(19) United States
(12) Patent Application Publication
(10) Pub. No.: US 2007/0271409 A1
(43) Pub. Date: Nov. 22, 2007

(54) MEMORY MODULE, MEMORY SYSTEM, AND DATA PROCESSING SYSTEM

(76) Inventors: Seiji Miura, Hachioji (JP); Akira Yabu, Tokyo (JP); Yoshinori Haraguchi, Tokyo (JP)

Correspondence Address: MILES & STOCKBRIDGE PC, 1751 PINNACLE DRIVE, SUITE 500, MCLEAN, VA, 22102-3833, US

(21) Appl. No.: 11/748,936

(22) Filed: May 15, 2007

(30) Foreign Application Priority Data
May 16, 2006 (JP) JP2006-135970

(51) Int. Cl. G06F 12/06

(52) U.S. Cl. 711/5

(57) ABSTRACT

A user-friendly data processing system apparatus which ensures the expandability of memory capacity and high speed processing with low cost is provided. The data processing system is composed of a data processing unit, a volatile memory and a nonvolatile memory. The data processing unit, the volatile memory and the nonvolatile memory are connected in series and by reducing the number of connection signals fast processing is realized while maintaining the memory capacity expandability. Upon transferring a data of the nonvolatile memory to the volatile memory, an error correction is executed, therefore, the reliability is improved. The data processing system composed of the plurality of memory chips is formed as a data processing system module in which the each chips are stacked and arranged, and wiring is formed by ball grid array (BGA) and bonding between the chips.

### CROSS-REFERENCE TO RELATED APPLICATION

The present application claims priority from Japanese Patent Application No. JP 2006-135970 filed on May 16, 2006, the content of which is hereby incorporated by reference into this application.

### TECHNICAL FIELD OF THE INVENTION

The present invention relates to a method for controlling a data processing system including a nonvolatile memory and a data processing unit and a memory module.

### BACKGROUND OF THE INVENTION

Conventionally, there is known a hybrid semiconductor memory in which a flash memory chip (32 Mbit capacity) and a static random access memory (SRAM) chip (4 Mbit capacity) are stacked and integrally sealed by stack chip into a fine pitch ball grid array (FBGA) package. For the flash memory and the SRAM, address input terminals and data input/output terminals are connected in common to an input/output electrode of the FBGA package. Meanwhile, each control terminal is independently connected thereto (see “hybrid memory (stacked CSP) flash memory+RAM data sheet. LRS1380”, Dec. 10, 2001, SHARP corporation, http://www.sharp.co.jp/products/device/flash/cmlist.html (Non-Patent Document 1), for example).

Additionally, in another known hybrid semiconductor memory, a flash memory (1 Gbit capacity) and a dynamic random access memory (DRAM) (512 MB capacity) are stacked and integrally sealed by stack chip into an FBGA package. As for the flash memory and the DRAM, address input terminals, data input/output terminals and control terminals, respectively, are connected independently to input/output electrodes of the FBGA package (see “MCP data sheet KBE00F005A-D411”, June 2005, Samsung Electronics Co. Ltd., http://www.samsung.com/Products/Semiconductor/common/product_list.aspx?family_cd=MCP0 (Non-Patent Document 2), for example).

Furthermore, another hybrid semiconductor memory includes a flash memory chip and a DRAM chip that are integrally sealed into a lead frame package. In this case, address input terminals, data input/output terminals and control terminals, respectively, are connected in common to input/output electrodes of the package (see FIGS. 1 and 15 of Japanese Patent Application Laid-Open Publication No. 05-299616 (Patent Document 1), and European Patent Application Laid-Open Publication No. 0566306 (Patent Document 2), for example).

There is also known a system including a flash memory as a main memory, a cache memory, a controller and a central processing unit (CPU) (see FIG. 1 of Japanese Patent Application Laid-Open Publication No. 07-146820 (Patent Document 3), for example).

In addition, another known semiconductor memory includes a flash memory, a DRAM and a data transfer control circuit (see FIG. 2 of Japanese Patent Application Laid-Open Publication No. 2001-5723 (Patent Document 4), and Japanese Patent Application Laid-Open Publication No. 2002-366429 (Patent Document 5), for example).

Furthermore, there is also provided a memory module formed by connecting a plurality of memories of the same kind (see Japanese Patent Application Laid-Open Publication No. 2002-7308 (Patent Document 6), and Japanese Patent Application Laid-Open Publication No. 2004-192616 (Patent Document 7)).

### SUMMARY OF THE INVENTION

Inventors of the present invention examined a mobile phone, a processor used therein, and a data processing system including flash memory and random access memory, prior to the invention.

As shown in FIG. 36, the mobile phone includes a data processing unit PRC and memory modules MCM1, MCM2. The data processing unit PRC is composed of a central processing unit CPU, SRAM controller SRC, DRAM controller DRC and a NAND flash memory controller NDC. The memory module MCM1 is composed of NOR flash memory NOR FLASH and SRAM. The memory module MCM2 is composed of NAND flash memory NAND FLASH and DRAM. The data processing unit PRC accesses the memory modules MCM1 and MCM2 to read and write data.

After turning the power on, the data processing unit PRC reads boot data stored in the NOR flash memory NOR FLASH to boot itself. Then, the data processing unit PRC reads an application program as necessary from the NOR flash memory NOR FLASH and executes the program in the central processing unit CPU. The SRAM and the DRAM each serves as a working memory and stores calculation results of the central processing unit CPU and the like.

The NAND flash memory NAND FLASH mainly stores music data and moving image data. According to needs, the data processing circuit PRC reads the music data or the moving image data from the NAND flash memory NAND FLASH into the DRAM to play music or moving images. Recently, there has been a growing development of multifunctional mobile devices as represented by mobile phone, therefore, there is a need for using various types of interfaces.

As shown in FIG. 36, the current CPU has a controller for each of different memory devices and is connected to memories in parallel. In addition, as more functions (e.g. the distribution of music, games and other contents) have been added to mobile phones, applications, data and work area used by mobile phones have become progressively larger. Consequently, there is a demand for a memory with a larger capacity.

Accordingly, the number of signal lines connecting a CPU to a memory increases, which leads to increases in substrate cost, noise and signal skew. Therefore, it has turned out that cost reduction, high-speed performance and miniaturization in mobile phones can be hardly achieved by the known technique.

Therefore, an object of the present invention is to provide a user-friendly data processing system capable of achieving high-speed performance and expanding memory capacity at a low cost, with reduced numbers of signal lines between a data processing unit and memories and those between the memories.

A typical means of the present invention will be shown. Data processing unit, dynamic random access memory, NOR flash memory and NAND flash memory are connected in series and sealed into a single body. Additionally, an electrode for connecting to a semiconductor chip and an electrode for connecting the sealed body to an external unit is formed on the sealed body.

In the above aspect, preferably, a read request sent from the data processing unit to each of the dynamic random access memory, the NOR flash memory and the NAND flash memory includes identification information regarding a destination of a request. Furthermore, preferably, read data includes identification information regarding a source of transfer.

Preferably, when the data processing unit reads data in the memories, a data read order among the memories is determined dynamically according to a read frequency (number of times read occurs). Furthermore, it is preferable that the read frequency can be programmed.

Preferably, after turning power on, the data processing unit performs control so as to determine identification information for each of the memories connected in series.

Preferably, regardless of a temporal order of read requests input to each of the memories, control is performed such that fast readable data can be transmitted without waiting for late read data.

Preferably, control is performed such that a circuit receiving a read request for each memory and a circuit transmitting read data can operate independently.

Preferably, control is performed such that a read operation and a write operation can be performed independently.

Preferably, control is performed such that a clock frequency of each memory can be changed if necessary.

Preferably, the data processing unit detects and corrects an error in reading data from the NAND flash memory, and in writing operation, performs replacement processing for a bad address in which data has been incorrectly written.

As a result, there can be obtained a user-friendly data processing system which enables fast performance and ensures the expandability of memory capacity at a low cost.

### BRIEF DESCRIPTIONS OF THE DRAWINGS

FIG. 1 is a block diagram showing an example of structure of data processing system according to the invention;

FIG. 2 is an illustration showing an example of an address map of the data processing system according to the invention;

FIG. 3 is an illustration showing an example of an operation upon turning power on of the data processing system according to the invention;

FIG. 4 is a block diagram showing an example of structure of a memory composing the data processing system according to the invention;

FIG. 5 is a flowchart showing an example of an operation performed in response to a request which occurs in the data processing system according to the invention;

FIG. 6 is a flowchart showing an example of an operation performed in response to a response in the data processing system according to the invention;

FIG. 7 is a flowchart showing an example of an operation performed in response to a response in the data processing system according to the invention;

FIG. 8 is a flowchart showing an operation of a response schedule circuit SCH;

FIG. 9 is a table showing an example of a response priority changing operation by the response schedule circuit SCH;

FIG. 10A is a flowchart showing an example of a clock control operation by the data processing system according to the invention.

FIG. 10B is a flowchart showing an example of a clock control operation by the data processing system according to the invention.

FIG. 10C is a flowchart showing an example of a clock control operation by the data processing system according to the invention.

FIG. 11 is a block diagram showing an example of structure of memory circuit of the memory composing the data processing system according to the invention;

FIG. 12 is a block diagram showing an example of structure of memory composing the data processing system according to the invention;

FIG. 13 is a table showing an example of response priority changing operation by the response schedule circuit SCH;

FIG. 14 is a block diagram showing an example of structure of memory composing the data processing system according to the invention;

FIG. 15 is a table showing an example of response priority changing operation by the response schedule circuit SCH;

FIG. 16 is a flowchart showing an example of an operation in response to an error response in the data processing system according to the invention;

FIG. 17A is an illustration showing an example of waveform of operation in the data processing system according to the invention;

FIG. 17B is an illustration showing an example of waveform of operation in the data processing system according to the invention;

FIG. 17C is an illustration showing an example of waveform of operation in the data processing system according to the invention;

FIG. 17D is an illustration showing an example of waveform of operation in the data processing system according to the invention;

FIG. 17E is an illustration showing an example of waveform of operation in the data processing system according to the invention;

FIG. 18A is an illustration showing an example of waveform of operation in the data processing system according to the invention;

FIG. 18B is an illustration showing an example of waveform of operation in the data processing system according to the invention;

FIG. 18C is an illustration showing an example of waveform of operation in the data processing system according to the invention;

FIG. 18D is an illustration showing an example of waveform of operation in the data processing system according to the invention;

FIG. 18E is an illustration showing an example of waveform of operation in the data processing system according to the invention;

FIG. 19A is an illustration showing an example of waveform of operation in the data processing system according to the invention;

FIG. 19B is an illustration showing an example of waveform of operation in the data processing system according to the invention;

FIG. 19C is an illustration showing an example of waveform of operation in the data processing system according to the invention;

FIG. 19D is an illustration showing an example of waveform of operation in the data processing system according to the invention;

FIG. 19E is an illustration showing an example of waveform of operation in the data processing system according to the invention;

FIG. 20A is an illustration showing an example of waveform of operation in the data processing system according to the invention;

FIG. 20B is an illustration showing an example of waveform of operation in the data processing system according to the invention;

FIG. 20C is an illustration showing an example of waveform of operation in the data processing system according to the invention;

FIG. 20D is an illustration showing an example of waveform of operation in the data processing system according to the invention;

FIG. 21A is an illustration showing an example of waveform of operation in the data processing system according to the invention;

FIG. 21B0 is an illustration showing an example of waveform of operation in the data processing system according to the invention;

FIG. 21B1 is an illustration showing an example of waveform of operation in the data processing system according to the invention;

FIG. 22A is an illustration showing an example of waveform of operation in the data processing system according to the invention;

FIG. 22B is an illustration showing an example of waveform of operation in the data processing system according to the invention;

FIG. 22C is an illustration showing an example of waveform of operation in the data processing system according to the invention;

FIG. 22D is an illustration showing an example of waveform of operation in the data processing system according to the invention;

FIG. 23 is an illustration showing an example of waveform of operation in the data processing system according to the invention;

FIG. 24 is a block diagram of a data processing system according to the invention;

FIG. 25 is a block diagram of a data processing system according to the invention;

FIG. 26 is a block diagram of a data processing system according to the invention;

FIG. 27 is a block diagram of a data processing system according to the invention;

FIG. 28 is a block diagram of a data processing system according to the invention;

FIG. 29A is an illustration showing an example of a memory data processing system according to an embodiment of the invention;

FIG. 29B is an illustration showing an example of a memory data processing system according to an embodiment of the invention;

FIG. 30A is an illustration showing an example of a memory data processing system according to an embodiment of the invention;

FIG. 30B is an illustration showing an example of a memory data processing system according to an embodiment of the invention;

FIG. 31A is an illustration showing an example of a memory data processing system according to an embodiment of the invention;

FIG. 31B is an illustration showing an example of a memory data processing system according to an embodiment of the invention;

FIG. 32A is an illustration showing an example of a memory data processing system according to an embodiment of the invention;

FIG. 32B is an illustration showing an example of a memory data processing system according to an embodiment of the invention;

FIG. 33A is an illustration showing an example of a memory data processing system according to an embodiment of the invention;

FIG. 33B is an illustration showing an example of a memory data processing system according to an embodiment of the invention;

FIG. 34 is a block diagram showing an example of structure of mobile phone using a memory data processing system according to the invention;

FIG. 35 is a block diagram showing an example of structure of mobile phone using a memory data processing system according to the invention; and

FIG. 36 is a block diagram showing an example of structure of memory of the prior art used in a mobile phone.

### DESCRIPTIONS OF THE PREFERRED EMBODIMENTS

Hereinafter, embodiments of the present invention will be described in detail with reference to the accompanying drawings. In the embodiments, circuit elements constituting individual blocks may be formed on a single semiconductor substrate such as a monocrystal silicon substrate by well-known integrated circuit techniques including the complementary metal-oxide semiconductor (CMOS) technology, for example.

### First Embodiment

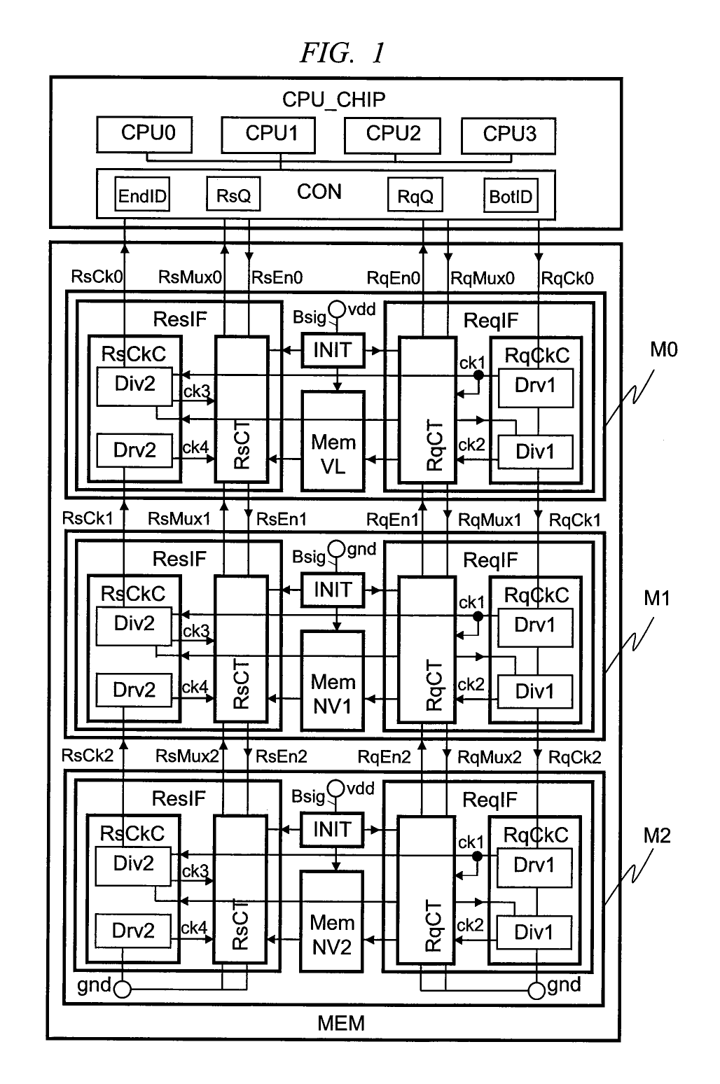

FIG. 1 shows a data processing system including a data processing unit CPU_CHIP and a memory module MEM according to a first embodiment of the invention. Now, a description for each component will be given.

The data processing unit CPU_CHIP is composed of data processing circuits CPU0, CPU1, CPU2 and CPU3 and a memory control circuit CON. The memory control circuit CON includes a request queue RqQ, a response queue RsQ, a boot device ID register BotID and an endmost device ID register EndID. The CPU0, CPU1, CPU2 and CPU3 read out an operating system (OS), an application program and data to be processed by the application program from the memory module MEM0 via the memory control circuit CON to execute them.

The request queue RqQ stores results of the application program executed by the CPU0, CPU1, CPU2 and CPU3 and the like to be output to the memory module MEM0. The response queue RsQ stores the application program to be output to the CPU0, CPU1, CPU2 and CPU3 read from the memory module MEM0 and the like.

The memory module MEM0 is composed of memory chips M0, M1 and M2. Additionally, the data processing unit CPU_CHIP and the memory chips M0, M1 and M2 are connected in series. The memory chip M0 is a volatile memory, while the memory chips M1 and M2 are nonvolatile memories. Typical volatile memories are DRAM using dynamic random access memory cells as memory array, pseudo static random access memory PSRAM, SRAM using static random access memory cells and the like. The present invention can use all kinds of volatile memory cells. In the first embodiment, an example using dynamic random access memory cells as memory array will be described.

The nonvolatile memory may be a read only memory (ROM), an electrically erasable and programmable ROM (EEPROM), a flash memory, a phase change memory, a magnetic random access memory (MRAM), a resistance switching type random access memory (ReRAM) or the like. The first embodiment shows an example using flash memory.

And, typical flash memories may include a NOR flash memory, an AND flash memory, a NAND flash memory and an ORNAND flash memory. The present invention is applicable to all kinds of flash memories. The first embodiment shows an example using NOR flash memory and NAND flash memory.

A typical volatile memory used as the memory chip M0 is dynamic random access memory using dynamic memory cells, although not specifically limited thereto. The memory may have a read access time of approximately 15 ns and an approximately 1 Gbit storage capacity. The memory chip M0 may be used as a temporary work memory necessary when the data processing unit CPU_CHIP executes an application program, although not specifically limited thereto.

A typical flash memory as the memory chip M1 may be comprised of NOR flash memory cells although not specifically limited thereto, and may have a read access time of approximately 80 ns and an approximately 1 Gbit storage capacity. The memory chip M1 may store an OS to be executed by the data processing unit CPU_CHIP, a boot code, a boot device ID number, an endmost device ID number, an application program and the like, although not specifically limited thereto.

A typical flash memory as the memory chip M2 may be comprised of NAND flash memory cells although not specifically limited thereto, and may have a read access time of approximately 25 μs and an approximately 4 Gbit storage capacity. The memory chip M2 may store, for example, audio data, still image data, moving image data and the like to be played, audio-recorded or video-recorded through the data processing unit CPU_CHIP although not specifically limited thereto.

The memory chip M0 is composed of an initialization circuit INIT, a request interface circuit ReqIF, a response interface circuit ResIF and a memory circuit MemVL. The request interface circuit ReqIF is composed of a request clock control circuit RqCkC and a request queue control circuit RqCT. The response interface circuit ResIF is composed of a response clock control circuit RsCkC and a response queue control circuit RsCT. Although not specifically limited thereto, the memory circuit MemVL may be a volatile memory, and may be a dynamic random access memory using dynamic random access memory cells. The request clock control circuit RqCkC is composed of a clock driver circuit Drv1 and a clock division circuit Div1. The memory chip M1 is composed of an initialization circuit INIT, a request interface circuit ReqIF, a response interface circuit ResIF and a memory circuit MemNV1. The request interface circuit ReqIF is composed of a request clock control circuit RqCkC and a request queue control circuit RqCT. The response interface circuit ResIF is composed of a response clock control circuit RsCkC and a response queue control circuit RsCT.

Although not specifically limited thereto, the memory circuit MemNV1 may be a nonvolatile memory, and is a NOR flash memory using NOR flash memory cells. The memory circuit MemNV1 stores the boot device ID number and the endmost device ID number.

The request clock control circuit RqCkC is composed of a clock driver circuit Drv1 and a clock division circuit Div1.

The memory chip M2 is composed of an initialization circuit INIT, a request interface circuit ReqIF, a response interface circuit ResIF and a memory circuit MemNV2. To indicate that the memory chip M2 is the endmost chip among the memory chips connected in series, signals RqEn3, RsMux3 and RqCk3 are grounded (gnd), although not specifically restricted thereto.

The request interface circuit ReqIF is composed of a request clock control circuit RqCkC and a request queue control circuit RqCT. The response interface circuit ResIF is composed of a response clock control circuit RsCkC and a response queue control circuit RqCT. The memory circuit MemNV2 may be a nonvolatile memory, and is a NAND flash memory having NAND flash memory cells, although not specifically limited thereto. The request clock control circuit RqCkC is composed of a clock driver circuit Drv1 and a clock division circuit Div1.

Immediately after turning power on, the initialization circuits INIT of each of the memory chips M0, M1 and M2 execute initialization of each memory. The request queue control circuit RqCT of each memory chip M0, M1 and M2 has an ID register for storing an ID number of each memory chip. Immediately after turning power on, firstly, the initialization circuit INIT executes initial setting. Then, the data processing unit CPU_CHIP determines the ID numbers of the memory chips M0, M1 and M2. Those ID numbers are stored in the ID register of each memory chip.

The memory chips M0, M1 and M2 each may have a boot device identification signal Bsig, although not specifically limited thereto. If the boot device identification signal Bsig is grounded, it indicates that the memory chip concerned is a device storing a boot program for an operation performed immediately after turning power on. If the boot device identification signal Bsig is connected to a power source (vdd), it indicates that the memory chip concerned is not a boot device. Although not specifically limited thereto, the memory chip M1 may be a boot device and the memory chips M0 and M2 may be not. And, selection of chip to be used as boot device can be programmed by the boot device identification signal Bsiq.

Reference symbols RqCk0, RqCk1 and RqCk2 each denote request clock, and RsCk0, RsCk1 and RsCk2 each denote response clock. Reference symbols RqEn0, RqEn1 and RqEn2 each denote request enable signal, and RsEn0, RsEn1 and RsEn2 each denote response enable signal. Reference symbols RqMux0, RqMux1 and RqMux2 each denote request signal, and RsMux0, RsMux1 and RsMux2 each denote response signal.

If the memory chip M0 can receive a request from the data processing unit CPU_CHIP, the memory chip M0 sets the RqEn0 to high, and if not, the memory chip M0 sets the RqEn0 to low, although not specifically limited thereto. If the memory chip M1 can receive a request from the memory chip M0, the RqEn1 is set to high, and if not, the RqEn1 is set to low, although not specifically limited thereto. If the memory chip M2 can receive a request from the memory chip M1, the RqEn2 is set to high, and if not, the RqEn2 is set to low, although not specifically limited thereto.

RqMux0, RqMux1, and RqMux2 are request signals, and a request transmitted through these request signals, is multiplexed with information such as an ID number, a command, addresses and write data, although not specifically limited thereto, and transmitted in synchronization with their request clock signals RqCk0, RqCk1 and RqCk2, respectively. As for a response transmitted through each of the response signals RsMux0, RsMux1 and RsMux1, is multiplexed with information such as an ID number and read data, although not specifically limited thereto, and transmitted in synchronization with their response clock signals RsCk0, RsCk1 and RsCk2, respectively.

Hereinafter, operations of the present memory system will be described. First described will be operations immediately after turning power on.

### <Description of Operations Immediately After Turning Power On>

First, operations of the memory system according to the first embodiment immediately after turning power on will be described.

When power supply to the data processing unit CPU_CHIP starts, the boot device ID register BotID is set to 1 and the endmost device ID register EndID is set to 0.

When power supply to the memory chip M0 starts, the initialization circuit INIT of the memory chip M0 initializes the request queue control circuit RqCT thereof, the response queue control circuit RsCT, the request control circuit RqCkc, the response clock control circuit RsCkC, the clock division circuits Div1 and Div2, and the memory circuit MemVL. The ID register of the request queue control circuit RqCT is set to 0 and its ID valid bit is set to low. Regarding a response priority order of response arbitration circuit included in the response queue control circuit RsCT, initialization is performed such that response priority order of the memory chips M0 is set to 1, and response priority order of the memory chips M1 is set to 2, response priority order of the memory chips M2 is set to 3. A division ratio of each of the clock division circuits Div1 and Div2 is set to 1.

When power supply to the memory chip M1 starts, the initialization circuit INIT of the memory chip M1 initializes the request queue control circuit RqCT thereof, the response queue control circuit RsCT, the request control circuit RqCkc, the response clock control circuit RsCkC, the clock division circuits Div1 and Div2, and the memory circuit MemNV1. The ID register of the request queue control circuit RqCT is set to 0 and its ID valid bit is set to low. Regarding a response priority order of response arbitration circuit included in the response queue control circuit RsCT of the memory chip M1, initialization is performed such that the response priority order of the memory chips M1 is set to 1, and the response priority order of the memory chips M2 is set to 2. A division ratio of each of the clock division circuits Div1 and Div2 is set to 1.

When power supply to the memory chip M2 starts, the initialization circuit INIT of the memory chip M2 initializes the request queue control circuit RqCT thereof, the response queue control circuit RsCT, the request control circuit RqCkc, the response clock control circuit RsCkC, the clock division circuits Div1 and Div2, and the memory circuit MemNV2. The ID register of the request queue control circuit RqCT of memory chip M2 is set to 0 and its ID valid bit is set to low. Regarding a response priority of response arbitration circuit included in the response queue control circuit RsCT of memory chip M2, the response priority order of the memory chip M2 is initially set to be 1. A division ratio of each of the clock division circuits Div1 and Div2 is set to 1. Then, the memory chip M2 identifies itself as not a boot device, since the boot device identification signal Bsig is connected to the power source.

Then, request clock RqCk0 is input to the memory chip M0 from the data processing unit CPU_CHIP. The clock driver Drv1 of the memory chip M0 outputs the request clock RqCk0 to the clock division circuit Div1 and outputs the clock RqCk0 as a clock signal ck1 to the clock division circuit Div2. The clock signal input to the clock division circuit Div1 is output to the memory chip M1 through the request clock RqCk1. The clock input to the clock division circuit Div1 is output from the clock signal ck2 and is output to the memory chip M2 through the request clock RqCk1. The clock input to the clock division circuit Div2 is output from the clock signal ck3 and is output to the data processing unit CPU_CHIP through the response clock RsCk0. The clock input to the clock driver Drv1 of the memory chip M1 is output to the clock division circuit Div1 and is output as a clock signal ck1 to the clock division circuit Div2. The clock input to the clock division circuit Div1 is output from the clock signal ck2 and is output to the memory chip M2 through the request clock RqCk1. The clock input to the clock division circuit Div2 is output from the clock signal ck3 and is output to the memory chip M0 through the response clock RsCk1. The clock input to the clock driver Drv2 of the memory chip M0 through the response clock RsCk1 is output to a clock signal ck4. The clock input to the clock driver Drv1 of the memory chip M2 is output to the clock division circuit Div1 and is output as a clock signal ck1 to the clock division circuit Div2. The clock input to the clock division circuit Div2 is output from the clock signal ck3 and is output to the memory chip M2 through the request clock RqCk1. The clock input to the clock driver Drv2 of the memory chip M1 through the response clock RsCk2 is output to the clock signal ck4.

Next, the memory chip M0 identifies itself as not a boot device, since the boot device identification signal Bsig connected to the power source vdd. The memory chip M1 identifies itself as a boot device, since the boot device identification signal Bsig is grounded, therefore, the boot device ID number 1 stored in the memory circuit MemNV1 is set into the ID register and its ID valid bit is set to high. The memory chip M2 identifies itself as not a boot device, since the boot device identification signal Bsig connected to the power source. In addition, the memory chip M2 identifies itself as the endmost one among the memory chips connected in series since RqEn3, RsMux3 and RqCk3 are grounded, and sets the request enable signal RqEn2 to high.

Next, the memory chip M1 confirms that the request enable signal RqEn2 has become high, then, sets the response enable signal RsEn2 and the request enable signal RqEn1 to high. Next, the memory chip M0 confirms that the request enable signal RqEn1 has become high, then, sets the response enable signal RsEn1 and the request enable signal RqEn0 to high. Lastly, the data processing unit CPU_CHIP confirms that the request enable signal RqEn0 has become high and recognizes that signal connections between the memory chips have been confirmed. Accordingly, the data processing unit CPU_CHIP sets the response enable signal RsEn0 to high. As a result, it can be appropriately confirmed that the data processing unit CPU_CHIP and the memory chips M0, M1 and M2 are connected in series.

Next, a method for reading boot data after confirming signal connections between the memory chips is described.

The data processing unit CPU_CHIP reads the boot device ID register BotID number 1 and synchronizes a request ReqBRD1 to which the ID number 1 of the memory chip M1, a read command, a transfer data size and addresses multiplexed, with the clock signal RqCk0 via the request signal RqMux0, and transfers it to the memory chip M0. Since the ID valid bit of the memory chip M0 is low, the memory chip M0 determines that the request ReqBRD1 from the data processing unit CPU_CHIP is not a request to itself, therefore, the memory chip M0 synchronizes the request ReqBRD1 with the clock signal RqCk1 through the request signal RqMux1 and transfer to the memory chip M1.

The memory chip M1 stores the request ReqBRD1 from the memory chip M0 in the request queue control circuit RqCT of its own. Then, the request queue control circuit RqCT compares the ID number 1 included in the request with the ID register number 1 of it own. Both numbers are the same and the ID valid bit is high, therefore, the memory chip M1 determines that the request from the memory chip M0 is a request to itself.

After that, based on the read command, the transfer data size and the address included in the request ReqBRD1, boot data is read out from the memory circuit MemNV1 and an ID number 3 is read out from the endmost device ID register to be transferred to the response queue control circuit RsCT. At the same time, the ID register number 1 stored in the request queue control circuit RqCT is also transferred to the response queue control circuit RsCT.

The response queue control circuit RsCT of the memory chip M1 synchronizes a response ResBRD1 generated by multiplexing the ID number 1 of the memory chip M1, a boot program, and the endmost device ID with the clock signal RqCk1 to transfer to the memory chip M0 through the response signal RqMux1.

Finally, the response queue control circuit RsCT of the memory chip M0 synchronizes the response ResBRD1 with the clock signal RqCK0 to transfer to the data processing unit CPU_CHIP through the response signal RqMux0.

The data processing unit CPU_CHIP stores the response ResBRD1 in the response queue RsQ. Based on the ID number 1 included in the response ResBRD1, it can be recognized that the boot data and the endmost device ID number 3 have been transmitted from the memory chip M1. The endmost device ID number 3 is stored in the endmost device ID register of the memory control circuit CON.

The data processing unit CPU_CHIP boots itself with the boot program and then assigns an ID number to each of the memory chips M0, M1 and M2.

Next, assignment of the ID number to the memory chips will be explained. Based on the boot code, the data processing unit CPU_CHIP, first, assigns an ID number to each memory. The data processing unit CPU_CHIP transfers an ID number 2 and an ID setting command to the memory chip M0 through the request signal RqMux0. In the memory chip M0, since the ID valid bit is low, the ID number assignment has not been executed yet. Therefore, the memory chip M0 sets the ID number 2 into the ID register based the ID number 2 and the ID setting command and sets the ID valid bit to high. The high ID valid bit indicates the completion of the ID number assignment. When the ID number assignment of the memory chip M0 is completed, the memory chip M0 outputs the ID number 2 thereof and information of the ID number assignment completion through the response signal RsMux0. The data processing unit CPU_CHIP receives the ID number 2 thereof and information of the ID number assignment completion, and recognizes that the ID number assignment of the memory chip M0 has been completed.

Next, the data processing unit CPU_CHIP transfers a request ReqID3 generated by multiplexing ID number 3 and an ID setting command to the memory chip M0 through the request signal RqMux0. The memory chip M0 compares the ID number 2 of its own with the ID number 3 included in the request ReqID3 and identifies a mismatch. Therefore, the request ReqID3 is transferred to the memory chip M1.

The memory chip M1 compares its own ID number 1 with the ID number 3 included in the request ReqID3. Since there is a mismatch, the memory chip M0 transfers the request ReqID3 to the memory chip M2. In the memory chip 2, since the ID valid bit number is low, the ID number assignment has not been completed yet. Accordingly, the memory chip M2 sets the ID number 3 into its own ID register based on the ID number 3 and the ID setting command included in the request ReqID3 and sets the ID valid bit to high. Upon completion of the ID number assignment of the endmost memory chip M2, the memory chip M2 outputs a response ResID3 generated by multiplexing the ID number 3 of memory chip M2 and information of the ID number assignment completion to the memory chip M1 through the response signal RsMux2. The memory chip M1 outputs the response ResID3 to the memory chip M0 through the response signal RqMux1. The memory chip M0 transfers the response ResID3 to the data processing unit CPU_CHIP through the response signal RqMux0. The data processing unit CPU_CHIP receives the response ResID3, receives the ID number 3 of the memory chip M2 and the ID number completion information included in the response ResID3, and recognizes the completion of the ID number assignment of the memory chip 2. Furthermore, the data processing unit CPU_CHIP compares the transferred ID number 3 of the memory chip M2 with the endmost device ID number 3 set into the endmost device ID register of the memory control circuit CON. Then, due to a match between them, the data processing unit CPU_CHIP confirms that the ID number assignment is completed to the endmost memory chip. Following that, the memory module MEM0 goes into an idling state waiting for a request from the data processing unit CPU_CHIP.

As described above, by performing the confirmation of the series connection immediately after turning power on, the certain connection between memories can be confirmed. Moreover, the boot device and the endmost memory chip are identified and the ID numbers are automatically given to the memories, therefore, it becomes easy to connect the memory chips only as necessary, and memory capacity can be expanded.

### <Description of Ordinary Operations>

Hereinafter, a description of a data transfer between the memory module MEM0 and the data processing unit CPU_CHIP after a power on sequence upon turning power on is finished is described.

Although not specifically restricted thereto, the following is the data transfer between the memory module MEM0 and the data processing unit CPU_CHIP performed in the case where the ID register numbers of the memory chips M0, M1 and M2 are set to be 2, 1 and 3, respectively. Although not specifically restricted thereto, an example in which the data transfer performed in the case where there are two request queues in the response queue control circuit RqCT of the memory chip M0, M1 and M2 and no request entries, and there are four response queues in the response queue control circuit RsCT and no response entries. Although not specifically restricted thereto, a single request queue can store a 1-byte ID number, a 1-byte command, 2-byte addresses and 32-byte read data, while a single response queue can store a 1-byte ID number and 32-byte read data.

Furthermore, although not specifically restricted, the memory circuits MemVL, MemNV1 and MemNV2 of the memory chips M0, M1 and M2, respectively, are each composed of four memory banks, and a single memory bank may have a single sense amplifier circuit.

In the memory chip M0, no entry of request from the data processing unit CPU_CHIP exists in the request queue thereof. Accordingly, the memory chip M0 sets the request enable signal RqEn0 to high and notifies the data processing unit CPU_CHIP that a request can be received.

The data processing unit CPU_CHIP synchronizes a request ReqBAm01 generated by multiplexing the ID number 2, a bank active command BA, a bank address BK0 and a row address Row0 with the clock signal RqCK0 to transfer to the memory chip M0 through the request signal RqMux0.

Next, through the request signal RqMux0, a request ReqRDm04 generated by multiplexing the ID number 2, a 4-byte read command RD, the bank address BK0 and a column address Col3 is synchronized with the clock signal RqCK0 to transfer to the memory chip M0.

The memory chip M0 stores the requests ReqBAm01 and ReqRDm04 from the data processing unit CPU_CHIP in order in the request queue control circuit RqCT thereof.

As a result, all the request queues in the request queue circuit RqCT are occupied and a new request from the data processing unit CPU_CHIP cannot be received, therefore, the request enable signal RqEn0 is set to low. Since the request enable signal RqEn0 is set to low, the data processing unit CPU_CHIP can recognize that the memory chip M0 cannot receive a request.

Then, the request queue control circuit RqCT compares the ID number 2 of the request ReqBAm01 with the ID register number 2 of its own. Since the ID number 2 in the request ReqBA1 matches the register number 2 of the memory chip M0, the request queue control circuit RqCT transmits the request ReqBA1 to the memory circuit MemVL. In the memory circuit MemVL, 8192-bit memory cells connected to row 0 of bank 0 are activated based on the bank active command BA, the bank address BK0 and the row address Row0 in the request ReqBAm01 to be transferred to the sense amplifier.

Because the request ReqBAm01 has been processed, there is a vacancy in one of the request queues in the request queue control circuit RqCT. Accordingly, the memory chip M0 sets the request enable signal RqEn0 to high and notifies the data processing unit CPU_CHIP that a new request can be received.

Next, the request queue control circuit RqCT compares the ID number 2 in the request ReqRDm04 with the ID register number 2 of itself. Since there is a match between the ID number 2 in the request ReqRDm04 and the ID register number 2 of the memory chip M0, the request queue control circuit RqCT transmits the request ReqRDm04 to the memory circuit MemVL. Based on the 4-byte read command RD4, the bank address BK0 and the column address Col3 included in the request ReqRDm04, the memory circuit MemVL reads out a 4-byte data which starts with the column address 3 from data stored in the sense amplifier of bank 0 of the memory circuit MemVL and transfers as a response ResRDm04 along with the ID register number 2 to the response queue control circuit RsCT. It takes approximately 15 ns after the request ReqRDm04 is transmitted to the memory circuit MemNV1 until desired data is read and input as the response ResRDm04 to the response queue control circuit RsCT, although not specifically restricted thereto.

The response queue control circuit RsCT outputs the response ResRDm04 to the data processing unit CPU_CHIP through the response signal RsMux0. The memory control circuit CON of the data processing unit CPU_CHIP receives the response RsRDm04 into the response queue RsQ. The data processing unit CPU_CHIP can confirm that data corresponding to the request RqRDm04 has been correctly transmitted from the memory chip M0 by the ID number 2 in the response RsRDm04 sent to the response queue RsQ.

Although not specifically defined, the data input to the response queue RsQ may be processed by one of the data processing circuits CPU0, CPU1 and CPU2. Hereinabove, data read by the memory chip M0 has been described, however, obviously, data write operation thereby can also be performed in a similar manner.

As described above, by including the ID information in the request from the data processing unit CPU_CHIP to the memory module MEM0 and the response from the memory module MEM0 to the data processing unit CPU_CHIP, it can be confirmed that the data transfer executed correctly. Accordingly, by the series connection between the data processing unit CPU_CHIP and the memory chips M0, M1 and M2, the data processing unit CPU_CHIP can perform desired processing, with reduced the number of connection signals.

Next, data transfer between the data processing unit CPU_CHIP and the memory chip M1 will be described. The data processing unit CPU_CHIP transfers a request ReqNRD4m1 generated by multiplexing the ID number 1, a 4-byte data read command NRD4 and an address Add31 to the memory chip M0 through the request signal RqMux0. The memory chip M0 stores the request ReqNRD4m1 from the data processing unit CPU_CHIP in the request queue control circuit RqCT of its own and compares the ID number 1 in the request ReqNRD4m1 with the ID number 2 of its own ID register. Since the comparison result shows a mismatch, the memory chip M0 determines that the request ReqNRD4m1 is not a request to itself and then transfers it to the memory chip M1 through the request signal RqMux1.

The memory chip M1 stores the request ReqNRD4m1 from the memory chip M0 in the request queue control circuit RqCT of its own and compares the ID number 1 in the request ReqNRD4m1 with its own ID register number 1. The request queue control circuit RqCT compares the ID number 1 included in the request ReqNRD4m1 with the ID register number 1 of its own. Since they match with each other, the request ReqNRD4m1 is transmitted to the memory circuit MemNV1. Based on the 4-byte read command NRD4 and the address Add 31 in the request ReqNRD4m1, a 4-byte data which starts with a start address specified by the address Add 31 is read out from the memory circuit MemNV1 and transferred as a response ResNRD4m1 with the ID register number 1 to the response queue control circuit RsCT. Although not restricted thereto, it may take approximately 80 ns after the request ReqNRD4m1 is transmitted to the memory circuit MemNV1 until the desired data is read out.

The response queue control circuit RsCT outputs the response ResNRD4m1 to the memory chip M0 through the response signal RsMux1. The response queue control circuit RsCT of the memory chip M0 outputs the received response ResNRD4m1 to the data processing unit CPU_CHIP from the response signal RsMux0. Hereinabove, data read by the memory chip M1 has been described, however, it is needless to say that data write operation thereby can also be performed in a similar manner.

As described above, in the series connected circuit in which the data processing unit CPU_CHIP and the memory chips M0, M1 and M2 are connected in series, the memory chip M0 is connected to the data processing unit CPU_CHIP, the memory chip M1 is connected to the memory chip M0 in subsequent part of the memory chip M0, and the memory chip M2 is connected to the memory chip M1 in subsequent part of the memory chip M1, by assigning the ID number to the request for the memory chips M0, M1 and M2 from the data processing unit CPU_CHIP, the request is transferred from the data processing unit CPU_CHIP to the memory chip M1 through the memory chip M0 certainly. In addition, by assigning the ID number to the response, it is confirmed that the data read out from the memory chip M1 and then received by the data processing unit CPU_CHIP through the memory chip M0 is the data read out from the memory chip M1 in response to the request to the memory chip M1. Accordingly, because of the series connection between the data processing unit CPU_CHIP and the memory chips M0, M1 and M2, the data processing unit CPU_CHIP can perform desired processing, with the reduced number of connection signals.

Next, a data transfer between the data processing unit CPU_CHIP and the memory chip M2 will be described. Although not restricted thereto, the memory chip M2 may be a NAND flash memory using NAND flash memory cells. The reliability of a NAND flash memory tends to be degraded through repetitive rewrite operations. And, although it is rare, data written during a write operation can be different during a read operation or data rewrite cannot be performed upon a rewrite operation. For such a reason, 512-byte data and 16-byte ECC code which is used for correcting an error in the 512-byte data are managed as a single page data.

The data processing unit CPU_CHIP transmits a request ReqNDRDp1m2 generated by multiplexing ID number 3, a single page (512 bytes+16 bytes) data read command NDRDp1 and a page address Padd1 to the memory chip M0 through the request signal RqMux0. The memory chip M0 stores the request ReqNDRDp1m2 from the data processing unit CPU_CHIP in the request queue control circuit RqCT of its own to compare the ID number 3 in the request ReqNDRDp1m2 with its own ID register number 2. Since the comparison result indicates a mismatch, the memory chip M0 transfers the request ReqNDRDp1m2 to the memory chip M1 through the request signal RqMux1.

The memory chip M1 stores the request ReqNDRDp1m2 from the memory chip M0 in the request queue control circuit RqCT of its own to compare the ID number 3 in the request ReqNDRDp1m2 with its own ID register number 1. Since the comparison results indicate a mismatch, the memory chip M1 transfers the ReqNDRDp1m2 to the memory chip M2 through the request signal RqMux2. The memory chip M2 stores the request ReqNDRDp1m2 from the memory chip M1 in the request queue control circuit RqCT of its own to compare the ID number 3 in the request ReqNDRDp1m2 with its own ID register number 3. Since the result shows a match therebetween, the request ReqNDRDp1m2 is transmitted to the memory circuit MemNV2 thereof.

Based on the single-page read command NDRDp1 and the page address Padd1 in the request ReqNDRDp1m2, single-page (512 bytes) data which starts with a address specified by page address 1 and its ECC code (16 bytes) are read out from the memory circuit MemNV2 and transferred to a data register of the memory circuit MemNV2. Next, the response queue control circuit RsCT reads out the data stored in the data register for every 32 byte block in order, including the ID register number 3, as from the responses ResNDRDp1m2-0 to the responses ResNDRDp1m2-7 and transfers them to the memory chip M1. Lastly, the 16-byte ECC code of the page address 1 is read out and transferred as a response ResNDRDp1m2ECC, along with the ID register number 3, to the memory chip M1 through the response signal RsMux2. It may take approximately 25 usec after the request ReqNDRD1pm2 is transmitted to the memory circuit MemNV2 until the desired data is read into the data register of the memory circuit MemNV2, although not restricted thereto.

The responses ResNDRDp1m2-0, ResNDRDp1m2-1, ResNDRDp1m2-2, ResNDRDp1m2-3, ResNDRDp1m2-4, ResNDRDp1m2-5, ResNDRDp1m2-6, the response ResNDRDp1m2-7 and the response ResNDRDp1m2ECC are transferred to the memory chip M1 in order. Then, they are transferred to the memory chip M0 through the response signal RsMux1 and furthermore transferred to the data processing unit CPU_CHIP through the response signal RsMux0.

The memory control circuit CON of the data processing unit CPU_CHIP receives ResNDRDp1m2-0, ResNDRDp1m2-1, ResNDRDp1m2-2, ResNDRDp1m2-3, ResNDRDp1m2-4, ResNDRDp1m2-5, ResNDRDp1m2-6, the response ResNDRDp1m2-7 and the response ResNDRDp1m2ECC in order into the response queue RsQ. The data processing unit CPU_CHIP can confirm that the responses have been transmitted from the memory chip M2, based on the ID number 3 in each of the responses transmitted into the response queue RsQ.

The data processing unit CPU_CHIP detects errors in the data transmitted from the memory chip M2 using the ECC code through one of the data processing circuits CPU0, CPU1, CPU2 and CPU3. If there is no error in the data, one of the data processing circuit CPU0, CPU1, CPU2 and CPU3. performs data processing. If any error is detected, error correction is performed by one of those processing circuits and, thereafter, the data subjected to error correction is processed by one of them. Hereinabove, data read by the memory chip M2 has been described, however, obviously, data write operation thereby can also be performed in a similar manner.

As described above, in the series connected circuit in which the data processing unit CPU_CHIP and the memory chips M0, M1 and M2 are connected in series, the memory chip M0 is connected to the data processing unit CPU_CHIP, the memory chip M1 is connected to the memory chip M0 in subsequent part of the memory chip M0, and the memory chip M2 is connected to the memory chip M1 in subsequent part of the memory chip M1, by assigning the ID number to the request for the memory chips M0, M1 and M2 from the data processing unit CPU_CHIP, the request from the data processing unit CPU_CHIP is transferred certainly to the memory chip M2 through the memory chips M0 and M1. Furthermore, by assigning the ID number to the response, it is confirmed that the data read from the memory chip M2 and then received by the data processing unit CPU_CHIP through the memory chips M0 and M1 is data read from the memory chip M2 in response to the request to the memory chip M2. And, the series connection between the data processing unit CPU_CHIP and the memory chips M0, M1 and M2 allows the data processing unit CPU_CHIP to perform desired processing while reducing the number of connection signals.

Next, data transfer performed in the case where the data processing unit CPU_CHIP transmits a data read request and then a data write request to the memory module MEM will be described.

The data processing unit CPU_CHIP transfers a request ReqRD8b1m0 generated by multiplexing ID number 2, an 8-byte read command RD8, a bank address BK1 and a column address Col15 to the memory chip M0 through the request signal RqMux0. Next, a request ReqWF8b1m0 generated by multiplexing the ID number 2, an 8-byte write command WT8, the bank address BK1, column address Col31 and 8-byte write data is transferred to the memory chip M0 through the request signal RqMux0.

The memory chip M0 stores both the request ReqRD8b1m0 and the request ReqWT8b1m0 from the data processing unit CPU_CHIP in order in the request queue control circuit RqCT thereof. The request queue control circuit RqCT compares the ID number 2 in the request ReqRD8b1m0 with the ID register number 2 of its own. Since both numbers match with each other, the request ReqRD8b1m0 is transmitted to the memory circuit MemVL.

Based on the 8-byte read command RD8, the bank address BK1 and the column address Col31 in the request ReqRD8b1m0, the memory circuit MemVL reads an 8-byte data which starts with address specified by the column address 15 from data retained in the sense amplifier of the bank 1 of the memory circuit MemVL and transfers as a response RsRD8b1m0 including the number 2 of the ID register to the response queue control circuit RsCT.

The response queue control circuit RsCT outputs the response RsRD8b1m0 including the ID register number 2 and the 8-byte data to the data processing unit CPU_CHIP through the response signal RsMux0.

Because the request RqRD8b1m0 has been processed, the request queue control circuit RqCT compares the ID number 2 in the request ReqWT8b1m0 with the ID register number 2 of its own. Since there is a match therebetween, the request ReqWT8b1m0 is transmitted to the memory circuit MemVL.

In the memory circuit MemVL, based on the 8-byte write command WT8, the bank address BK1 and the column address Col31 in the request ReqWT8b1m0, an 8-byte data which starts with address specified by the column address 31 is written in the sense amplifier of bank 1 of the memory circuit MemVL as well as in the memory bank 1.

The request queue control circuit RqCT and the response queue control circuit RsCT operate independently, therefore, the write operation of request Req8b1m0 can be executed even while the ResRD8b1m0 corresponding to the request RqRD8b1m0 is being output to the data processing unit CPU_CHIP.

As described above, the request interface circuit ReqIF and the response interface circuit ResIF can operate independently, therefore, data read operation and data write operation can be executed simultaneously, so that data transfer capability can be improved. Hereinbefore, data read and data write by the memory chip M0 have been described, however, obviously, the other memory chips M1 and M2 can also perform similar operations. Furthermore, since the request interface circuit ReqIF and the response interface circuit ResIF can operate independently in each of those memory chips, even when there occur data read/write requests to a different memory chip, each requests can be processed independently and in parallel. Therefore, the data transfer capability can be improved, although it is needless to say.

Next, a data transfer performed when a read request from the data processing unit CPU_CHIP occurs to the memory chip M1 and thereafter, a read request therefrom occurs to the memory chip M0 subsequently will be described. First, the data processing unit CPU_CHIP transfers a request ReqNRD4m1 generated by multiplexing the ID number 1, a 4-byte data read command NRD4 and an address Add63 to the memory chip M0 through the request signal RqMux0.

Next, a request ReqRD4b3m0 generated by multiplexing the ID number 2, a 4-byte read command RD4, a bank address BK3 and a column address Col15 is transferred to the memory chip M0 through the request signal RqMux0. The memory chip M0 stores both the requests ReqNRD4m1 from the data processing unit CPU_CHIP and the request ReqRD4b3m0 in order in the request queue control circuit RqCT of its own.

The request queue control circuit RqCT of the memory chip M0 compares the ID number 1 in the request ReqNRD4m1 with its own ID register number 2. Since the numbers does not match with each other, the request ReqNRD4m1 is transferred to the memory chip M1 through the request signal RqMux1.

Next, the request queue control circuit RqCT of the memory chip M0 compares the ID number 2 in the request ReqRD4b3m0 with its own ID register number 2. Since both numbers are the same, the request ReqRD4b3m0 is transferred to the memory circuit MemVL. Based on the request ReqRD4b3m0, a 4-byte data is read out from the memory circuit MemVL after approximately 15 ns and then input as a response ResRD4b3m0 to the response queue control circuit RsCT. The response queue control circuit RsCT transmits the response ResRD4b3m0 to the data processing unit CPU_CHIP through the response signal RsMux0.

In parallel with the read of the request ReqRD4b3m0 by the memory chip M0, the request queue control circuit RqCT of the memory chip M1 compares the ID number 1 in the request ReqNRD4m1 with its own ID register number 1. Since there is a match therebetween, the request ReqNRD4m1 is transferred to the memory circuit MemNV1. Based on the request ReqNRD4m1, a 4-byte data is read out from the memory circuit MemNV1 after approximately 80 ns and then input as a response ResNRD4m1 to the response queue control circuit RsCT. The response queue control circuit RsCT of the memory chip M1 transmits the response ResNRD4m1 to the memory chip M0 through the response signal RsMux1 and furthermore transmits it to the data processing unit CPU_CHIP through the response signal RsMux0.

It takes approximately 10 ns from the data processing unit CPU_CHIP issues the request ReqNRD4m1 to the memory chip M1 to the memory module MEM until the request ReqNRD4m1 is completely stored in the request queue control circuit RqCT of the memory chip M1. It takes approximately 1 ns for the request queue control circuit RqCT to transmit the request ReqNRD4m1 to the memory circuit MemNV1. It takes approximately 80 ns until the 4-byte data is read out from the memory circuit MemNV1 and then input as the response ResNRD4m1 to the response queue control circuit RsCT. It takes approximately 10 ns until the response ResNRD4m1 reaches the data processing unit CPU_CHIP. Accordingly, it takes approximately 101 ns from the data processing unit CPU_CHIP issues the request ReqNRD4m1 to the memory chip M1 until it receives the response ResNRD4m1.

It takes approximately 5 ns from the data processing unit CPU_CHIP issues the request ReqRD4b3m0 to the memory chip M0 to the memory module MEM until the request ReqRD4b3m0 is completely stored in the request queue control circuit RqCT of the memory chip M0. It takes approximately 1 ns for the request queue control circuit RqCT to transmit the request ReqRD4n3m0 to the memory circuit MemVL. It takes approximately 15 ns until the 4-byte data is read output from the memory circuit MemVL and input as the response ResRD4b3m0 to the response queue control circuit RsCT. It takes approximately 5 ns until the response ResRD4b3m0 reaches the data processing unit CPU_CHIP. Accordingly, it takes approximately 26 ns from the data processing unit CPU_CHIP issues the request ReqRD4b3m0 to the memory chip M0 until it receives the response ResRD4b3m0.

As above, regardless of the input order of requests, fast readable data can be read immediately without waiting for late read data, therefore, high-speed processing is realized. Additionally, by assigning an ID number to a request, the request is transferred to the request destination certainly. Furthermore, by assigning an ID number to a response, the data processing unit CPU_CHIP can recognize the memory chip as a transfer source even when the input order of requests is different from the read order of data. Therefore, because of the series connection between the data processing unit CPU_CHIP and the memory chips, the data processing unit CPU_CHIP can perform desired processing, with the reduced number of connection signals.

The present embodiment has described data read mainly, however, obviously, data write can also be performed in a similar manner. In addition, there has been described the data transfer operation between the memory chips M0 and M1, however, similar data transfer operation can also be performed between the other memory chips, although it is needless to say.

### <Clock Control>

Next, clock control of the memory module MEM will be described. When the memory module is incorporated in a portable apparatus, although not restricted thereto, all the memory chips M0, M1 and M2 in the memory module MEM do not always perform simultaneously. Therefore, in order to reduce power consumption of the portable apparatus, the memory module MEM can generate a clock at a frequency necessary for a data transfer when data transfer occurs and can stop the clock when data transfer does not occur.

Now, frequency control of a response clock signal RsCk0 output from the memory chip M0 will be given. First, a case in which a clock frequency of the response clock signal RsCk0 from the memory chip M0 is set to ½, although not specifically restricted thereto, will be described. The data processing unit CPU_CHIP inputs the ID number 2 of the memory chip M0 and a response clock divide command 2 to the memory chip M0 through the request signal RqMux0.

If the memory chip M0 transmits the response clock divide command 2 to the clock division circuit Div2 of the memory chip M0 through the request queue control circuit RqCT, the frequency of the response clock signal RsCk0 becomes ½. In reducing the clock frequency, in order to prevent malfunction caused by noise, it is desirable to gradually reduce the frequency so as to finally allow performance at a desired frequency.

Next, a case in which the response clock signal RsCk0 from the memory chip M0 to be stopped will be described. The data processing unit CPU_CHIP inputs the ID number 2 of the memory chip M0 and a response clock stop command through the request signal RqMux0. The memory chip M0 transmits the response clock stop command to the clock division circuit Div2 in the memory chip M0 through the request queue control circuit RqCT, accordingly, the response clock signal RsCk0 is stopped. In stopping a clock, in order to prevent malfunction caused by noise, it is desirable to gradually reduce the clock frequency so as to finally stop it.

Next, a restart of the stopped response clock signal RsCk0 will be described. The data processing unit CPU_CHIP inputs the ID number 2 of the memory chip M0 and a response clock restart command through the request signal RqMux0. If the memory chip M0 transmits the response clock restart command to the clock division circuit Div2 thereof through the request queue control circuit RqCT, the stopped response clock signal RsCk0 restarts its operation. In restarting the clock, in order to prevent malfunction caused by noise, it is desirable to gradually increase the frequency so as to finally allow performance at a desired frequency.

Frequency control of a response clock signal RsCk1 output from the memory chip M1 will be described. First, a case in which a clock frequency of the response clock signal RsCk1 from the memory chip M1 is set to ¼, although not specifically restricted thereto, will be described. The data processing unit CPU_CHIP inputs the ID number 1 of the memory chip M1 and a response clock divide command 4 through the request signal RqMux0. Then, the ID number 1 of the memory chip M1 and a response clock divide command 4 are transmitted to the memory chip M1 through the memory chip M0. When the memory chip M1 transmits the response clock divide command 4 to the clock division circuit Div2 of the memory chip M1 through the request queue control circuit RqCT, the frequency of the response clock signal RsCk1 becomes ¼. In reducing the clock frequency, in order to prevent malfunction caused noise, it is desirable to gradually reduce the frequency so as to finally allow the clock to operate at a desired frequency.

Next, a case of stopping the response clock signal RsCk1 from the memory chip M1 will be described. The data processing unit CPU_CHIP inputs the ID number 1 of the memory chip M1 and a response clock stop command through the request signal RqMux0. Then, through the memory chip M0, the ID number 1 and the response clock divide command4 are transmitted to the memory chip M1. The memory chip M1 transmits the response clock stop command to the clock division circuit Div2 of the memory chip M1 through the request queue control circuit RqCT, accordingly, the response clock signal RsCk1 is stopped. In stopping the clock, in order to prevent malfunction caused by noise, it is desirable to gradually reduce the clock frequency so as to finally stop it.

Next, a case of a restart of the stopped response clock signal RsCk1 will be given. The data processing unit CPU_CHIP inputs the ID number 1 of the memory chip M1 and a response clock restart command through the request signal RqMux0. Then, through the memory chip M0, the ID number 1 of the memory chip M1 and a response clock restart command are transmitted to the memory chip M1. If the memory chip M1 transmits the response clock restart command to the clock division circuit Div2 thereof through the request queue control circuit RqCT, the stopped response clock signal RsCk1 restarts its operation. In restarting the clock, in order to prevent malfunction caused by noise, it is desirable to gradually increase the frequency so as to finally allow the clock to operate at a desired frequency.

Frequency control of a response clock signal RsCk2 output from the memory chip M2 will be described. First, a case in which a clock frequency of the response clock signal RsCk2 from the memory chip M2 is set to ⅛, although not specifically restricted thereto, will be described. The data processing unit CPU_CHIP inputs the ID number 3 of the memory chip M2 and a response clock divide command 8 through the request signal RqMux0. Then, the ID number 3 of the memory chip M2 and a response clock divide command 8 are transmitted to the memory chip M2 through the memory chips M0 and M1. If the memory chip M2 transmits the response clock divide command 8 to the clock division circuit Div2 thereof through the request queue control circuit RqCT thereof, the frequency of the response clock signal RsCk2 becomes ⅛. In reducing the clock frequency, in order to prevent malfunction caused by noise, it is desirable to gradually reduce the frequency so as to finally allow it to operate at a desired frequency.

Next, a case of a stop of the response clock signal RsCk2 from the memory chip M2 will be described. The data processing unit CPU_CHIP inputs the ID number 3 of the memory chip M2 and a response clock stop command through the request signal RqMux0. Then, through the memory chips M0 and M1, the ID number 3 of the memory chip M2 and a response clock stop command are transmitted to the memory chip M2. The memory chip M2 transmits the response clock stop command to the clock division circuit Div2 thereof through the request queue control circuit RqCT thereof, accordingly, the response clock signal RsCk2 is stopped. In stopping the clock, in order to prevent malfunction caused by noise, it is desirable to gradually reduce the clock frequency so as to finally stop it.

Next, a case of a restart of the stopped response clock signal RsCk2 will be described. The data processing unit CPU_CHIP inputs the ID number 3 of the memory chip M2 and a response clock restart command through the request signal RqMux0. Then, through the memory chips M0 and M1, the ID number 3 and a response clock restart command are transmitted to the memory chip M2. If the memory chip M2 transmits the response clock restart command to the clock division circuit Div2 thereof through the request queue control circuit RqCT thereof, the stopped response clock signal RsCk2 restarts its operation. In restarting the clock, in order to prevent malfunction caused by noise, it is desirable to gradually increase the frequency so as to finally allow the clock to operate at a desired frequency.

Next, frequency control of a request clock signal RqCk1 output from the memory chip M0 will be described. First, a case in which a clock frequency of the request clock signal RqCk1 from the memory chip M0 is set to ½ will be described, although not specifically restricted thereto. The data processing unit CPU_CHIP inputs the ID number 2 of the memory chip M0 and a request clock divide command 2 through the request signal RqMux0. If the memory chip M0 transmits the request clock divide command 2 to the clock division circuit Div1 thereof through the request queue control circuit RqCT thereof, the clock division circuit Div1 generates a clock having a ½ frequency of the clock frequency of the request clock signal RqCk0 to output from the request clock signal RqCk1. The request clock signal RqCk1 is input to the memory chip M1, which in turn outputs it as a response clock signal RxCk1 through the clock driver Drv2 and the clock division circuit Div2 of the memory chip M1. In reducing the clock frequency, in order to prevent malfunction caused by noise, it is desirable to gradually reduce the frequency so as to finally allow it to operate at a desired frequency.

Next, a stop of the request clock signal RqCk1 from the memory chip M0 will be described. The data processing unit CPU_CHIP inputs the ID number 2 of the memory chip M0 and a request clock stop command through the request signal RqMux0. The memory chip M0 transmits the request clock stop command to the clock division circuit Div1 thereof through the request queue control circuit RqCT, accordingly, the clock division circuit Div1 stops the request clock signal RqCk1. The request clock signal RqCk1 is input to the memory chip M1 and output as a response clock signal RsCk1 through the clock driver Drv2 and the clock division circuit Div2 of the memory chip M1, therefore, the response clock signal RsCk1 is also stopped. In stopping the clock, in order to prevent malfunction caused by noise, it is desirable to gradually reduce the clock frequency so as to finally stop it.

Next, a case of a restart of the stopped request clock signal RqCk1 will be described. The data processing unit CPU_CHIP inputs the ID number 2 of the memory chip M0 and a request clock restart command through the request signal RqMux0. If the memory chip M0 transmits the request clock restart command to the clock division circuit Div1 of the memory chip M0 through the request queue control circuit RqCT, the clock division circuit Div1 restarts the stopped request clock signal RqCk1. The request clock signal RqCk1 is input to the memory chip M1 and output as the response clock signal RsCk1 through the clock driver Drv2 and the clock division circuit Div2 of the memory chip M1, therefore, the response clock signal RsCk1 also restarts its operation. In restarting the clock, in order to prevent malfunction caused noise, it is desirable to gradually increase the frequency so as to finally allow it to operate at a desired frequency.

Frequency control of a request clock signal RqCk2 output from the memory chip M1 will be described. First, a case in which a clock frequency of the request clock signal RqCk2 from the memory chip M1 is set to ¼ will be described, although not specifically restricted thereto. The data processing unit CPU_CHIP inputs the ID number 1 of the memory chip M1 and a request clock divide command 4 through the request signal RqMux0. Then, the ID number 1 of the memory chip M1 and a request clock divide command 4 are transmitted to the memory chip M1 through the memory chip M0. If the memory chip M1 transmits the request clock divide command 4 to the clock division circuit Div1 of its own through the request queue control circuit RqCT, the clock division circuit Div1 generates a clock having a ¼ frequency of the clock frequency of the request clock signal RqCk0 to output it from the request clock signal RqCk2. The request clock signal RqCk2 is input to the memory chip M2 and output as the response clock signal RsCk2 through the clock driver Drv2 and the clock division circuit Div2 of the memory chip M2. In reducing the clock frequency, in order to prevent malfunction caused by noise, it is desirable to gradually reduce the frequency so as to finally allow it to operate at a desired frequency.

Next, a case of stop of the request clock signal RqCk2 from the memory chip M1 will be described. The data processing unit CPU_CHIP inputs the ID number 1 of the memory chip M1 and a request clock stop command through the request signal RqMux0. Then, through the memory chip M0, the ID number1 and the request clock stop command are transmitted to the memory chip M1. The memory chip M1 transmits the request clock stop command to the clock division circuit Div1 of its own through the request queue control circuit RqCT thereof, and the clock division circuit Div1 stops the request clock signal RqCk2. The request clock signal RqCk2 is input to the memory chip M2 and output as the response signal RsCk2 through the clock driver Drv2 and the clock division circuit Div2 of the memory chip M2. Accordingly, the response clock signal RsCk2 also stops.

In stopping the clock, in order to prevent malfunction due caused by, it is desirable to gradually reduce the clock frequency so as to finally stop it.

Next, a case of restart of the stopped request clock signal RsCk2 will be described. The data processing unit CPU_CHIP inputs the ID number 1 of the memory chip M1 and a request clock restart command through the request signal RqMux0. Then, through the memory chip M0, the ID number1 and the request clock restart command are transmitted to the memory chip M1. The memory chip M1 transmits the request clock restart command to the clock division circuit Div1 of its own through the request queue control circuit RqCT thereof, accordingly, the clock division circuit Div1 thereof restarts the stopped request clock signal RqCk2. The request clock signal RqCk2 is input to the memory chip M2 and output as the response clock signal RsCk1 through the clock driver Drv2 and the clock division circuit Div2 of the memory chip M2. Accordingly, the response clock signal RsCk2 also restarts. In restarting the clock, in order to prevent malfunction caused by noise, it is desirable to gradually increase the frequency so as to finally allow the signal to operate at a desired frequency.

### <Advantages of First Embodiment>

The following will be a summary of the structure and advantages of the above embodiment.

(1) By confirmation of the series connection immediately after power up, the connections between the memories can be confirmed. Furthermore, identification of the boot device and the endmost memory chip and automatic assignment of the ID numbers to the memories facilitate connections of memory chips only as necessary, so that memory capacity can be expanded.
(2) By assigning an ID number to a request, the request from the data processing unit CPU_CHIP is transferred to each of the memory chips M0, M1 and M2 certainly. Additionally, by assigning an ID number to a response to the data processing unit CPU_CHIP, it can be confirmed that data has been correctly transmitted from each memory. Therefore, because of the series connection between the data processing unit CPU_CHIP and the memory chips M0, M1 and M2, the number of connection signals can be reduced, while the data processing unit CPU_CHIP can perform desired processing.
(3) The request interface circuit ReqIF and the response interface circuit can operate independently. Therefore, data read/write can be simultaneously performed, as a result, data transfer capability is improved.
(4) Regardless of the input order of requests, fast readable data can be read immediately without waiting for late read data, therefore, faster processing can be realized. Additionally, by assigning an ID number to a request, the request is transferred to a request destination certainly. Furthermore, by assigning an ID number to a response, the data processing unit CPU_CHIP can identify a memory chip as a transfer source even when the input order of requests is different from the read order of data.
(5) The clock of each of the memory chips M0, M1 and M2 can be operated at a low speed, stopped or restarted according to the need. Therefore, power consumption can be reduced.
(6) In read operation from the memory chip M2, error detection and correction are performed, while in write operation, replacement processing is performed for a bad address in which a write operation has been done incorrectly. Thus, processing reliability can be maintained.

Furthermore, the present embodiment has shown the example of the memory module MEM including one volatile memory, one NOR flash memory and one NAND flash memory. However, obviously, the present invention can be realized even when the memory module MEM includes a plurality of volatile memories, a plurality of NOR flash memories and a plurality of NAND flash memories.

### <Description of Memory Map>

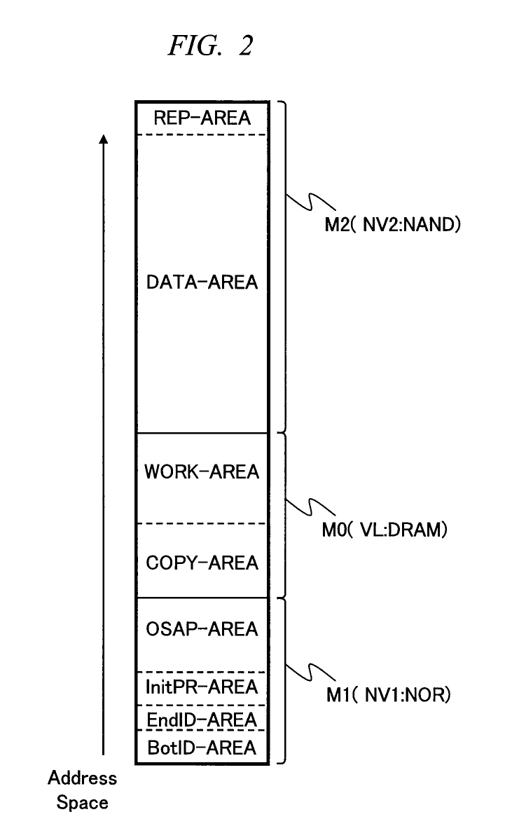

FIG. 2 shows an example of a memory map regarding the memory module MEM0 managed by the data processing unit CPU_CHIP. In this embodiment, a typical memory map will be explained by taking an example of a memory module which includes memory chips M0 and M1 each may have a 1 GB capacity, and the memory chip M2 which may have a capacity of 4 GB+128 MBit (128 Mbit is replacement area), although not restricted thereto.

The memory chip M0 may be a volatile memory such as a dynamic random access memory composed of dynamic random access memory cells, with a read access time of approximately 15 ns, although not restricted thereto. The memory chip M1 may be a nonvolatile memory such as a NOR flash memory composed of NOR flash memory cells, with a read access time of approximately 80 ns, although not restricted thereto. The memory chip M2 may be a nonvolatile memory such as a NAND flash memory composed of NAND flash memory cells, with a read access time of approximately 25 usec, although not restricted thereto. The memory chip M1 is divided into a boot device ID storage area BotID-AREA, an endmost device ID storage area EndID-AREA, an initial program area InitPR-AREA and a program storage area OSAP-AREA, although not restricted thereto.

The boot device ID storage area BotID-AREA stores ID information of a boot device. The endmost device ID storage area EndID-AREA stores endmost memory device ID information regarding memory chips connected in series. The initial program area InitPR-AREA stores a boot program, although not restricted thereto. The program storage area OSAP-AREA may store an operating system, a communication program for audio communication and data communication, an application program for playing music, still image, and moving picture, and the like, although not restricted thereto. The memory chip M0 may be divided into a copy area COPY-AREA and a work area WORK-AREA, although not restricted thereto. The work area WORK-AREA may be used as a work memory for executing a program, while the copy area COPY-AREA may be used as a memory for copying programs and data from the memory chips M1 and M2. The memory chip M1 may store an operating system, a communication program for audio communication and data communication, an application program for playing music, still image and moving picture, and the like, although not restricted thereto. The memory chip M2 may be divided into a data area DATA-AREA and a replacement area REP-AREA, although not restricted thereto. The data area DATA-AREA may store music data, audio data, moving image data, static image data, and the like, although not restricted thereto.

The reliability of flash memory tends to be degraded by repetitive rewrite operations. Data written during write operations becomes different when read out, or data is not even written during a write operation, although these are rare. The replacement area REP-AREA is provided for replacing incorrect data into a new area. The capacity of the replacement area REP-AREA is not defined strictly, but may be determined so as to ensure the secured reliability of the memory chip M2.

### <Operations Immediately After Turning Power On>

Data transfer from the memory chip M1 to the data processing unit CPU_CHIP immediately after turning power on will be described. After turning power on, the data processing unit CPU_CHIP sets its boot device ID register BotID to 1. The memory chip M1 reads boot device ID information 1 from the boot device ID storage area BotID-AREA to set 1 into its own ID register. Thereby, the memory chip M1 is identified as a boot device.

Next, the data processing unit CPU_CHIP transmits the ID number 1 of the memory chip M1 and a read command to the memory module MEM to read the boot program and endmost memory device ID information stored in the memory chip M1 as the boot device. Based on the ID number 1 and the read command, the memory module MEM0 reads the boot program from the initial program area InitPR-AREA of the memory chip M1, as well as reads the endmost memory device ID information from the endmost device ID storage area EndID-AREA thereof to transmit to the data processing unit CPU_CHIP. In this manner, initialization of the boot device ID is performed immediately after turning power on, therefore, the boot device in the memory module M0 formed by connecting the memory chips in series can be identified. Accordingly, while greatly reducing the number of connection signals between the data processing unit CPU_CHIP and the memory module MEM0, the data processing unit CPU_CHIP can immediately and surely read out the boot program and the endmost memory device ID from the boot device to boot itself and the memory module MEM0.

### <Description of Data Copy Operation>

A data read time of the memory chip M0 is greatly shorter than that of the memory chip M2. Accordingly, if necessary image data is transmitted from the memory chip M2 to the memory chip M0 in advance, the data processing unit CPU_CHIP can perform fast image processing. Now, a data transfer from the memory chip M2 to the memory chip M0 in the case where the ID register numbers of the memory chips M0, M1 and M2 are set to 2, 1 and 3, respectively, will be described, although not restricted thereto.

The data processing unit CPU_CHIP transmits the ID number 3 of the memory chip M2 and a single-page (512-byte data+16-byte ECC code) data read command to the memory module MEM0 to read out data from the data area DATA-AREA of the memory chip M2. Based on the ID number 3 and the single-page data read command, the memory module MEM0 reads out a single-page data from the data area DATA-AREA of the memory chip M2, adds the ID number 3 to the data and then transmits them to the data processing unit CPU_CHIP.

The data processing unit CPU_CHIP performs error detection to the single-page data from the memory chip M2. If there is no error, the data processing unit CPU_CHIP transmits the ID number 2 of the memory chip M0 and the single-page read command to the memory module MEM0 to transfer the single-page data to the copy area COPY-AREA of the memory chip M0. If there is any error, after correcting the error, the data processing unit CPU_CHIP transmits the ID number 2 of the memory chip M0 and the single-page read command to the memory module MEM0 to transfer the single-page data to the copy area COPY-AREA of the memory chip M0. Based on the ID number 2 and the single-page data read command, the memory module MEM0 writes the single-page data into the copy area COPY-AREA of the memory chip M0.

Next, data transfer from the memory chip M0 to the memory chip M2 in the case where the image data is written at a high speed from the data processing unit CPU_CHIP into the memory chip M0 and stored in the memory chip M2 if needed will be described. The data processing unit CPU_CHIP transmits the ID number 2 of the memory chip M0 and a single-page (512-byte) data read command to the memory module MEM0 to read out data from the copy area COPY-AREA of the memory chip M0. Based on the ID number 2 and the single-page data read command, the memory module MEM0 reads out a single-page data from the copy area COPY-AREA of the memory chip M0, adds the ID number 2 to the data, and then transmits to the data processing unit CPU_CHIP. The data processing unit CPU_CHIP transmits the ID number 3 of the memory chip M2 and a single-page data write command to the memory module MEM0 to transfer the single-page data from the memory chip M0 to the data area DATA-AREA of the memory chip M2.

If the memory module MEM0 transmits the ID number 3 and the single-page data write command to the memory chip M2 through the memory chips M0 and M1, the memory chip M2 writes the single-page data into the data area DATA-AREA thereof. The memory chip M2 checks whether the data has been correctly written, and if succeeded, finishes the write operation. If the write has failed, the memory chip M2 transmits the ID number 2 and write error information through the memory chips M1 and M0 to report the write error to the data processing unit CPU_CHIP. After receiving the ID number 3 and the write error information, the data processing unit CPU_CHIP transmits the ID number 3 of the memory chip M2 and a single-page data write command to the memory module MEM0 to write data at a new address of the replacement area REP-AREA prepared in advance in the memory chip M2. If the memory module MEM0 transmits the ID number 3 and the single-page data write command to the memory chip M2 through the memory chips M0 and M1, the memory chip M2 writes the single-page data into the replacement area REP-AREA thereof. Additionally, in the case where the replacement processing has been done, the data processing unit CPU_CHIP retains and manages a bad address and address information regarding an address with which the bad address has been replaced.

As described above, by maintaining the area for copying a part of data of the memory chip M2 and transmitting data in advance from the memory chip M2 to the memory chip M0, the data of the memory chip M2 can be read out at a speed equal to that of the memory chip M0, so that the data processing unit CPU_CHIP can perform fast processing. And, when data is written in the memory chip M2, the data is temporarily written in the memory chip M0 and can be written back into the memory chip M2 as needed, therefore, data write can also be performed faster. Furthermore, in the read operation from the memory chip M2, error detection and correction are performed, and in the writing operation, replacement processing is performed for a bad address where the write operation has not been performed correctly. Therefore, highly reliable processing can be maintained. Note that, the operation transmitting a part of data of the memory chip M2 to the memory chip M0 is described here, however, needless to say, since the memory chip M0 can comprise an area in which a part of data of the memory chip M1 is copied, a part of data of the memory chip M1 can be transmitted to the memory chip M0. And, the memory chips M0, M1 and M2 are memory modules that are series connected in order of shorter read time. It is needless to say that by setting up an area in which a part of data of the memory chips M1 and M2 can be copied in the memory chip M0, and transmitting a data from the memory chips M1 and M2 to the memory chip M0 in advance, the data of the memory chips M1 and M2 can be read out at a speed equal to that of the memory chip M0 so that the data processing unit CPU_CHIP can perform fast processing.

### <Initial Sequence Upon Turning Power On>

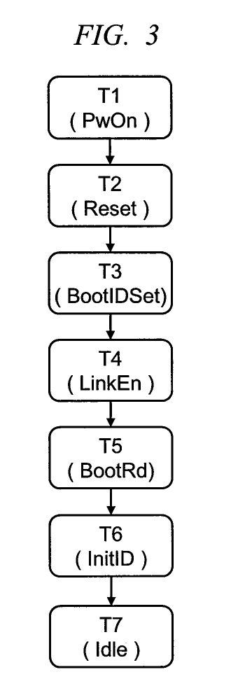

FIG. 3 shows an initial sequence upon turning power on in the information system apparatus composed of the data processing unit CPU_CHIP and the memory module MEM0. At period T1 (PwON), power is turned on to the data processing unit CPU_CHIP and the memory chips M0, M1 and M2 in the memory module MEM0. At period T2 (RESET), reset is executed. The method of reset is not limited, but may be executed using individual built-in circuits or a reset signal from an external reset terminal. At the reset period T2, the data processing unit CPU_CHIP sets the boot device ID register BotID and the endmost device ID register EndID, respectively, to 1 and 0. Each of the memory chips M0, M1 and M2 resets the individual ID number thereof to 0 and also resets an ID valid bit thereof to low. In addition, the memory chips M0, M1 and M2 initialize the response queue priority thereof and the number of frequency of response execution for changing the priority. Furthermore, the memory chips M0, M1 and M2 initialize a clock frequency division ratio thereof.

At period T3 (BootIDSet) in which reset has been cancelled, a boot device sets a boot device ID into its ID register. The boot device identification signal Bsig of each of the memory chips M0 and M2 is connected to the power source, therefore, those memory chips each identify themselves as not a boot device and keep the ID register number thereof to 0. Since the boot device identification signal Bsig of the memory chip M1 is grounded, the memory chip M1 identifies itself as a boot device, therefore, the memory chip M1 reads out the boot device ID number 1 in the memory circuit MemNV1 thereof to store the number in the ID register and then sets the ID valid bit to high. At period T4 (LinkEn) after period T3 is over, it is confirmed whether the signal connections are established between the memory chips M0, M1 and M2. The memory chip M2 identifies itself as the endmost memory chip among those connected in series and thus sets the request enable signal RqEn2 to high.

Next, the memory chip M1 confirms that the request enable signal RqEn2 has become high and sets the response enable signal RsEn2 and the request enable signal RqEn1 to high. Then, the memory chip M0 confirms that the request enable signal RqEn1 has become high and sets the response enable signal RsEn1 and the request enable signal RqEn0 to high. Finally, the data processing unit CPU_CHIP confirms that the request enable signal RqEn0 has become high and recognizes that signal connections between the memory chips have been confirmed, therefore, data processing unit CPU_CHIP sets the response enable signal RsEn0 to high. At period T5 (BootRD), after period T4 has been finished, the data processing unit CPU_CHIP reads out boot data from the memory chip M1.

The data processing unit CPU_CHIP synchronizes a request NRDm1 generated by multiplexing the ID number 1 of the memory chip M1, a read command and addresses to transmit to the memory chip M0 through the request signal RqMux0. Since the ID valid bit of the memory chip M0 is low, the memory chip M0 synchronizes the request ReqNRDm1 with the clock signal RqCK1 to transmit to the memory chip M1 through the request signal RqMux1y. The memory chip M1 stores the request ReqNRDm1 from the memory chip M0 in the request queue control circuit RqCT of its own. Due to the high ID valid bit thereof, the memory chip M1 compares the ID number 1 included in the request ReqNRDm1 with the ID register number 1 thereof. Since the comparison result indicates a match, the ReqNRDm1 is transferred to the memory circuit MemNV1. Based on the request ReqNRDm1, the boot data and the endmost device ID number 3 are read out from the memory circuit MemNV1 and, along with the ID register number 1, transferred as a response ResNRDm1 to the response queue control circuit RsCT. The response queue control circuit RsCT of the memory chip M1 transfers the response ResNRDm1 to the memory chip M0 through the response signal RqMux1. Finally, the response queue control circuit RsCT of the memory chip M0 transfers the response ResNRDm1 to the data processing unit CPU_CHIP through the response signal RqMux0. The data processing unit CPU_CHIP receives the response ResNRDm1 and stores the endmost device ID number 3 in the endmost device ID register ENDID in the memory control circuit CON. Then, the data processing unit CPU_CHIP boots itself with the received boot program. At period T6 (InitID) after period T5 is over, based on the boot code, the data processing unit CPU_CHIP sets an ID number of each memory chip.

The data processing unit CPU_CHIP, first, transfers the ID number 2 and an ID setting command to the memory chip M0 through the request signal RqMux0. In the memory chip M0, the ID valid bit is low and thus ID number has not yet been assigned, therefore, based on the ID number 2 and the ID setting command, the memory chip M0 stores the ID number 2 in its ID register, and the ID valid bit is set to high. If the ID valid bit becomes high, it indicates that ID assignment has been completed. Upon the completion of ID assignment, the memory chip M0 notifies the ID number 2 and the information of ID setting completion to the data processing unit CPU_CHIP through the response signal RsMux0.

When the data processing unit CPU_CHIP recognizes that the ID setting of the memory chip M0 has been completed, the ID number 3 and an ID setting command are transferred to the memory chip M0 through the request signal RqMux0. The memory chip M0 compares its own ID number 2 with the ID number 3 and detects a mismatch therebetween. Thus, the memory chip M0 transfers the ID number 3 and the ID setting command to the memory chip M1. Since the memory chip M1 already has its ID number, the memory chip M1 compares its ID number 1 with the ID number 3. Since they are different, the memory chip M1 transfers the ID number 3 and the ID setting command to the memory chip M2 through the request signal RqMux2.

The memory chip M2 does not have its ID number yet, therefore, based on the ID number 3 and the ID setting command, the memory chip M2 sets the ID number 3 into the ID register, and the ID valid bit is set to high. The high ID valid means completion of the ID number assignment. Due to the completion thereof, the memory chip M2 transmits the ID number 3 and information of the ID number setting completion to the data processing unit CPU_CHIP through the memory chips M1 and M0. The data processing unit CPU_CHIP compares the transmitted ID number 3 with the endmost device ID number 3 set in the endmost device ID register EndID in the memory control circuit CON. Since there is a match, the data processing unit CPU_CHIP confirms the completion of ID numbering of the endmost memory chip.

From period T7 (Idle), after period T6 has been finished, the memory module MEM0 goes into an idling state, waiting for a request from the data processing unit CPU_CHIP.

### <Description of Memory Chip M0>

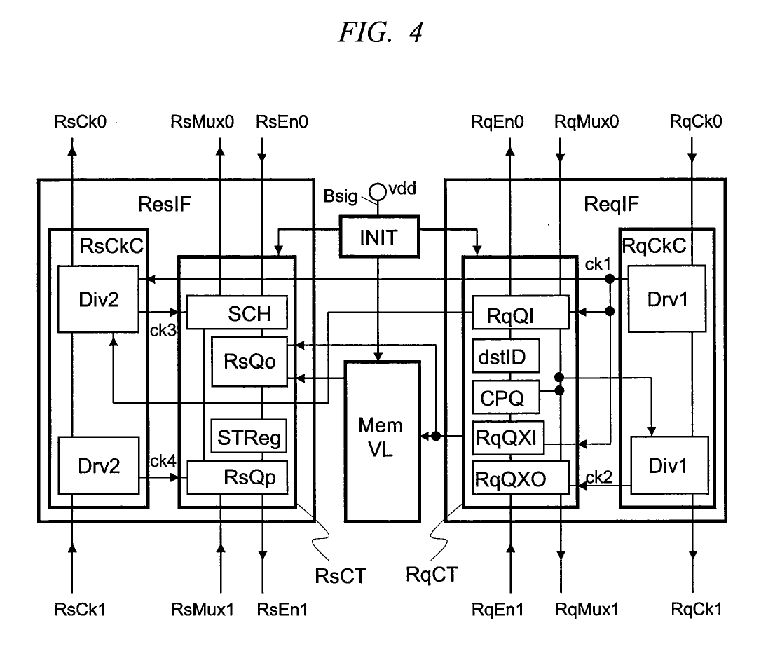

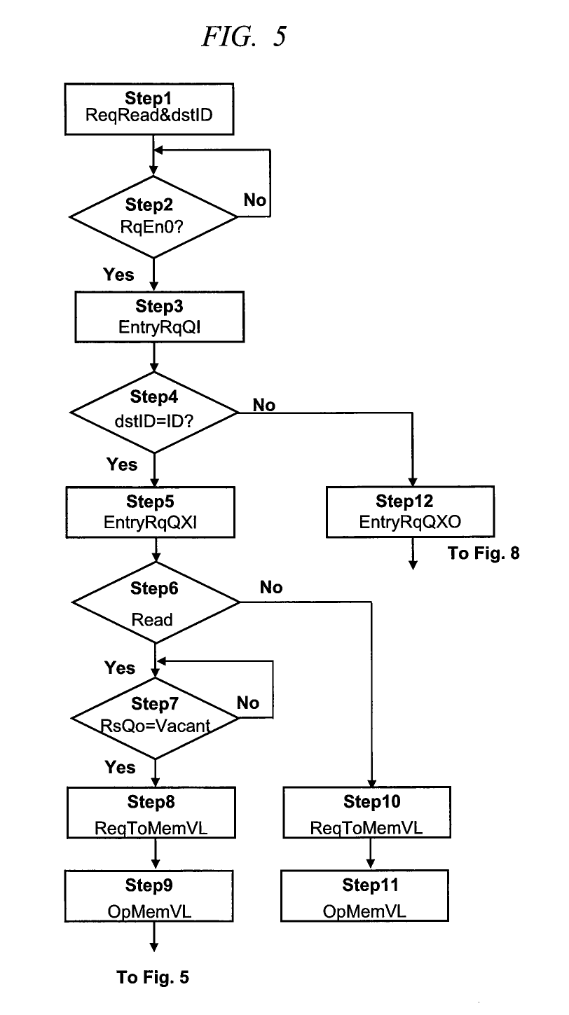

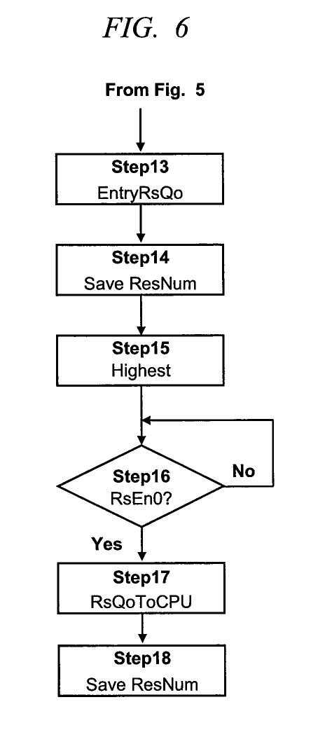

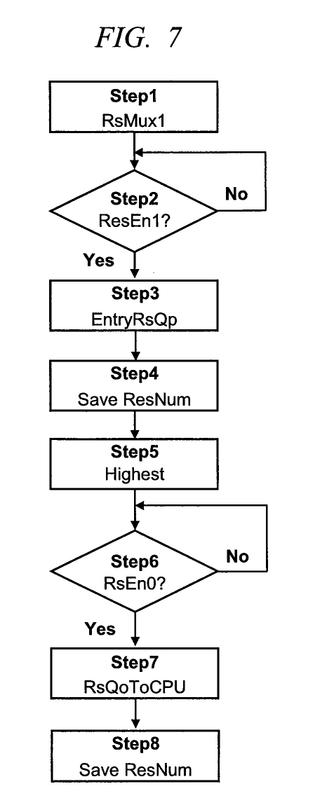

FIG. 4 shows an example of a block diagram of the memory chip M0. FIG. 5 is a flowchart showing an example of an operation performed when a request occurs to the memory chip M0. FIG. 6 is a flowchart showing an example of an operation performed when a response occurs from the memory circuit MemVL of the memory chip M0. FIG. 7 is a flowchart showing an example of an operation performed when a response occurs from the memory chip M1 to the memory chip M0. Operations of the individual circuit blocks will be described below.

The memory chip M0 is composed of a request interface circuit ReqIF, a response interface circuit ResIF, an initialization circuit INIT and a memory circuit MemVL. The request interface circuit ReqIF is composed of a request clock control circuit RqCkC and a request queue control circuit RqCT. The request clock control circuit RqCkC is composed of a clock driver circuit Drv1 and a clock division circuit Div1. The request queue control circuit RqCT is composed of request queue circuits RqQI, RqQXI and RqQXO, an ID register circuit dstID and an ID comparison circuit CPQ. Although not restricted thereto, the request queue circuit RqQI may be composed of two request queues, the request queue circuit RqQXI may be composed of a request queue; and the request queue circuit RqQXO may be composed of two request queues. The response interface circuit ResIF is composed of the response clock control circuit RsCkC and the response queue control circuit RsCT. The response clock control circuit RsCkC is composed of a clock driver Drv2 and a clock division circuit Div2. The response queue control circuit RsCT is composed of response queue circuits RsQo and RsQp, a status register circuit STReg and a response schedule circuit SCH. Although not restricted thereto, the response queue circuits RsQo and RsQp, respectively, may be composed of four response queues.

Although not restricted thereto, the memory circuit MemVL may be a volatile memory, and is a dynamic random access memory using dynamic random access memory cells. The initialization circuit INIT initializes the memory chip M0 upon turning power on to the memory chip M0. The request clock control circuit RqCkC transmits a clock input from the request clock signal RqCk0 to the request queue control circuit RqCT and the response clock control circuit RsCkC through an internal clock ck1. And, the request clock control circuit RqCkC outputs the clock input from the request clock signal RqCk0 through the clock driver Drv1 and the clock division circuit Div1 from the request clock signal RqCk1. Additionally, according to a command input through the request signal RqMux0, the request clock control circuit RqCkC can reduce clock frequencies of the clock signal ck2 and the request clock RqCk1, can stop and restart the clock.

The response clock control circuit RsCkC outputs the clock input from the internal clock signal ck1 to the response queue control circuit RsCT through the internal clock signal ck3. And, the response clock control circuit RsCkC also outputs the clock input from the internal clock signal ck1 through the clock division circuit Div2 by clock signal RsCk0. And, the response clock control circuit RsCkC outputs the clock input from the clock signal RsCK1 to the response queue control circuit RsCT through the clock driver Div2 by the clock signal ck4. Furthermore, according to a command input through the request signal RsMux0, the response clock control circuit RsCkC can also reduce a clock frequency of the response clock RsCk0, as well as can stop and restart the clock.

The request queue circuit RqQI stores a request in which an ID number, a command, addresses and write data have been multiplexed and input to the memory chip M0 through the request signal RqMux0. The ID register circuit dstID stores the ID number of the memory chip M0 and an ID valid signal. The ID comparison circuit CPQ compares the ID number stored in the request queue circuit RqQI with the ID number stored in the ID register circuit dstID.

The request queue circuits RqQXI and RqQXO store a request transferred from the request queue circuit RqQI. The response queue circuit RsQo stores data read out from the memory circuit MemVL of the memory chip M0 and the ID number from the ID register circuit dstID thereof. The response queue circuit RsQp stores an ID number, read data, error information and status information input through the response signal RsMux1.

The status register circuit STRReg stores unprocessed response information indicating that responses exist in the response queue circuits RsQo and RsQp, although not restricted thereto. The response schedule circuit SCH determines priorities of the responses stored in the response queue circuits RsQo and RsQp and arbitrates such that a higher priority response is output from the response signal RsMuxo. The response schedule circuit dynamically changes the response priority according to the frequencies of responses output from the response queue circuits RsQo and RsQp.

Next, operation of the memory chip M0 will be described. First, an operation upon turning power on to the memory chip M0 will be described. When power is turned on to the memory chip M0, the initialization circuit INIT initializes the memory chip M0. First, the ID register number of the ID register circuit dstID is set to 0 and the ID valid bit is set to low. Next, the priority of a response input to the response queue circuit RsQo of the response schedule circuit SCH is set to 1, the priority of a response input to the response queue circuit RsQp from the memory chip M1 to 2 and the priority of a response from the memory chip M2 to 3, respectively. Upon completion of the initialization by the initialization circuit INIT, the memory chip M0 confirms that communications are established between the data processing unit CPU_CHIP and the memory chip M1. The memory chip M0 also confirms that the request enable signal RqEn1 has become high and then sets the response enable signal RsEn1 and the request enable signal RqEn0 to high.

Next, the data processing unit CPU_CHIP confirms that the request enable signal RqEn0 has become high and recognizes that signal connections between the memory chips have been confirmed. Then, the data processing unit CPU_CHIP sets the response enable signal RsEn0 to high. Upon completion of the communications confirmation, the data processing unit CPU_CHIP transfers the ID number 2 and an ID setting command to the memory chip M0 through the request signal RqMux0. In the memory chip M0, due to the low ID valid bit, it is determined that ID number has not been assigned yet. Accordingly, the ID number 2 is stored in the ID register and the ID valid bit is set to high so as to complete the ID number assignment. Then, the memory chip M0 outputs the ID number 2 thereof and information of the ID number assignment completion to the data processing unit CPU_CHIP through the response signal RsMux0.

Next, an operation in the case where a request from the data processing unit. CPU_CHIP occurs to the memory chip M0 after the operation immediately after turning power on has been finished. The request queue circuit RqQI of the memory chip M0 may be composed of two request queues RqQI-O and RqQI-1, although not restricted thereto. Additionally, since there is no request entry in the request queues RqQI-O and RqQI-1, the memory chip M0 sets the request enable signal RqEn0 to high and notifies the data processing unit CPU_CHIP that a request can be received. Although not restricted thereto, the response queue circuit RsQo of the memory chip M0 may be composed of two response queues RqQo-O and RqQp-1 and the response queue circuit RsQp thereof may be composed of two response queues RsQo-O and RsQp-1. The data processing unit CPU_CHIP sets the response enable signal RsEn0 to high and notifies the memory chip M0 that a response can be received. The data processing unit CPU_CHIP synchronizes a request ReqBAb0m0 generated by multiplexing the ID number 2, a bank active command BA, a bank address BK1 and a row address Row with the clock signal RqCk0 to transfer to the memory chip M0 through the request signal RqMux0 (Step 1 in FIG. 5).

Next, through the request signal RqMux0, a request ReqRD32b0m0 generated by multiplexing the ID number 2, a 32-byte data read command RD4, a bank address BK0 and a column address Col255 is synchronized with the clock signal RqCK0 to transfer to the memory chip M0 (Step 1 in FIG. 5). If the request enable signal RqEn0 is low (Step 2 in FIG. 5), the requests from the data processing unit CPU_CHIP are not stored in the request queue circuit RqQI of the memory chip M0. If the request enable signal RqEn0 is high (Step 2 in FIG. 5), the requests ReqBAb0m0 and ReqRD32b0m0 are stored in order in the request queues RqQI-0 and RqQI-1, respectively, of the request queue circuit RqQI (Step 3 in FIG. 5). Consequently, since all request queues of the request queue circuit RqQI are occupied, no new request from the data processing unit CPU_CHIP can be received. Therefore, the request enable signal RqEn0 is set to low. By setting the request enable signal RqEn0 to low, the data processing unit CPU_CHIP can recognize that the memory chip M0 cannot receive any request.

Then, the ID comparison circuit CPQ compares the ID number 2 of the request ReqBAb0m0 in the request queue RqQI-O with the ID number 2 in the ID register circuit dstID (Step 4 in FIG. 5). Since there is a match, the request ReqBAb0m0 is transferred to the request queue circuit RqQXI (Step 5 in FIG. 5). If there is not a match, the request ReqBAb0m0 is transferred to the request queue circuit RqQXO and then to the memory chip M1 (Step 12 in FIG. 5).

Next, the request queue circuit RqQXI checks whether the stored request includes a read command (Step 6 in FIG. 5). If it is included, the request queue circuit RqQXI checks the status of vacancy of the response queues RqQp-O and RqQp-1 of the response queue circuit RsQo (Step 7 in FIG. 5). Since the request ReqBAb0m0 does not include a read command, the request queue circuit RqQXI transfers the stored request ReqBAb0m0 to the memory circuit MemVL (Step 10 in FIG. 5). The memory circuit MemVL operates according to the request ReqBAb0m0 (Step 11 in FIG. 5). Specifically, based on the bank active command BA, the bank address BK0 and the row address Row63 in the request ReqBAb0m0, the memory circuit MemVL activates 1-KB memory cells connected to row 63 of bank 0 to transfer them to the sense amplifier of bank 0 (Step 11 in FIG. 5).

Because the request ReqBAb0m0 has been processed, there is a space for one request in the request queue RqQI-O. Thus, the memory chip M0 sets the request enable signal RqEn0 to high and notifies the data processing unit CPU_CHIP that a new request can be received. The data processing unit CPU_CHIP confirms that the request enable signal RqEn0 has become high. Then, the data processing unit CPU_CHIP synchronizes a request ReqWT23b0m0 generated by multiplexing ID number 2, a 32-byte data write command WT, a bank address Bk0, a column address Col127 and a 32-byte write data with the clock signal RqCK0 to transfer to the memory chip M0 (Step 1 in FIG. 5).

After checking the request enable signal RqEn0 (Step 2 in FIG. 5), due to the high request enable signal RqEn0, the memory chip M0 stores the request ReqWT23b0m0 from the data processing unit CPU_CHIP in the request queue RqQI-O of the request queue control circuit RqCT thereof (Step 3 in FIG. 5).

Independently but in parallel with the above operation for storing the new request ReqWT23b0m0 (Step 3) in the request queue RqQI-O of the request queue control circuit RqCI thereof, the memory chip M0 can process the request ReqRD32b0m0 stored previously in the request queue RqQI-1 (Step 4 and thereafter in FIG. 5).

Next an operation for processing the request ReqRD32b0m0 that has been already stored in the request queue RqQI-1 will be described. The ID comparison circuit CPQ compares the ID number 2 of the request ReqRD32b0m0 stored in the request queue RqQI-1 with the ID number 2 retained in the ID register circuit dstID (Step 4 in FIG. 5). Since the comparison result shows a match, the request ReqRD32b0m0 is transferred to the request circuit RqQXI (Step 5 in FIG. 5). If it shows a mismatch, the request ReqRD32b0m0 is transferred to the request queue circuit RqQXO and then to the memory chip M1 (Step 12 in FIG. 5). Next, the request queue circuit RqQXI checks whether the stored request includes a read command (Step 6 in FIG. 5). Since the request ReqRD32b0m0 includes the read command, the request queue circuit RqQXI checks the status of vacancy of the response queues RsQp-0 and RsQp-1 of the response queue circuit RsQo (Step 7 in FIG. 5). If there is no vacancy, the request queue circuit RqQXI stops the transfer of the request ReqRD32b0m0 until a vacancy occurs. If a vacancy is available in the response queues RsQp-O and RsQp-1 thereof, the request queue circuit RqQXI transfers the stored request ReqRD32b0m0 to the memory circuit MemVL (Step 8 in FIG. 5). The memory circuit MemVL operates according to the request ReqRD32b0m0 (Step 9 in FIG. 5). Specifically, based on the ID number 2, the 32-byte data read command, the bank address BK0 and the column address Col255 included in the request ReqRD32b0m0, the memory circuit MemVL reads out a 32-byte data which starts with a address specified by the column address 255 from data retained in the sense amplifier of bank 0 (Step 9 in FIG. 5), and stores the data with the ID register number 2 as a response ResRD32b0m0 into the response queue RsQo-O of the response queue circuit RsQo in the response queue control circuit RsCT (Step 13 in FIG. 6).

If responses are stored in the response queue circuits RsQo and RsQp, the response schedule circuit SCH stores the number of responses present in response queue circuits RsQo and RsQp in the status register circuit STReg (Step 14 in FIG. 6). Additionally, response priorities of the responses stored in the response queue circuits RsQo and RsQp is determined (Step 15 in FIG. 6). Next, the response enable signal RsEn0 is checked (Step 16 in FIG. 6), and if the signal is high, highest priority response is transmitted to the data processing unit CPU_CHIP through the response signal RsMux0 (Step 17 in FIG. 6). If the response enable signal RsEn0 is low, the transfer is not performed.

If a response in the response queue circuits RsQo and RsQp has been completely transmitted to the data processing unit CPU_CHIP, the response schedule circuit SCH checks the number of responses left in the response queue circuits RsQo and RsQp and updates the number of the responses in the status register STReg (Step 18 in FIG. 6). In the current situation, the response enable signal RsEn0 is high and the response ResRD32b0m0 is an only response stored in the response queue circuit RsQo and RsQp. Therefore, the response schedule circuit SCH stores a response quantity 1 in the status register STReg, sets a response priority level of the response ResRD32b0m0 to the highest and then transmits the response ResRD32b0m0 to the data processing unit CPU_CHIP. After the response ResRD32b0m0 has been transmitted, there is no response left in the response queue circuits RxQo and RsQp, therefore, the response schedule circuit SCH stores a response quantity 0 in the status register STReg.

If the response ResRD32b0m0 corresponding to the request ReqRD32b0m0 has been stored in the response queue circuit RsQo, the request ReqWT23b0m0 can be processed even while the response ResRD32b0m0 is being output to the data processing unit CPU_CHIP (Step 4 or later in FIG. 5).

Next, an operation for processing the request ReqWT23b0m0 stored already in the request queue RqQI-O will be described. The ID comparison circuit CPQ compares the ID number 2 included in the request ReqWT23b0m0 of the request queue RqQI-0 with the ID number 2 retained in the ID register circuit dstID (Step 4 in FIG. 5). Since the comparison result shows a match, the request ReqWT23b0m0 is transferred to the request queue circuit RqQXI (Step 5 shown in FIG. 5). If the result shows a mismatch, the request ReqWT23b0m0 is transferred to the request queue circuit RqQXO and then to the memory chip M1 (Step 12 in FIG. 5).

Next, the request queue circuit RqQXI checks whether the stored response includes a read command or not (Step 6 in FIG. 5). If the read command is included, the request queue circuit RqQXI checks the status of vacancy of the response queues RqQp-0 and RqQp-1 of the response queue circuit RsQo (Step 7 in FIG. 5). Since the request ReqWT23b0m0 does not include a read command, the request queue circuit RqQXI transfers the stored request ReqWT23b0m0 to the memory circuit MemVL (Step 10 in FIG. 5). The memory circuit MemVL operates according to the request

ReqWT23b0m0 (Step 11 in FIG. 5). Specifically, based on the ID number 2, the 32-byte data write command WT, the bank address BK0, the column address Col127 and the 32-byte write data in the request ReqWT23b0m0, the memory circuit MemVL writes a 32-byte data which starts with address specified by the column address 127 into the sense amplifier of memory bank 0.

FIG. 7 is a flowchart showing an operational example in the case where a response occurs from the memory chip M1 to the memory chip M0. Through the response signal RsMux1, a response synchronized with the response clock signal RsCK1 is transmitted to the memory chip M0 (Step 1 in FIG. 7). If the response enable signal ResEn1 is low (Step 2 in FIG. 7), the response is not stored in the response queue circuit RsQp of the memory chip M0. If the signal is high (Step 2 in FIG. 7), the response is stored in the response queue circuit RsQp of the memory chip M0 (Step 3 in FIG. 7). If the response is stored in the response queue circuit RsQp, the response schedule circuit SCH stores the number of responses present in the response queue circuits RsQo and RsQp in the status register STReg (Step 4 in FIG. 6). Additionally, the response schedule circuit SCH determines the response priorities of responses stored in the response queue circuits RsQo and RsQp (Step 5 in FIG. 6). Next, the response schedule circuit SCH checks the status of the response enable signal RsEn0 (Step 6 in FIG. 6). If the response enable signal RsEn0 is high, the response schedule circuit SCH transmits a highest priority response to the data processing unit CPU_CHIP through the response signal RsMux0 (Step 7 in FIG. 6). If the response enable signal RsEn0 is low, the transfer is not executed.

When one of responses stored in the response queue circuits RsQo and RsQp have been completely transmitted to the data processing unit CPU_CHIP, the response schedule circuit SCH checks the number of responses left in the response queue circuits RsQo and RsQp and updates the number of responses in the status register STReg (Step 8 in FIG. 6).

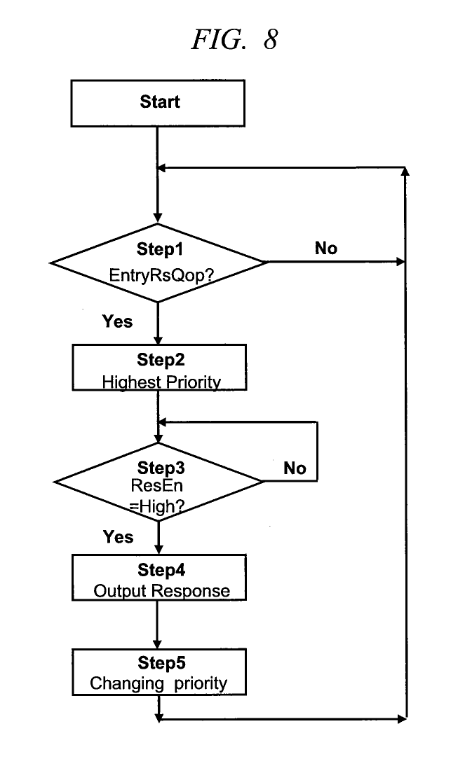

The response schedule circuit SCH operates as follows. FIG. 8 is a flowchart showing the operation of the response schedule circuit SCH. The response schedule circuit SCH, first, checks whether there is any entry in the response queue circuits RsQo and RsQp (Step 1). If there is no response entry in the response queue circuits RsQo and RsQp, the response schedule circuit SCH checks the status of the response entry in the response queue circuits RsQo and RsQp again. If response entry occurs in one of the response queue circuits RsQo and RsQp, the response schedule circuit SCH checks a response priority and prepares for a transfer of a highest priority response (Step 2).

Next, the response schedule circuit SCH checks the status of the response enable signal RsEn0 (Step 3). If the signal RsEn0 is low, the circuit dose not output a response and waits until the signal RsEn0 becomes high. If the signal RsEn0 is high, the response schedule circuit SCH outputs a response having the highest priority (Step 4), and then changes a response output priority (Step 5).

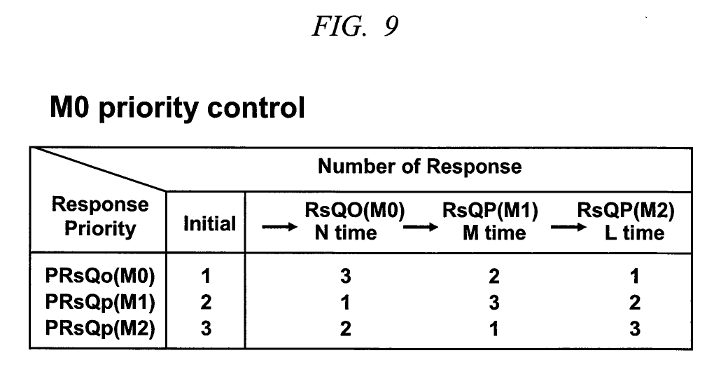

An example of a response priority changing operation by the response schedule circuit SCH of the memory chip M0 will be described. FIG. 9 shows control of a dynamic response priority by the response schedule circuit SCH of the memory chip M0.

First, a response priority control in the memory chip M0 will be described. In initialization (Initial) immediately after turning power on, a priority PRsQo(M0) of a response from the memory chip M0 in the response queue circuit RsQo is set to 1 and a priority PRsQp(M1) of the response from the memory chip M1 in the response queue circuit RsQp is set to 2, a priority PRsQp(M2) of the response from the memory chip M2 in the response queue circuit RsQp is set to 3, respectively. Although not restricted thereto, it is assumed that a response priority set to a smaller number implies a higher response priority. When a response RsQo(M0) from the memory chip M0 in the response queue circuit RsQo has been output Ntime time(s), the priority PRsQo (M0) of a response stored in the response queue circuit RsQo from the memory chip M0 becomes 3, the lowest. And, the priority PRsQp(M1) of response from the memory chip M1 becomes 1 (the highest), the priority PRsQp(M2) of response from the memory chip M2 in the response queue circuit RsQp becomes 2, respectively.

When a response PRsQp (M1) from the memory chip M1 in the response queue circuit RsQp has been output Mtime time(s), the priority PRsQp(M1) of the response from the memory chip M1 in the response queue circuit RsQp becomes 3 (the lowest). And, the priority PRsQp(M2) of a response from the memory chip M2 in the response queue circuit RsQp becomes 1 (the highest) and the priority PRsQo(M0) of a response from the memory chip M0 in the response queue circuit RsQo becomes 2.

Next, when a response RsQp(M2) from the memory chip M2 in the response queue circuit RsQp has been output Ltime time (s), the priority PRsQp(M2) of the response in the response queue circuit RsQp from the memory chip M2 becomes 3 (the lowest), and the priority PRsQo(M0) of a response from the memory chip M0 in the response queue circuit RsQo becomes 1 (the highest). The priority PRsQp (M1) of a response from the memory chip M1 in the response queue circuit RsQp becomes 2. The response output frequency Ntime used for changing the priority of a response stored in the response queue circuit RsQo from the memory chip M0, the response output frequency Mtime used for changing the priority of a response stored in the response queue circuit RsQp from the memory chip M1, and the response output frequency Ltime used for changing the priority of a response stored in the response queue circuit RsQp from the memory chip M2 are set to 10 (times), 2 (times), and 1 (time), respectively, in the initialization (Initial) immediately after turning power on, although not restricted thereto.

Furthermore, the response output frequencies Ntime, Mtime and Ltime can be set by the data processing unit CPU_CHIP, and can be set in accordance with system structures of mobile phones or the like utilizing the invention so as to achieve high performance.

### <Clock Control>

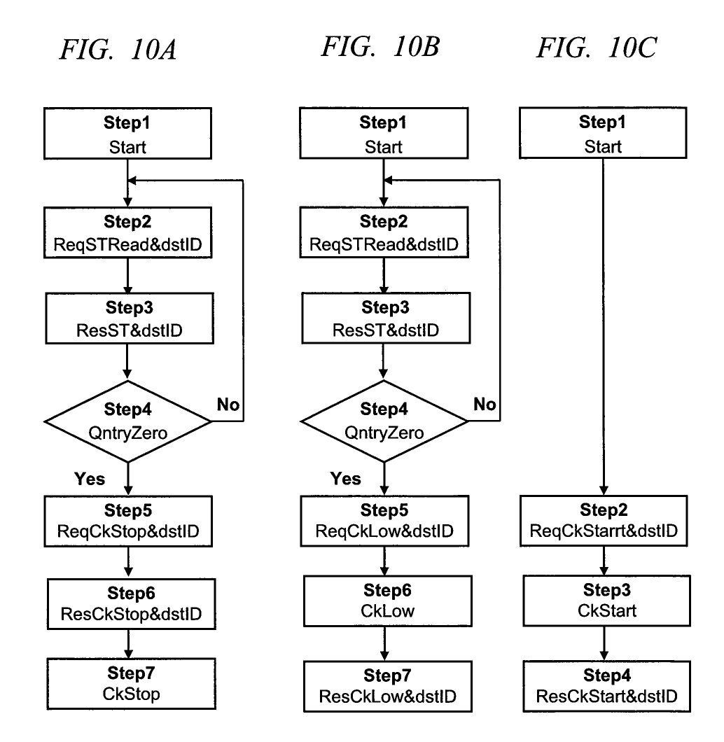

FIG. 10A shows an example of an operation for stopping the response clock signal RsCk0 output from the memory chip M0. In order to confirm the number ResN of responses stored in the response queue circuits RsQo and RsQp, the data processing unit CPU_CHIP inputs a request ReqRNo generated by multiplexing the ID number 2 of the memory chip and a response quantity confirm command to the memory chip M0 through the request signal RqMux0 (Step 2). The request queue circuit RqQI of the memory chip M0 stores the request ReqRNo. Then, the ID comparison circuit CPQ compares the ID number 2 of the request ReqRNo stored in the request queue circuit RqQI with the ID number 2 retained in the ID register circuit dstID. Since the ID numbers are the same, the request ReqBAb0m0 is transferred to the request queue circuit RqQXI.

The request queue circuit RqQXI transfers the request ReqBAb0m0 to the status register circuit STReg. The status register circuit STReg transmits the ID number 2 and the number of responses ResN to the response queue circuit RsQo. The response queue circuit RsQo transmits the ID number 2 and the number of responses ResN to the data processing unit CPU_CHIP through the response signal RsMux0 (Step 3). Next, the data processing unit CPU_CHIP which receives the ID number 2 and the number of responses ResN checks whether the number of responses ResN is 0 or not (Step 4). If the ResN is not 0, it indicates that response entry exists in the response queue circuits RsQo and RsQp. Accordingly, the data processing unit CPU_CHIP transmits the response quantity confirm command to the memory chip M0 again (Step 2).

If the number of responses ResN is 0, no response exists in the response queue circuit RsQo and RsQp. Therefore, a command for stopping the response clock signal RsCk0 is transmitted to the memory chip M0 through the request signal RqMux0 (Step 5). A request ReqStop2 generated by multiplexing the ID number 2 and a response clock stop command is input as a request to the memory chip M0 through the request signal RqMux0. The memory chip M0 stores the request ReqStop2 in the request queue of the request queue control circuit RqCT of its own. After that, the ID comparison circuit of the request queue control circuit RqCT compares the ID number 2 included in the request ReqStop2 with the number 2 of its own ID register. Since the result shows a match, the request queue control circuit RqCT transmits the request ReqStop2 to the clock division circuit Div2 of the response clock control circuit RsCkC (Step 5).

Based on the request ReqStop2, the clock division circuit Div2 gradually reduces a clock frequency of the response clock signal RsCk0. When the preparation for stopping clock signal RsCK0 is completed, the ID number 2 and information of response clock stop notification is transmitted to the data processing unit CPU_CHIP through the response schedule circuit SCH by the response signal RsMux0 (Step 6). After that, the clock division circuit Div2 stops the clock signal ck3 and the response clock signal RsCk0 (Step 7).

FIG. 10B shows an example of an operation for reducing the clock frequency of the response clock signal RsCk0 output from the memory chip M0. Since operations from Step 1 through Step 4 in FIG. 10B are the same as those in FIG. 10A, processings from Step 5 and thereafter will be described. A request ReqDIV8 generated by multiplexing the ID number 2, a response clock divide command and a division ratio 8 is transmitted as a request to the memory chip 0 through the RqMux0 (Step 5). The memory chip M0 compares the ID number 2 included in the request ReqDIV8 with its own ID register number 2 in the ID comparison circuit of the request queue control circuit RqCT thereof. Since there is a match, the request ReqDIV8 is transmitted to the clock division circuit Div2 of the request clock control circuit RqCkC (Step 5).

Based on the request ReqDIV8, the clock division circuit Div2 gradually reduces a clock frequency of the response clock signal RsCk0 and then finally outputs a clock generated by dividing the frequency of a request clock signal RqC2 by ⅛ from the clock CK3 and the response clock signal RsCk2 (Step 6). After the clock frequency of the response clock signal RsCk0 has been changed into a desired frequency, the clock division circuit Div2 transmits the ID number 2 and information of the response clock division completion to the data processing unit CPU_CHIP through the response schedule circuit SCH by the response signal RsMux0 (Step 7).

FIG. 10C shows an example of an operation for allowing the response clock signal RsCk0 subjected to frequency division or stopped to operate at a frequency equal to that of the request clock signal RqCk0 again. It is an example of an operation for decreasing the clock frequency of the response clock signal RsCk0 output from the memory chip M0. A request ReqStart2 generated by multiplexing the ID number 2 and a response clock restart command is input as a request to the memory chip M0 by the request signal RqMux0.

The memory chip M0 stores the request ReqStart2 in the request queue of the request queue control circuit RqCT thereof (Step 2). Then, the ID comparison circuit of the request queue control circuit RqCT compares the ID number 2 included in the request ReqStart2 with the ID register number 2 of its own. Since the comparison results in a match, the request ReqDIV4 is determined to be a request to the memory chip M0 itself. The request queue control circuit RqCT transmits the request ReqStart2 to the clock division circuit Div2 of the response clock control circuit RsCkC (Step 2). Based on the request ReqStart2, the clock division circuit Div2 gradually increases the clock frequency and finally outputs a clock having the frequency equal to the request clock signal RqCk0 from the clock ck3 and the response clock signal RsCK0 (Step 3).

After the clock frequency of the response clock signal RsCK0 has been changed into a desired frequency, the clock division circuit Div2 transmits the ID number 2 and the information of response clock restart completion to the data processing unit CPU_CHIP through the response schedule circuit SCH by the response signal RsMux0 (Step 4). Hereinabove, the clock control method for the response clock signal RsCk0 has been described, however, it is obvious that a clock control for the request clock signal RqCk1 can also be executed similarly.

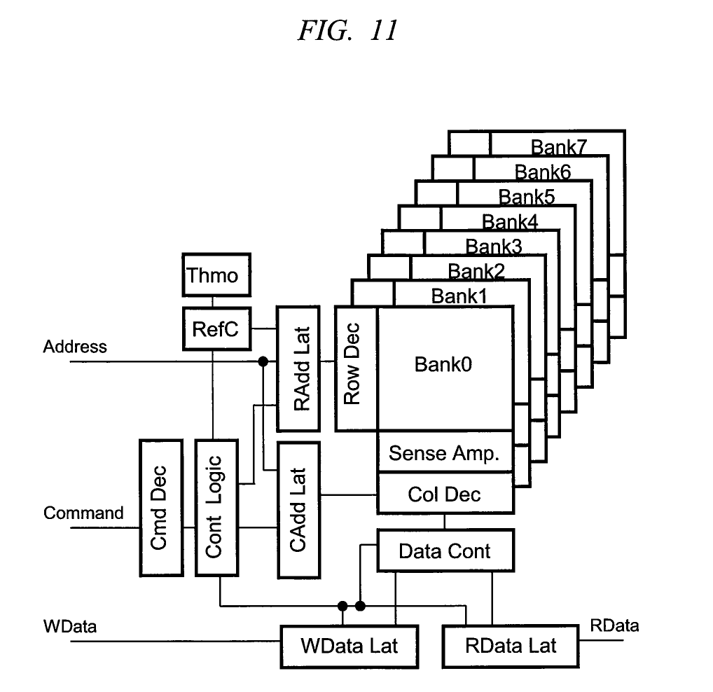

FIG. 11 is an example of a circuit block diagram of the memory circuit MemVL incorporated in the memory chip M0. The memory circuit MemVL is composed of a command decoder CmdDec, a control circuit Cont Logic, a row address buffer RAdd Lat, a column address buffer CAdd Lat, a refresh counter RefC, a thermometer Thmo, a write data buffer Wdata Lat, a read data buffer RData Lat, a row decoder RowDec, a column decoder ColDec, a sense amplifier SenseAmp, a data control circuit DataCont and memory banks Bank0 to Bank7. A read operation of the memory circuit MemVL will be described as follows.

The request queue RqQXI stores bank address 7 and row address 5. A bank active command BA from a command signal Command and the bank address 7 and the row address 5 from an address signal Address are transmitted to the memory circuit MemVL. The command decoder CmdDec decodes the bank active command BA and the control circuit ContLogic instructs the row address buffer RAdd Lat to store the bank address 7 and the row address 5. Following the instruction from the control circuit Cont Logic, the bank address 7 and the row address 5 are stored in the row address buffer RAddLat. Based on the bank address 7 stored in the row address buffer RAddLat, the memory bank Bank 7 is selected and the row address 5 is input to the row decoder RowDec of the Bank7. Then, memory cells connected to the row address 5 of the Bank7 are activated, and a 1-kByte data is transferred to the sense amplifier SenseAmp of the memory bank Bank7.

Next, an 8-byte data read command RD8, a bank address 7 and a column address 63 are stored in the request queue RqQXI. The 8-byte data read command RD8 from the command signal Command and the bank address 7 and the column address 63 from the address signal Address are transmitted to the memory circuit MemVL. The command decoder CmdDec decodes the 8-byte data read command RD8 and the control circuit Cont Logic instructs the column address buffer CAddLat to store the bank address 7 and the column address 63. Following the instruction from the control circuit Cont Logic, the bank address 7 and the column address 63 are stored in the column address buffer CAddLat.

Based on the bank address 7 stored in the column address buffer CAddLat, the memory bank Bank 7 is selected and the column address 63 is input to the column decoder ColDec of the Bank7. Then, the 8-Byte data which starts with address specified by the column address 63 of the Bank 7 is transferred to the read data buffer RdataLat through the data control circuit DataCont and stored. Then, the 8-byte data read is transferred to the response queue circuit RsQo.

Next, a write operation of the memory circuit MemVL will be described. An 8-byte data write command WT8, a bank address 7 and a column address 127 are stored in the request queue RqQXI. The 8-byte data write command WT8 from the command signal Command, the bank address 7 and the column address 127 from the address signal Address and an 8-byte data from the write data signal WData are transmitted to the memory circuit MemVL. The command decoder CmdDec decodes the 8-byte data write command WT8 and the control circuit Cont Logic instructs the column address buffer CAddLat to store the bank address 7 and the column address 127, and instructs the write data buffer WDataLat to store the 8-byte write data. Based on the instruction from the control circuit Cont Logic, the bank address 7 and the column address 127 are stored in the column address buffer CAddLat. The 8-byte data is stored in the write data buffer WData Lat based on the instruction from the control circuit Cont Logic.

Based on the bank address 7 stored in the column address buffer CAddLat, the memory bank Bank 7 is selected and the column address 127 is input to the column decoder ColDec of the Bank7. Then, the 8-Byte data which starts with address specified by the column address 127 of the Bank 7 is transferred to the sense amplifier SenseAmp of the Bank 7 through the data control circuit DataCont from the write data latch WdataLat and written in the memory cells connected to the row address 5 of the Bank7 and being activated.

Next, a refresh operation will be described. Since the memory circuit MemVL is a volatile memory, it requires a regular refresh operation for maintaining data. A refresh command REF stored in the request queue RqQXI is input to the memory circuit MemVL from the command signal Command. The command decoder CmdDec decodes the refresh command REF and the control circuit Cont Logic instructs the refresh counter RefC to execute a refresh operation. According to the instruction from the control circuit Cont Logic, the refresh counter RefC executes a refresh operation.

Next, a self-refresh operation will be described. In the case where no request to the memory circuit MemVL occurs during a long time, the memory circuit MemVL can perform a self-refresh operation by switching its operation mode into a self-refresh mode.

A self-refresh entry command SREF stored in the request queue RqQXI is input from the command signal Command. The command decoder CmdDec decodes the self-refresh entry command SREF and the control circuit Cont Logic switches operation modes of all circuits into a self-refresh state. Additionally, the control circuit Cont Logic instructs the refresh counter RefC to automatically perform a self-refresh operation at a regular interval. According to the instruction of the control circuit Cont Logic, the refresh counter RefC performs self-refreshing automatically and regularly.

In the above self-refresh operation, the frequency of self-refreshing can be varied depending on the temperature.

In general, as the temperature rises, a volatile memory exhibits a shorter data-retention time. Meanwhile, the data retention time becomes longer at a lower temperature. Therefore, temperature is detected with a thermometer. When the temperature is high, a cycle of the self-refresh operation is set to be short. When the temperature is low, the cycle thereof is set to be long. The self-refreshment operation is executed in such a manner. As a result, unnecessary self-refresh operations can be prevented, and power consumption can be reduced.

To exit a self-refresh mode, it is necessary to input a self-refresh exit command SREFX from the command signal Command. After exiting the self-refresh state, data retention operation is performed based on the refresh command REF.

### <Description of Memory Chip M1>

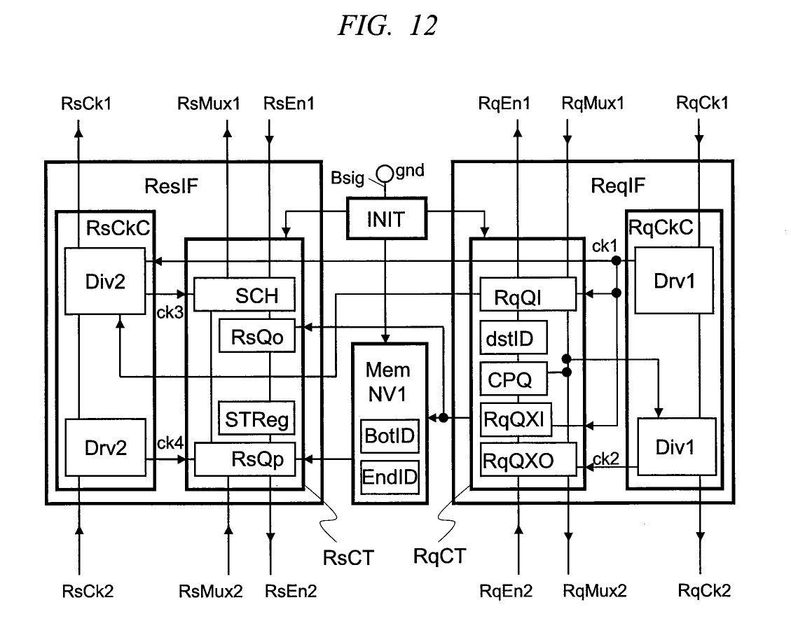

FIG. 12 shows an example of a block diagram of the memory chip M1. The memory chip M1 is composed of the request interface circuit ReqIF, the response interface circuit ResIF, an initialization circuit INIT1 and a memory circuit MemNV1. The request interface circuit ReqIF is composed of the request clock control circuit RqCkC and the request queue control circuit RqCT. The request clock control circuit RqCkC is composed of the clock driver Drv1 and the clock division circuit Div1. The request queue control circuit RqCT is composed of the request queue circuits RqQI, RqQXI and RqQXO, the ID register circuit dstID and the ID comparison circuit CPQ. The response interface circuit ResIF is composed of the response clock control circuit RsCkC and the response queue control circuit RsCT.

The response clock control circuit RsCkC is composed of the clock driver Drv2 and the clock division circuit Div2. The response queue control circuit RsCT is composed of the response queue circuits RsQo and RsQp, the status register circuit STReg and the response schedule circuit SCH. The memory circuit MemNV1 may be a nonvolatile memory, and is a NOR flash memory having NOR flash memory cells, although not restricted thereto. The boot device ID number BotID and an endmost device ID number EndID are stored in the memory circuit MemNV1. Circuits constituting the memory chip M1 and their operations are the same as those in the memory chip M0 shown in FIG. 4, except for the memory circuit MemNV1 and the initialization circuit INIT1.

Next, operation of the memory chip M1 will be described. First, operation upon turning power on will be described. When power is turned on to the memory chip M1, the initialization circuit INIT1 initializes the memory chip M1. Since the boot device identification signal Bsig is grounded, the memory chip M1 identifies itself as a boot device. Therefore, the memory chip M1 sets a boot device ID number 1 retained in the memory circuit MemNV1 thereof into the ID register dstID, and then sets its ID valid bit to high.

Next, the priority of a response input to the response queue circuit RsQo of the response schedule circuit SCH is set to 1 and the priority of a response input to the response queue circuit RsQp from the memory chip M2 is set to 2. The division ratio of each of the clock division circuits Div1 and Div2 is set to 1. When the initialization circuit INIT1 completes initialization, the memory chip M1 confirms that communications between the memory chips M1 and M2 are established. The memory chip M1 confirms that the request enable signal RqEn2 is high and sets the response enable signal RsEn2 and the request enable signal RqEn1 to high.

Next, the memory chip M0 confirms that the request enable signal RqEn1 is high and sets the response enable signal RsEn1 to high. When the communication confirmation is completed, the memory circuit MemNV1 reads out boot data to transmit it to the data processing unit CPU_CHIP through the memory chip M0. Next, a response priority control in the memory chip M1 will be described.

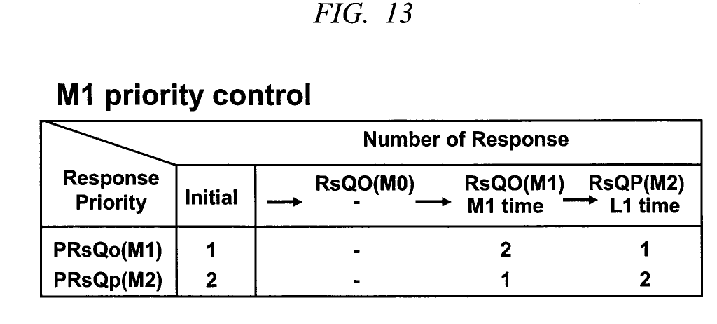

FIG. 13 shows a dynamic response priority control performed by the response schedule circuit SCH incorporated in the memory chip M1.

In the case where the connection structure has the structure in which no response occurs from the memory chip M0 to the memory chip M1, as shown in FIG. 1, response priority is set only for responses from the memory chips M1 and M2. In initialization (Initial) immediately after turning power on, the priority PRsQo(M1) of a response stored in the response queue circuit RsQo from the memory circuit MemNV1 is set to 1 and the priority PRsQp(M2) of a response stored in the response queue circuit RsQp from the memory chip M2 is set to 2. Although not specifically restricted, the priority set as a smaller number is assumed to be a higher priority.

Next, when a response RsQo(M1) of the memory circuit MemNV1 in the response queue circuit RsQo has been output M1time time(s), the priority PRsQo(M1) in the response queue circuit RsQo becomes 2, the lowest, while the priority PRsQp(M2) of a response of the memory chip M2 becomes 1, the highest.

Next, when a response PRsQp(M2) from the memory chip M2 in the response queue circuit RsQp has been output L1time time(s), the priority PRsQp(M2) of the response stored in the response queue circuit RsQp from the memory chip M2 becomes 2, the lowest, while the priority PRsQp(M1) of a response in the response queue circuit RsQo becomes 1, the highest. The response output frequency M1time used for changing the priority of a response stored in the response queue circuit RsQo from the memory circuit MemNV1 and the response output frequency L1time used for changing the priority of a response stored in the response queue circuit RsQp from the memory chip M2 may be set to 10 times and 1 time, respectively, in the initialization (Initial) immediately after turning power on, although not restricted thereto. Furthermore, the response output frequencies M1time and L1time can be set by the processing unit CPU_CHIP and can be determined in accordance with system architecture of mobile phones or other devices applying the present invention so as to achieve high performance.

The dynamic response priority control by the response schedule circuit SCH incorporated in the memory chip M1 is the same as the operations shown in FIG. 8. In addition, a clock control method for the request clock signal RqCk2 and the response clock signal RsCk1 is the same as that shown in FIG. 10.

### <Description of Memory Chip 2>

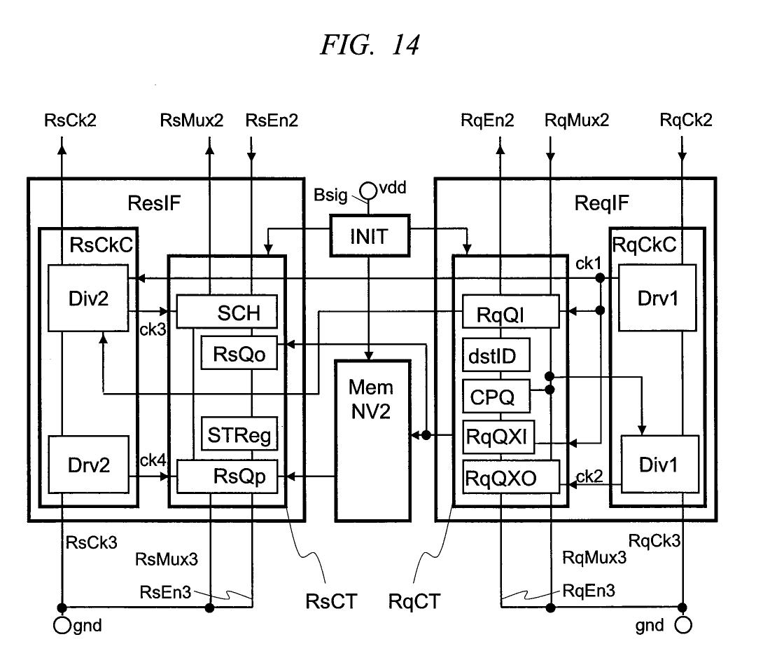

FIG. 14 shows an example of a block diagram of the memory chip M2. The memory chip M2 is composed of the request interface circuit ReqIF, the response interface circuit ResIF, an initialization circuit INIT2 and a memory circuit MemNV2. The request interface circuit ReqIF is composed of the request clock control circuit RqCkC and the request queue control circuit RqCT. The request clock control circuit RqCkC is composed of the clock driver circuit Drv1 and the clock division circuit Div1. The request queue control circuit RqCT is composed of the request queue circuits RqQI, RqQXI and RqQXO, the ID register circuit dstID and the ID comparison circuit CPQ. The response interface circuit ResIF is composed of the response clock control circuit RsCkC and the response queue control circuit RsCT. The response clock control circuit RsCkC is composed of the clock driver Drv2 and the clock division circuit Div2.

The response queue control circuit RsCT is composed of the response queue circuits RsQo and RsQp, the status register circuit STReg and the response schedule circuit SCH. The memory circuit MemNV2 may be a volatile memory, and is a NAND flash memory using NAND flash memory cells, although not restricted thereto. Circuits constituting the memory chip M2 and their operations are the same as those in the memory chip M0 shown in FIG. 4, except for the memory circuit MemNV2 and the initialization circuit INIT2.

Next, operation of the memory chip M2 will be described. First, an operation upon turning power on will be described. When power is turned on to the memory chip M2, the initialization circuit INIT2 initializes the memory chip M2. First, the ID register number of the ID register circuit dstID is initialized to 0 and ID valid bit is initialized to low. Then, the priority of a response input to the response queue circuit RsQo of the response schedule circuit SCH is set to 1. The division ratio of the clock division circuits Div1 and Div2 is set to 1. After the initialization by the initialization circuit INIT2 has been finished, the memory chip M2 executes confirmation that confirms the establishment of communication between the memory chips M1 and M2. Because the signals RqEn3, RsMux3 and RqCk3 are grounded, the memory chip M2 identifies itself as the endmost memory chip among those connected in series and sets the request enable signal RqEn2 to high.

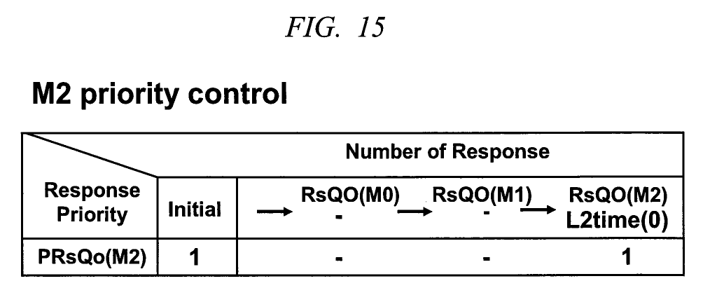

Next, the memory chip M1 confirms that the request enable signal RqEn2 is high and then sets the response enable signal RsEn2 and the request enable signal RqEn1 to high. Now, response priority control in the memory chip M2 will be described. FIG. 15 shows a dynamic response priority control by the response schedule circuit SCH of the memory chip M2. In the case where the memory chip M2 is the endmost chip among those connected in series, as shown in FIG. 1, no response occurs from the memory chips M0 and M1 to the memory chip M2.

Therefore, the response priority is set only to a response from the memory chip M2. Accordingly, the priority PRsQ0(M2) of a response from the memory chip M2 in the response queue circuit RsQo does not change after it has been set to 1 in the initialization (Initial) immediately after turning power on. Since it is unnecessary to change the priority PRsQ0(M2) of a response stored in the response queue circuit RsQo from the memory circuit MemNV2, the output frequency of a response used for changing the priority PRsQo(M2) of the response stored response queue circuit RsQo from the memory chip M2 is set to 0, although not restricted thereto, in the initialization (Initial) immediately after turning power on, and no change is necessary. And, a clock control method for the response clock signal RsCk2 is the same as that shown in FIG. 10.

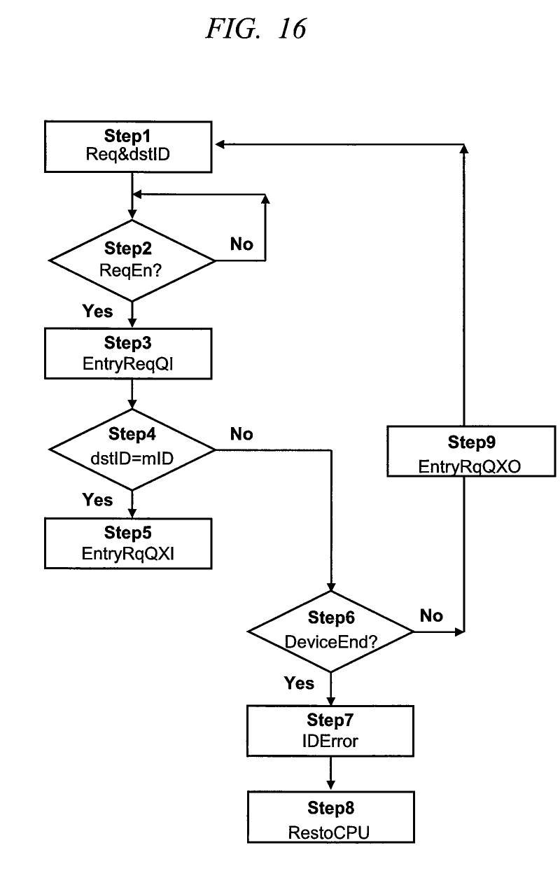

FIG. 16 is a flowchart illustrating an example of an operation performed in the case where an ID number included in the request transmitted to the memory module MEM from the data processing unit CPU_CHIP differs from any of the ID register numbers of the memory chips M0, M1, and M2, and an error occurs. A request and an ID number is transmitted to the memory module MEM from the data processing unit CPU_CHIP (Step 1). If the request enable signal RqEn0 is low (Step 2), the request from the data processing unit CPU_CHIP is not stored in the request queue circuit RqQI of the memory chip M0. If the request enable signal RqEn0 is high (Step 2), the request is stored in the request queue circuit RqQI of the memory chip M0 (Step 3).

Then, the ID comparison circuit CPQ compares the ID number in the request stored in the request queue circuit RqQI with an ID number in the ID register circuit dstID (Step 4). If the ID comparison results in a match, the request in the request queue circuit RqQI is transferred to the request queue circuit RqQXI (Step 5). If there is mismatch, it is checked whether the memory chip M0 is the endmost chip or not (Step 6). Since the memory chip M0 is not the endmost device, the request in the request queue circuit RqQI is transferred to the request queue circuit RqQXO and then to the next memory chip M1 (Step 9). In the memory chip M1, the Steps 1 to 9 are repeated. In the memory chip M2, the Steps 1 to 4 are performed. If the comparison result in step 4 shows a match, the request in the request queue circuit RqQI is transferred to request queue circuit RqQXI (Step 5). If it shows a mismatch, it is checked whether the memory chip M0 is the endmost chip or not (Step 6).

Since the memory chip M2 is the endmost memory chip, the ID number in the request transmitted to the memory module MEM from the data processing unit CPU_CHIP does not match any of the ID register numbers of the memory chips M0, M1 and M2, it means the ID error (Step 7). The ID error is transmitted to the data processing unit CPU_CHIP from the endmost memory chip M2 through the memory chips M1 and M0.

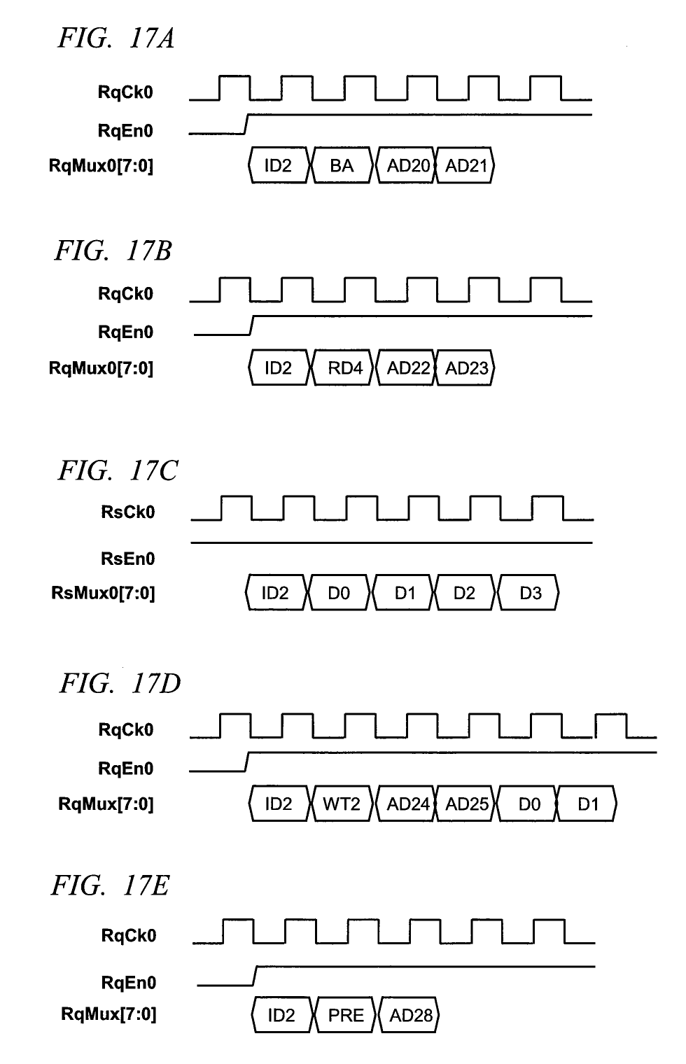

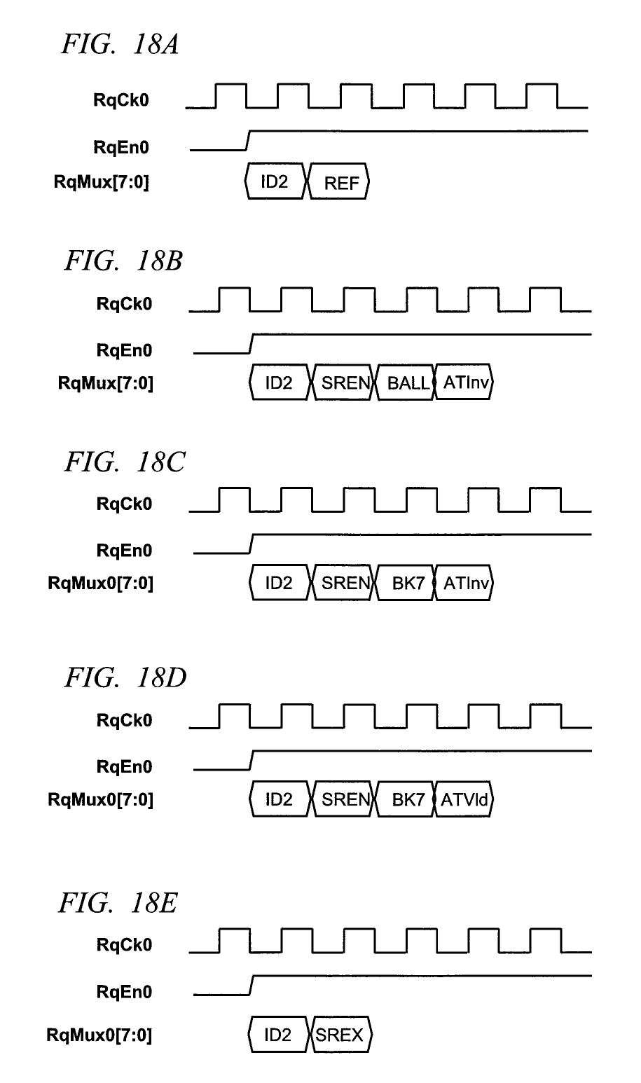

Next, an operational waveform of a request input to the memory module MEM will be described. FIGS. 17A to 17E and FIGS. 18A to 18E show an example of an operational waveform of a request from the data processing unit CPU_CHIP to the memory module MEM and an example of an operational waveform of a response from the memory module MEM to the data processing unit CPU_CHIP.

FIG. 17A shows a bank active request including a bank active command BA to the memory chip M0. Although not restricted thereto, when the request enable signal RqEn0 is high, the bank active request is synchronized with the request clock signal RqCk0 and the ID number 2 of the memory chip M0, the bank active command BA and addresses AD20 and AD21 are multiplexed to be input to the memory chip M0. The addresses AD20 and AD21 include a bank address and a row address. The bank active request activates one of the memory banks in the memory chip M0.

FIG. 17B shows a read request including a 4-byte data read command RD4 to the memory chip M0. Although not restricted thereto, when the request enable signal RqEn0 is high, the read request is synchronized with the request clock signal RqCk0 and the ID number 2 of the memory chip M0, the read command RD4 and addresses AD22 and AD23 are multiplexed to be input to the memory chip M0. The addresses AD22 and AD23 include a bank address and a column address. Based on the read request, the data is read from the memory bank activated in the memory chip M0.

FIG. 17C shows a read response including the ID number of the memory chip M0 and the data read from the memory chip M0. Although not restricted thereto, when the response enable signal RsEn0 is high, the read response is synchronized with the response clock signal RsCk0 and the ID number 2 of the memory chip M0 and the 4-byte data D0, D1, D2 and D3 are multiplexed to be input to the data processing unit CPU_CHIP.

FIG. 17D shows a write request including a 2-byte data write command WT2 to the memory chip M0. Although not restricted thereto, when the request enable signal RqEn0 is high, the write request is synchronized with the request clock signal RqCk0 and the ID number 2 of the memory chip M0, the write command WT2 and addresses AD24 and AD25 are multiplexed to be input to the memory chip M0. The addresses AD22 and AD23 include a bank address and a column address. Based on the write request, the data is written in the activated memory bank of the memory chip M0.

FIG. 17E shows a precharge request including a precharge command PRE to the memory chip M0. Although not restricted thereto, when the request enable signal RqEn0 is high, the precharge request is synchronized with the request clock signal RqCk0 and the ID number 2 of the memory chip M0, the precharge command PRE and an address AD28 are multiplexed to be input to the memory chip M0. The address AD28 includes a bank address. The precharge request deactivates one of the memory banks in the memory chip M0.

FIG. 18A shows a refresh request including an automatic refresh command REF to the memory chip M0. Although not restricted thereto, when the request enable signal RqEn0 is high, the refresh request is synchronized with the request clock signal RqCk0 and the ID number 2 of the memory chip M0 and the refresh command REF are multiplexed to be input to the memory chip M0. Based on the refresh request REF, a refresh operation is executed to the memory chip M0. FIG. 18B shows a self-refresh entry request including a self-refresh command SREF to the memory chip M0. Although not restricted thereto, when the request enable signal RqEn0 is high, the self-refresh entry request is synchronized with the request clock signal RqCk0 and the ID number 2 of the memory chip M0, the self-refresh entry command SREF, an all memory bank designation ALL and an automatic temperature compensation invalidation designation ATInv are multiplexed to be input to the memory chip M0. Based on the self-refresh entry request, the memory chip M0 goes into a self-refresh state. Therefore, the memory chip M0 automatically performs refresh operations for all the memory banks within itself.

FIG. 18C shows a self-refresh entry request including a self-refresh command SREF to the memory chip M0. Although not restricted thereto, when the request enable signal RqEn0 is high, the self-refresh entry request is synchronized with the request clock signal RqCk0 and the ID number 2 of the memory chip M0, the self-refresh entry command SREF, all memory banks designation BK7 and a designation of automatic temperature compensation invalidation ATInv are multiplexed to be input to the memory chip M0. Based on the self-refresh entry request, the memory chip M0 goes into a self-refresh state. Accordingly, the memory chip M0 automatically performs a refresh operation only for the memory bank Bank7 of its own.

FIG. 18D shows a self-refresh entry request including a self-refresh command SREF to the memory chip M0. Although not restricted thereto, when the request enable signal RqEN0 is high, the self-refresh entry request is synchronized with the request clock signal RqCk0 and the ID number 2 of the memory chip M0, the self-refresh entry command SREF, all memory banks designation BK7 and a designation of automatic temperature compensation validation ATVld are multiplexed to be input to the memory chip M0. Based on the self-refresh entry request, the memory chip M0 goes into a self-refresh state. Accordingly, the memory chip M0 automatically performs a refresh operation only for the memory bank Bank 7 thereof. Furthermore, due to the designation of automatic temperature compensation validation ATVld, although not restricted thereto, a temperature sensor incorporated in the memory chip M0 may detect surrounding temperature and a self-refresh frequency can be adjusted automatically according to the temperature.

FIG. 18E shows a self-refresh exit request including a self-refresh exit command SREX to the memory chip M0. Although not restricted thereto, when the request enable signal RqEn0 is high, the self-refresh exit request is synchronized with the request clock signal RqCk0 and the ID number 2 of the memory chip M0 and the self-refresh exit command SREX are multiplexed to be input to the memory chip M0. Based on the self-refresh exit request, the memory chip M0 exits a self-refresh state.

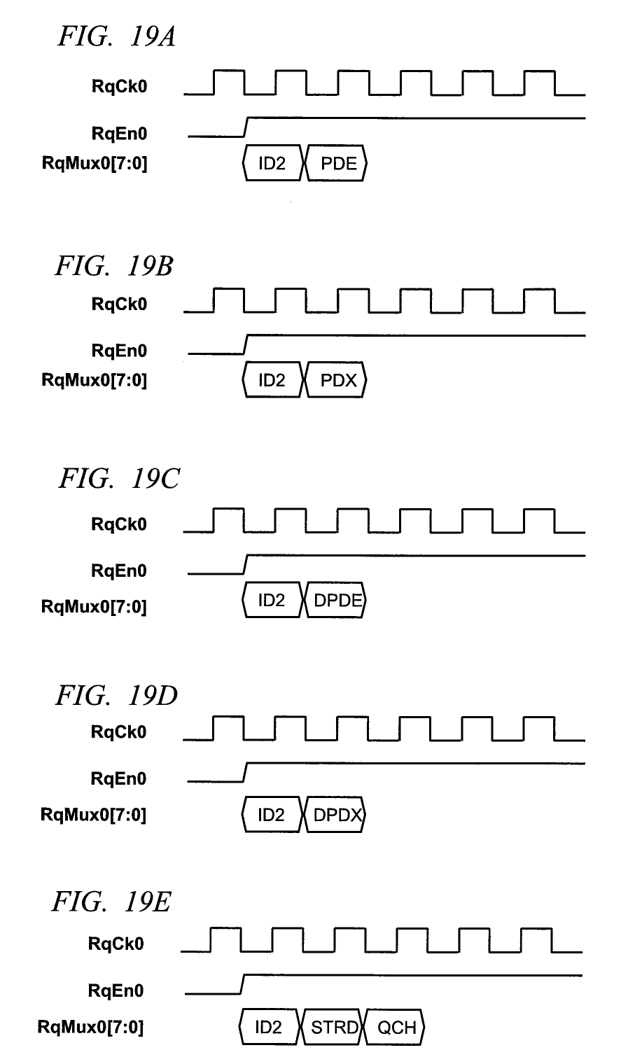

FIG. 19A shows a power-down entry request including a power-down entry command PDE to the memory chip M0. Although not restricted thereto, when the request enable signal RqEN0 is high, the power-down entry request PDE is synchronized with the request clock signal RqCk0 and the ID number 2 of the memory chip M0 and the power-down entry command PDE are multiplexed to be input to the memory chip M0. Based on the power-down entry request, the memory chip M0 goes into a power-down state and deactivates an internal clock of the memory chip M0. In the present embodiment, the power-down entry request to the memory chip M0 has been described, however, obviously, the power-down entry command can be applied to all the memory chips in the memory module MEM by changing the ID number of the memory chip.

Although not restricted thereto, a request generated by multiplexing the ID number 1 of the memory chip M1 and the power-down entry command PDE may be transmitted to the memory chip M1 through the memory chip M0 to deactivate the internal clock of the memory chip M1. Additionally, although not restricted thereto, a request generated by multiplexing the ID number 2 of the memory chip M2 and the power-down entry command PDE may be transmitted to the memory chip M2 through the memory chips M0 and M1 to deactivate the internal clock of the memory chip M2.

FIG. 19B shows a power-down exit request including a power-down exit command PDX to the memory chip M0. Although not restricted thereto, when the request enable signal RqEN0 is high, the power-down exit request is synchronized with the request clock signal RqCk0 and the ID number 2 of the memory chip M0 and the power-down exit command PDX are multiplexed to be input to the memory chip M0. Based on the power-down exit request, the memory chip M0 exits the power-down state. In the embodiment, the power-down exit request to the memory chip M0 has been described, however, obviously, this can be applied to all the memory chips included in the memory module MEM by changing the ID number in the request.

FIG. 19C shows a deep power-down entry request including a deep power-down entry command DPDE to the memory chip M0. Although not restricted thereto, when the request enable signal RqEN0 is high, the deep power-down entry request DPDE is synchronized with the request clock signal RqCk0 and the ID number 2 of the memory chip M0 and the deep power-down entry command DPDE are multiplexed to be input to the memory chip M0. Based on the deep power down entry request, the memory chip M0 goes into a deep power-down state and deactivates the internal clock of the memory chip M0 and also stops an internal clock circuit for refresh operations. In the embodiment, the deep power-down entry request to the memory chip M0 has been described, however, obviously, this can be applied to all the memory chips in the memory module MEM by changing the ID number of the memory chip included in the deep power-down entry request.

FIG. 19D shows a deep power-down exit request including a deep power-down exit command DPDX to the memory chip M0. Although not restricted thereto, when the request enable signal RqEN0 is high, the deep power-down exist request DPDX is synchronized with the request clock signal RqCk0 and the ID number 2 of the memory chip M0 and the deep power-down exit command PDX are multiplexed to be input to the memory chip M0. Based on the deep power-down exit request, the memory chip M0 exits the deep power-down state. In this embodiment, the deep power-down exit request to the memory chip M0 has been described, however, obviously, this can be applied to each of the memory chips in the memory module MEM by changing the ID number included in the deep power-down exit request.

FIG. 19E shows a status register read request including a status register read command STRD to the memory chip M0. Although not restricted thereto, when the request enable signal RqEN0 is high, the status register read request is synchronized with the request clock signal RqCk0 and the ID number 2 of the memory chip M0, the status register read command STRD and response entry quantity designation information QCH are multiplexed to be input to the memory chip M0. Based on the status register read command STRD and the response entry quantity designation information QCH, the memory chip M0 transmits a response quantity in the response queue to the data processing unit CPU_CHIP.

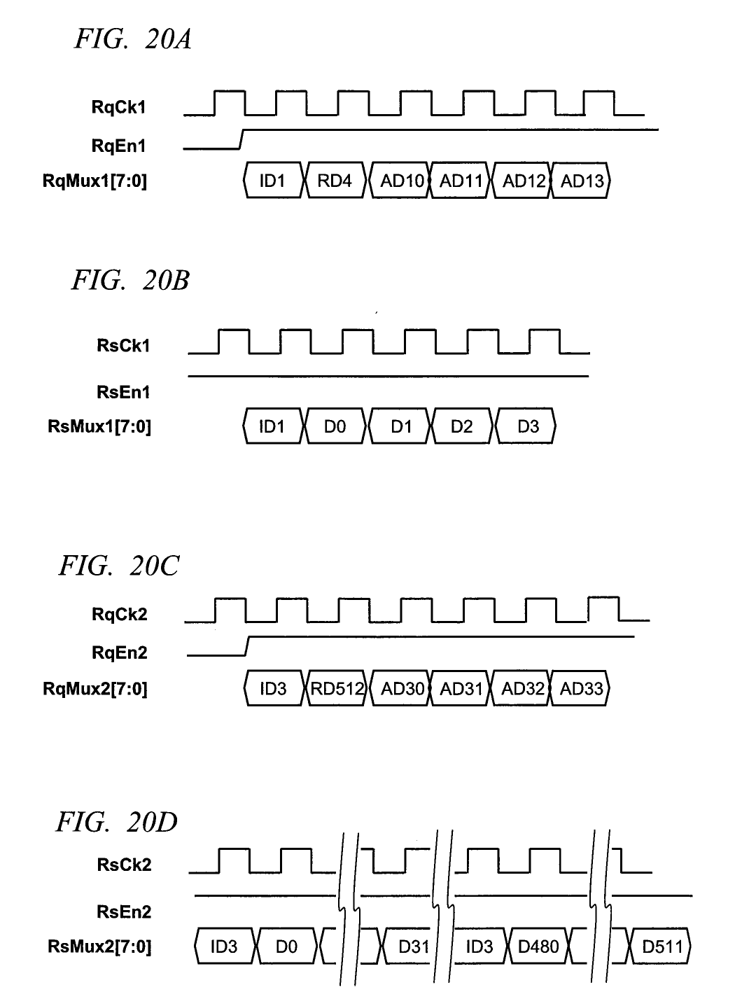

FIG. 20A shows a read request including a 4-byte data read command RD4 to the memory chip M1. Although not restricted thereto, when the request enable signal RqEN1 is high, the read request is synchronized with the request clock signal RqCk1 and the ID number 1 of the memory chip M1, the read command RD4 and addresses AD10, AD11, AD12 and AD13 are multiplexed to be input to the memory chip M1 through the memory chip M0. Based on the read request, data is read from the memory circuit NV1 in the memory chip M1.

FIG. 20B shows a read response including the ID number of the memory chip M1 and the data read from the memory chip M1. Although not restricted thereto, when the response enable signal RsEN1 is high, the read response is synchronized with the response clock signal RsCk1 and the ID number 1 of the memory chip M1 and the 4-byte data D0, D1, D2 and D3 are multiplexed to be transmitted to the memory chip M0 and then to the data processing unit CPU_CHIP.

FIG. 20C shows a read request including a 512-byte data read command RD512 to the memory chip M2. Although not restricted thereto, when the request enable signal RqEN2 is high, the read request is synchronized with the request clock signal RqCk2 and the ID number 3 of the memory chip M2, the read command RD512 and addresses AD30, AD31, AD32 and AD33 are multiplexed to be transmitted to the memory chip M3 through the memory chips M0 and M1. Based on the read request, 512-byte data is read from the memory circuit NV2 in the memory chip M3.

FIG. 20D shows a read response including the ID number 3 of the memory chip M2 and the data read from the memory chip M2. Although not restricted thereto, when the response enable signal RsEN2 is high, the read response is synchronized with the response clock signal RsCk2 and the ID number 1 of the memory chip M2 is multiplexed for every 32-byte data to be transmitted to the memory chip M1 in order, then to the memory chip M0 and finally to the data processing unit CPU_CHIP. Consequently, the 512-byte data is transmitted to the data processing unit CPU_CHIP.

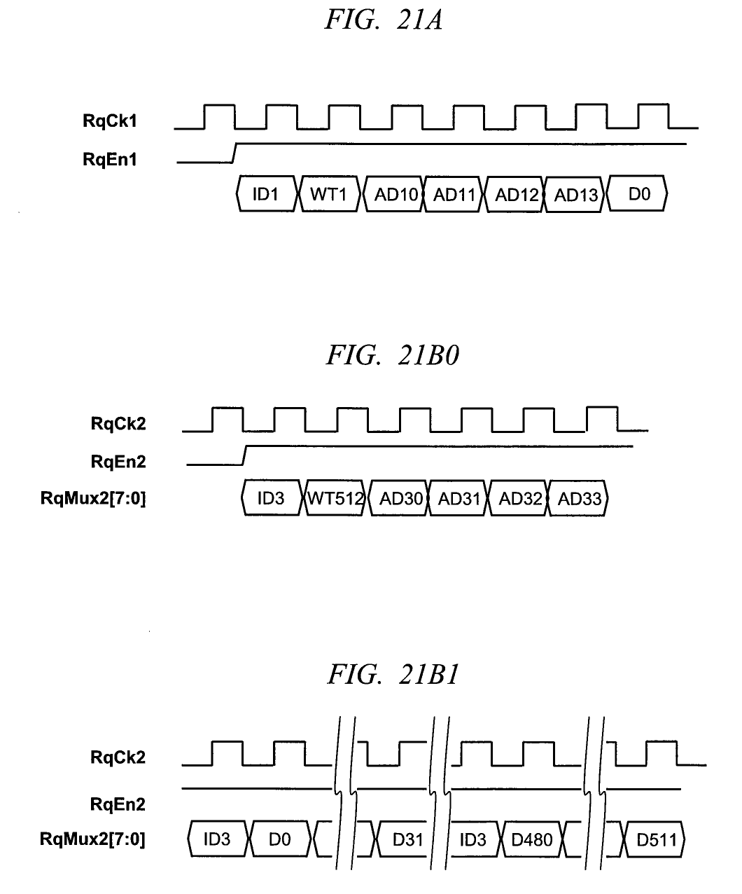

FIG. 21A shows a write request including a 1-byte data write command WT1 to the memory chip M1. Although not restricted thereto, when the request enable signal RqEN1 is high, the write request is synchronized with the request clock signal RqCk1 and the ID number 1 of the memory chip M1, the write command WT1, addresses AD10, AD11, AD12 and AD13 and write data D0 are multiplexed to be input to the memory chip M1 through the memory chip M0. Based on the write request, a 1-byte data is written in the memory circuit NV1 of the memory chip M1.

FIGS. 21B0 and 21B1 show a write request including a 512-byte data write command WT512 to the memory chip M2. Although not restricted thereto, when the request enable signal RqEN2 is high, the write request is synchronized with the request clock signal RqCk2 and the ID number 3 of the memory chip M2, the write command WT512, addresses AD30, AD31, AD32 and AD33 and 512-byte write data D0 to D511 are multiplexed to be transmitted to the memory chip M2 through the memory chips M0 and M1. Based on the write request, a 512-byte data is written in the memory circuit NV2 in the memory chip M2.

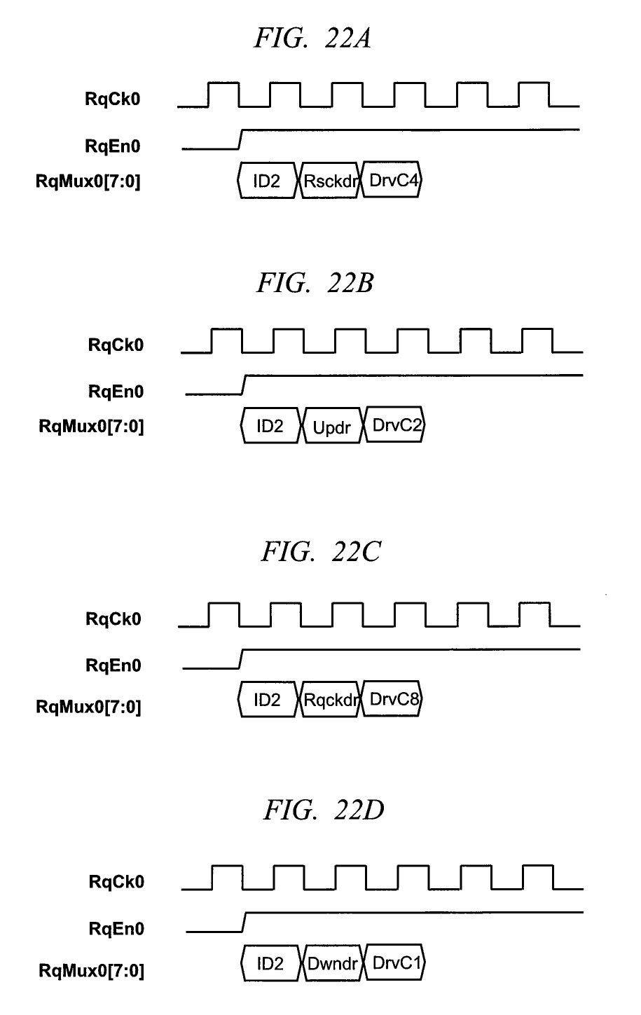

FIG. 22A shows a designation request of response clock drive performance which includes a designation command of response clock drive performance DPDE, which is used for changing drive performance of the response clock RsCk0 of the memory chip M0. Although not restricted thereto, when the request enable signal RqEN0 is high, the designation request of response clock drive performance is synchronized with the request clock signal RqCk0 and the ID number 2 of the memory chip M0, the designation command of a response clock drive performance DPDE and a drive performance number DrvC4 are multiplexed to be transmitted to the memory chip M0. Based on the request, the drive performance of the response clock signal RsCk0 of the memory chip M0 is set to ¼ of a reference drive performance. In the present embodiment, the case of change in the drive performance of the response clock signal RsCk0 of the memory chip M0 is described, however, obviously, the drive performance of a response clock of each memory chip in the memory module MEM can be changed by changing the ID number of the memory chip included in the designation request of response clock drive performance.

FIG. 22B shows a designation request of an upstream signal drive performance, which includes a designation command of an upstream signal drive performance Updr. The command is for changing the drive performance of the signals, which are output from the memory chip M0 except the response clock signal RsCK0, and transmitted in the same direction as that of the response clock signal RsCk0, namely, RsMux0 and RqEN1. Although not restricted thereto, when the request enable signal RqEN0 is high, the designation request of an upstream signal drive performance is synchronized with the request clock signal RqCk0, and the ID number 2 of the memory chip M0, the designation command of an upstream signal drive performance Updr and a drive performance number DrvC2 are multiplexed to be input to the memory chip M0. Based on the request, the drive performance of the signals, which are output from the memory chip M0 except RsCK0, and transmitted in the same direction as that of the response clock signal RsCk0, namely, RsMux0 and RqEN1, are set to ½ of a reference drive performance. In this embodiment, the case of the memory chip M0 has been described, however, obviously, it is possible to change the drive performance of an upstream signal of each memory chip in the memory module MEM by changing the ID number of the memory chip included in the designation request of an upstream signal drive performance.

FIG. 22C shows a designation request of a request clock drive performance, which includes a designation command of a request clock drive performance Rsckdr. The command is for changing a drive performance of the request clock signal RqCk1 of the memory chip M0. Although not restricted thereto, when the request enable signal RqEN0 is high, the designation request of a request clock drive performance is synchronized with the request clock signal RqCk0 and the ID number 2 of the memory chip M0, the designation command of a request clock drive performance Rsckdr and a drive performance number DrvC8 are multiplexed to be input to the memory chip M0. Based on the request, the drive performance of the request clock signal RqCk1 of the memory chip M0 is set to ⅛ of the reference drive performance. In this embodiment, the case of changing the drive performance of the request clock RsCk1 of the memory chip M0 is described, however, obviously it is possible to change the drive performance of a request clock signal of each memory chip in the memory module MEM by changing the ID number of the memory chip included in the designation request of a request clock drive performance.

FIG. 22D shows a designation request of a downstream signal drive performance, which includes a designation command of a downstream signal drive performance Dwndr. The command is for changing the drive performance of the signals, which are output from the memory chip M0 except the request clock signal RsCK0, and transmitted in the same direction as that of the request clock signal RqCkq, namely, RqMux1 and RsEN0. Although not restricted thereto, when the request enable signal RqEN0 is high, the designation request of a downstream signal drive performance is synchronized with the request clock signal RqCk0 and the ID number 2 of the memory chip M0, the designation command of a downstream signal drive performance Dwndr and a drive performance number DrvC2 are multiplexed to be input to the memory chip M0. Based on the request, the drive performance of the signals, which are output from the memory chip M0 except the request clock signal RsCK0, and transmitted in the same direction as that of the request clock signal RqCkq, namely, RqMux1 and RsEN0 are set to be equal to a reference drive performance. In this embodiment, the case of the memory chip M0 has been described, however, obviously, it is possible to change the drive performance of the downstream signal of each memory chip in the memory module MEM by changing the ID number of the memory chip included in the designation request of a downstream signal drive performance.

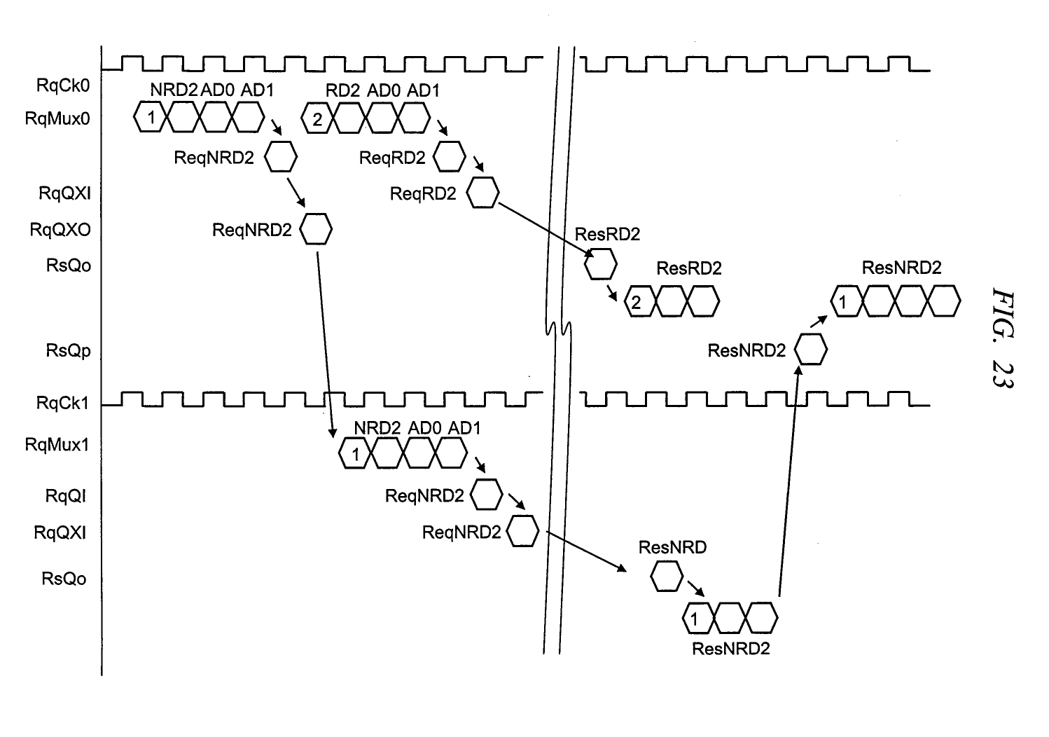

FIG. 23 shows a data transfer waveform obtained when a read request occurs to the memory chip M1 from the data processing unit CPU_CHIP and subsequently another read request occurs to the memory chip M0. The data processing unit CPU_CHIP transfers a request ReqNRD2 generated by multiplexing an ID number 1, a 2-byte data read command NRD2 and addresses AD0 and AD1 to the memory chip M0 through the request signal RqMux0. Following that, a request ReqRD2 generated by multiplexing an ID number 2, a 2-byte data read command RD2 and the addresses AD0 and AD1 to the memory chip M0 through the request signal RqMux0 is transferred. The requests ReqNRD2 and ReqRD2 are input to the request queue circuit RqQI of the memory chip M0. Since the request ReqNRD2 is a request to the memory chip M1, it is transferred to the request queue circuit RqQXO of the memory chip M0. And, the request ReqNRD2 is transferred to the memory chip M1 through the request signal RqMux1. The request ReqNRD2 is input to the request queue circuit RqQI of the memory chip M1 and then transferred to the request queue circuit RqQXI. Data corresponding to the request ReqNRD2 is read from the MemNV1 of the memory chip M1 and the data with the ID register number 1 is input as a response RsNRD2 to the response queue circuit RsQo. The response RsNRD2 input to the response queue circuit RsQo is transferred through the response signal RqMux1 and stored in the response queue RsQp of the memory chip M0. The response RsNRD2 stored in the response queue RsQp is output as the ID number 1 and the read data through the response signal ResMux0.

Since the request ReqRD2 is the request to the memory chip M0, it is transferred to the request queue circuit RqQXI of the memory chip M0. Data corresponding to the request ReqRD2 is read from the memory circuit MemVL of the memory chip M0 and the data with the ID register number 2 is input as a response RsRD2 to the response queue circuit RsQo. The response RsRD2 input to the response queue circuit RsQo is output as the ID number 2 and the read data through the response signal RqMux0. It takes approximately 15 ns after the request ReqRD2 is input to the request queue circuit RqQI of the memory chip M0 until the response ResRD2 corresponding to the request is output from the response signal ResMux0. Meanwhile, it takes approximately 70 ns after the request ReqNRD2 is input to the request queue circuit RqQI of the memory chip M1 until the response ResRD2 corresponding to the request is output from the response signal ResMux0. Therefore, the request ReqRD2 was input after the request ReqNRD2, the output corresponding the request ReqRD2 is output earlier. In this embodiment, the data read has mainly been described, however, obviously, similar operations can be performed also in data write operations. Additionally, data transfer operations between the memory chips M0 and M1 have been described in this embodiment, however, a similar data transfer operation can be performed between the memory chips M1 and another memory chip, although needless to say.

As described above, regardless of the input order of the requests, and even when the read access time is different between the memory chips, fast read data can be immediately read without waiting for late read data. Accordingly, fast processing can be achieved. Furthermore, by assigning an ID to a request, a request is transferred certainly to a request destination. Additionally, by assigning an ID to a response, the data processing unit CPU_CHIP can identify the memory chip as a transfer source even when the input order of the request is different from the order of read data. Therefore, by the series connection between the data processing unit CPU_CHIP and the memory chips, the data processing unit CPU_CHIP can perform a desired processing, while the number of connection signals is reduced.

### Second Embodiment

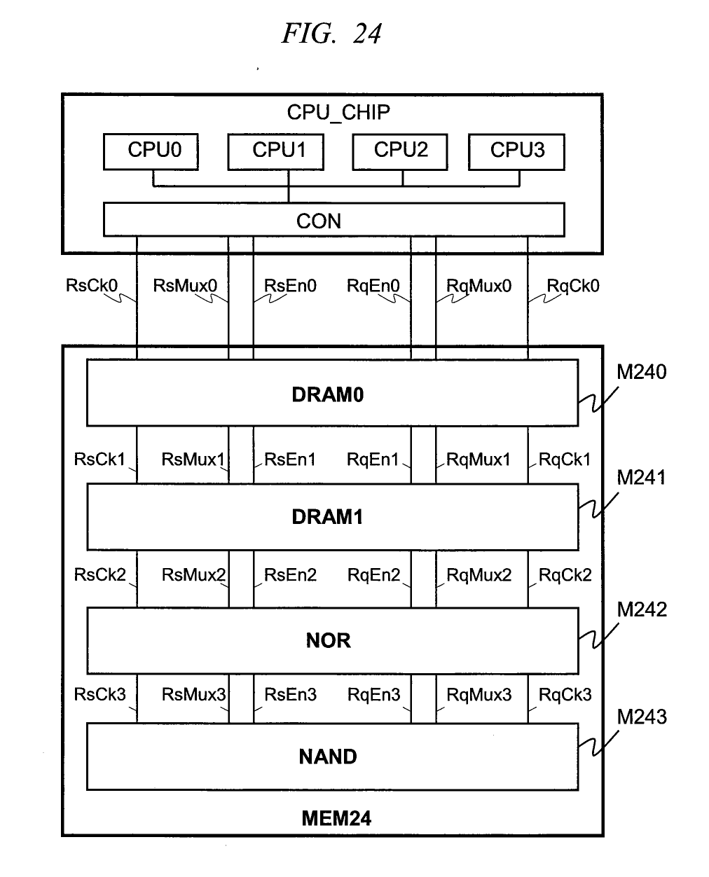

FIG. 24 shows a second embodiment of the present invention. It shows a data processing system including the data processing unit CPU_CHIP and a memory module MEM24.

The memory module MEM24 is composed of dynamic random access memories DRAM0 and DRAM1, a NOR flash memory NOR and a NAND flash memory.

The data processing unit CPU_CHIP is the same as that shown in FIG. 1. The dynamic random access memories DRAM0 and DRAM1 are the same as that shown in FIG. 4. The NOR flash memory NOR is the same as that shown in FIG. 12. The NAND flash memory is the same as that shown in FIG. 14.

The invention facilitates a plurality of dynamic random access memories to be connected in series so as to make it easy to expand a work area and a copy area necessary for the data processing unit CPU_CHIP, thereby allowing fast processing.

In this embodiment, the plurality of connected dynamic random access memories are described, however, if necessary, a plurality of the NOR flash memory NOR and NAND flash memory NAND can be connected, and, expansion of a program area and a data area can be facilitated, therefore, flexible use according to the system structure of an individual mobile apparatus is achieved.

### Third Embodiment

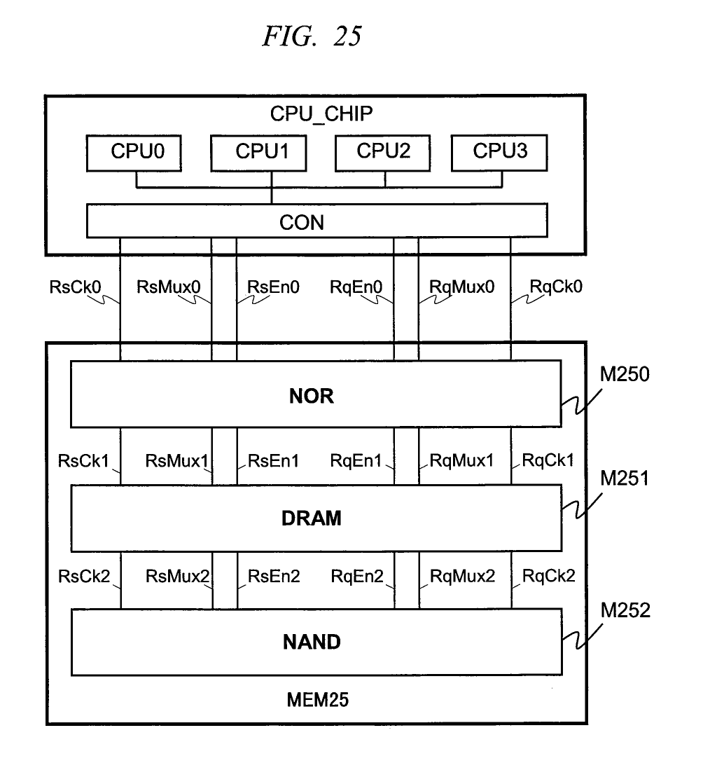

FIG. 25 shows a third embodiment of the invention. It shows a data processing system including the data processing unit CPU_CHIP and a memory module MEM25. The data processing unit CPU_CHIP is the same as that shown in FIG. 1. The NOR flash memory NOR is the same as that shown in FIG. 12. The dynamic random access memory DRAM is the same as that shown in FIG. 4. The NAND flash memory NAND is the same as that shown in FIG. 14.

The memory module MEM25 includes a NOR flash memory NOR composed of NOR flash memory cells, a dynamic random access memory DRAM composed of dynamic memory cells and a NAND flash memory NAND composed of NAND flash memory cells, arranged in the order from closer to the data processing unit CPU_CHIP. Although not restricted thereto, the NOR flash memory NOR may store an operating system, a communication program for audio communication and data communication and the like, the NAND flash memory NAND may store an application program for playing music, still image, moving picture and the like, and data such as music data, moving picture data, still image data and the like. The dynamic random access memory DRAM comprises a copy area COPY-AREA which may store a part of data such as an application program, music data, voice data, moving picture data, still image data and the like stored in the NAND flash memory NAND.

When a mobile phone is in a standby mode waiting for a call or e-mail, intermittent access to a NOR flash memory NOR storing an OS, a communication program and the like is dominant. Accordingly, in the present embodiment, in which the NOR flash memory NOR, which is a nonvolatile memory is the closest to the data processing unit CPU_CHIP, that is, in the memory module in which a plurality of memory chips connected in series and the memory chip storing an operating system and a program for audio communication and data communication is positioned at a top of the series connection and communicates with a data processing unit directly, only the NOR flash memory NOR can be operated while setting the dynamic random access memory DRAM to perform in a self-refresh mode and stopping the request clocks (RqCk1 and RqCk0) to the dynamic random access memory DRAM and the NAND flash memory NAND and the response clocks RsCk1 and RsCk2 during a standby mode. As a result, power consumption during such a standby can be reduced.

### Fourth Embodiment

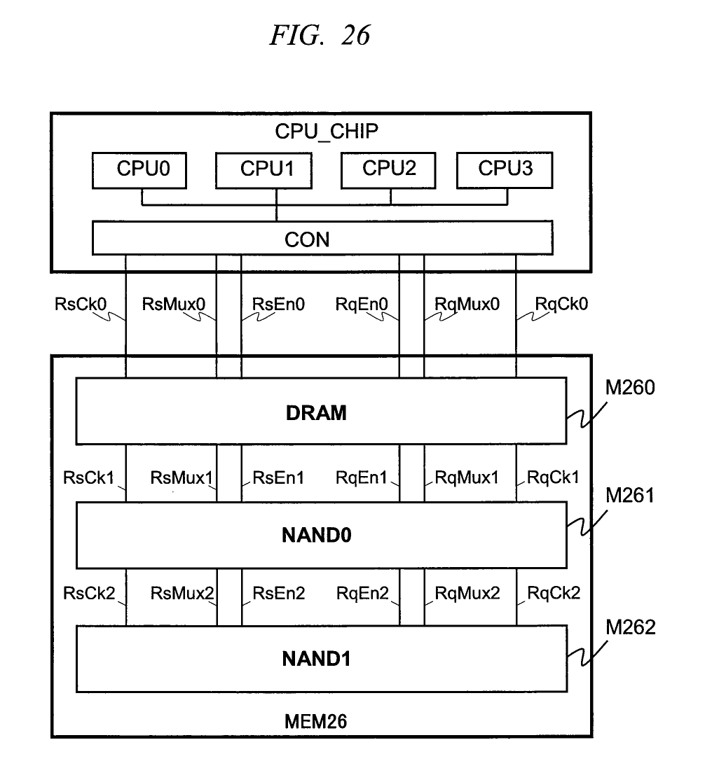

FIG. 26 shows a data processing system including the data processing unit CPU_CHIP and a memory module MEM26. The memory module MEM26 is composed of a dynamic random access memory DRAM, a NOR flash memory NOR and NAND flash memories NAND0 and NAND1. The data processing unit CPU_CHIP is the same as that shown in FIG. 1. The dynamic random access memory DRAM is the same as that shown in FIG. 4. The NAND flash memories NAND0 and NAND1 are the same as that shown in FIG. 14. Those NAND flash memories NAND0 and NAND1 can provide greater capacity at a lower cost compared with the NOR flash memory. By using the NAND flash memory NAND0 instead of the NOR flash memory, an operating system, a communication program for audio communication and data communication, an application program for playing music, still image and moving picture, and data such as music data, still image data, moving picture data, and the like can be stored in the NAND flash memory NAND0 so as to obtain a data processing system having a great capacity at a low cost. Furthermore, by transferring an operating system, a communication program for audio communication and data communication, an application program for playing music, still image and moving picture, and data such as music data, still image data, moving picture data, and the like stored in the NAND flash memory NAND0 to the dynamic random access memory DRAM in advance, the data processing system with high performance can be realized.

### Fifth Embodiment

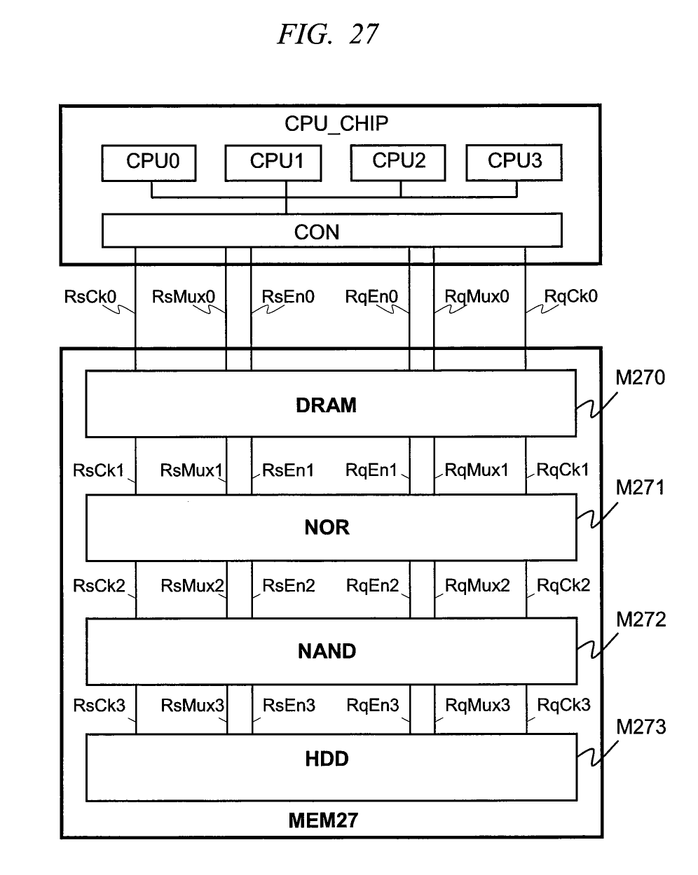

FIG. 27 shows a data processing system including a data processing unit CPU_CHIP and a memory module MEM27. The memory module MEM27 is composed of a dynamic random access memory DRAM, a NOR flash memory NOR and a NAND flash memory and a hard disk drive HDD. The data processing unit CPU_CHIP is the same as that shown in FIG. 1. The dynamic random access memory DRAM is the same as that shown in FIG. 4. The NOR flash memory NOR is the same as that shown in FIG. 12. The NAND flash memory NAND is the same as that shown in FIG. 14. The hard disk drive HDD is a memory which can provide greater capacity at a lower cost compared with the NAND flash memory NAND.

Regarding a data read unit, an address managing method and an error detection and correction method, originally, a flash memory takes over that of hard disk drive HDD, therefore, it is easy to add the hard disk drive HDD, and memory module with greater capacity can be realized at a low cost.

### Sixth Embodiment

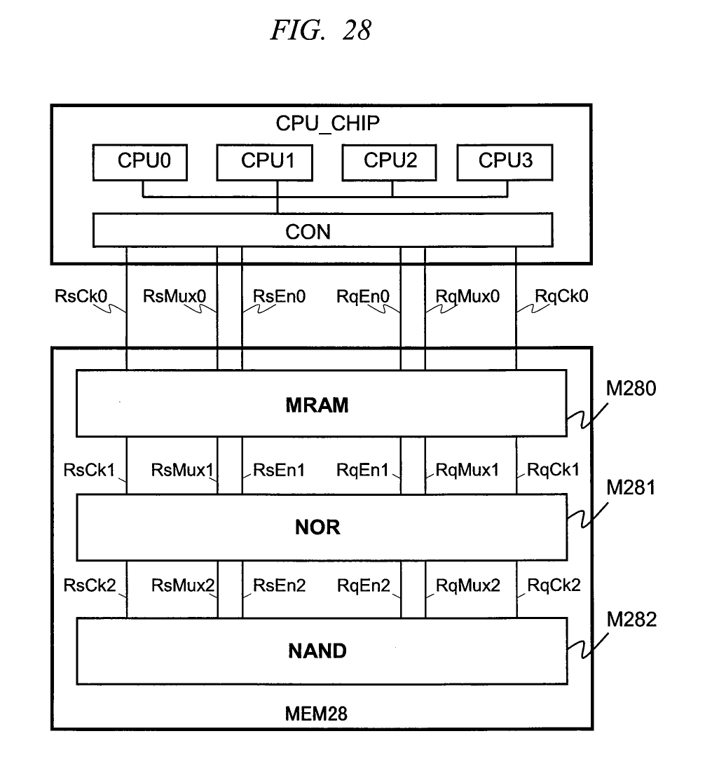

FIG. 28 shows a data processing system including the data processing unit CPU_CHIP and a memory module MEM28. The memory module MEM28 is composed of a first nonvolatile memory MRAM, a second nonvolatile memory NOR and a third nonvolatile memory NAND. The data processing unit CPU_CHIP is the same as that shown in FIG. 1. The first nonvolatile memory MRAM is a magnetic random access memory MRAM having the memory circuit MemVL (shown in FIG. 4) composed of nonvolatile magnetic memory cells. The second nonvolatile memory NOR is the same as the NOR flash memory shown in FIG. 12. The third nonvolatile memory NAND is the same as the NAND flash memory NAND shown in FIG. 14.

By using the nonvolatile magnetic random access memory MRAM instead of a volatile dynamic random access memory DRAM, it is unnecessary to execute data retention in the memory circuit regularly, as a result, power consumption can be reduced. In addition, the second volatile memory M280 may be a phase change memory having the memory circuit NV1 (shown in FIG. 12) composed of nonvolatile phase change memory cells.

### Seventh Embodiment

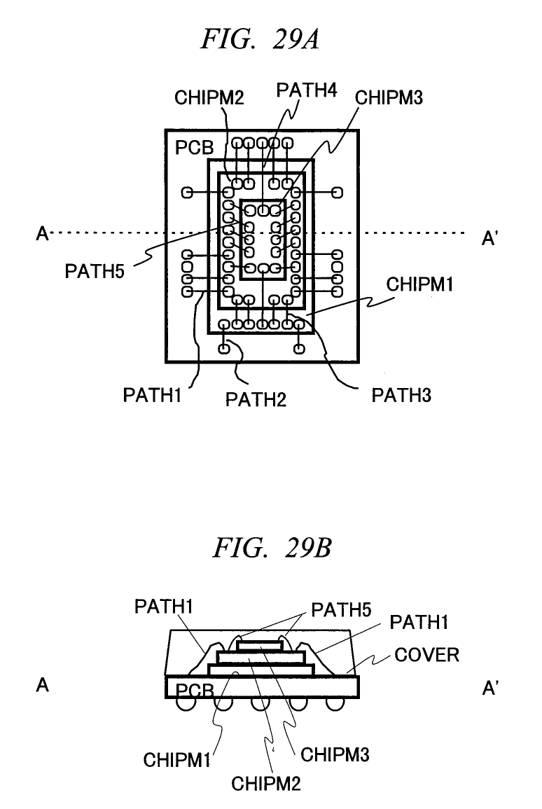

FIGS. 29A and 29B show a seventh embodiment of the invention. FIG. 29A is a top view, and FIG. 29B is a sectional view taken along the line A-A′ of the top view.

In the multi-chip module of this embodiment, memory chips CHIPM1, CHIPM2 and CHIMP3 are mounted on a printed circuit board PCB (e.g. a PCB made of a glass epoxy substrate) which is to be mounted in an apparatus using ball grid array (BGA). Although not restricted thereto, the CHIPM1 may be a first nonvolatile memory, the CHIPM2 may be a second nonvolatile memory and the CHIPM3 may be a first volatile memory.

The above multi-chip module allows integration of the memory module MEM in FIG. 1, the memory module MEM25 in FIG. 25, the memory module MEM26 in FIG. 26 and the memory module MEM28 in FIG. 28 into a single sealed package.

The CHIPM1 is connected to a bonding pad on the printed circuit board PCB by bonding wires PATH2. The CHIPM2 is connected to a bonding pad on the printed circuit board PCB by bonding wires PATH1. The CHIPM3 is connected to a bonding pad on the printed circuit board PCB by bonding wires PATH4. The CHIPM1 is connected to the CHIPM2 by a bonding wire PATH3, and the CHIPM2 is connected to the CHIPM3 by a bonding wire PATH5.

A resin mold seals a top surface of the printed circuit board PCB having the chips thereon to protect the chips and the wires. In addition to that, a cover COVER made of metal, ceramic or resin may be placed over the mold.

In the seventh embodiment, since the bear chips are directly mounted on the print circuit board PCB, the memory module with small mounting area can be realized. Additionally, the chips can be stacked, therefore, a length of wiring between the chips and the printed circuit board PCB can be shorter, as a result, the mounting area thereof can be smaller. By utilizing one wire bonding method to all wirings between the chips and wirings between the chips and the circuit board, the memory module can be formed through a small number of steps.

Furthermore, by connecting the chips by bonding wires directly, the numbers of bonding pads and wires on the printed circuit board PCB can be reduced and the memory module can be manufactured with small number of steps. In the case where a resin cover used, the memory module can be more robust. If the cover is made of ceramic or metal, the memory module can be made robust enough, as well as can be excellent in heat liberation and shielding effect.

### Eighth Embodiment

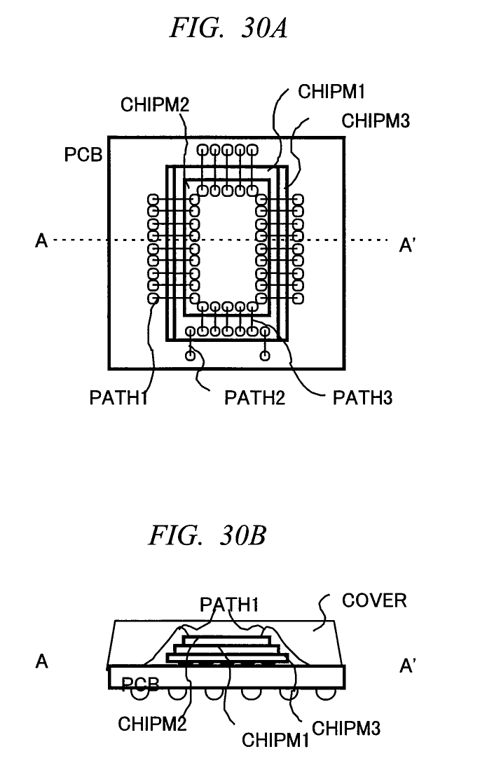

FIGS. 30A and 30B show an eighth embodiment of the present invention. FIG. 30A is a top view of the eighth embodiment. FIG. 30B is a sectional view taken along the line A-A′ of the top view.

A multi-chip module according to the eighth embodiment includes CHIPM1, CHIPM2 and CHIMP3 mounted on a printed circuit board PCB (e.g. a PCB made of a glass epoxy substrate) which is to be mounted in an apparatus by ball grid array (BGA). The CHIPM1 is a first nonvolatile memory, the CHIPM2 is a second nonvolatile memory and the CHIPM3 is a random access memory. As the multi-chip module, the memory module MEM in FIG. 1, the memory module MEM25 in FIG. 25, the memory module MEM26 in FIG. 26 and the memory module MEM28 in FIG. 28 can be integrate in a single sealed package.

The CHIPM1 is connected to a bonding pad on the printed circuit board PCB by bonding wire PATH2, and CHIPM2 is connected to a bonding pad on the printed circuit board PCB by bonding wire PATH1. The CHIPM1 is connected to the CHIPM2 by a bonding wire PATH3. In addition, the ball grid array is used for mounting and wiring of the CHIPM3.

Since the 3 chips can be stacked in this mounting form, an area the mounting can be small. In addition, bonding between the CHIPM3 and the printed circuit board PCB is unnecessary, therefore, the number of bonding wires can be reduced and the number of assembly steps can be reduced and a highly reliable multi-chip module can be realized.

### Ninth Embodiment

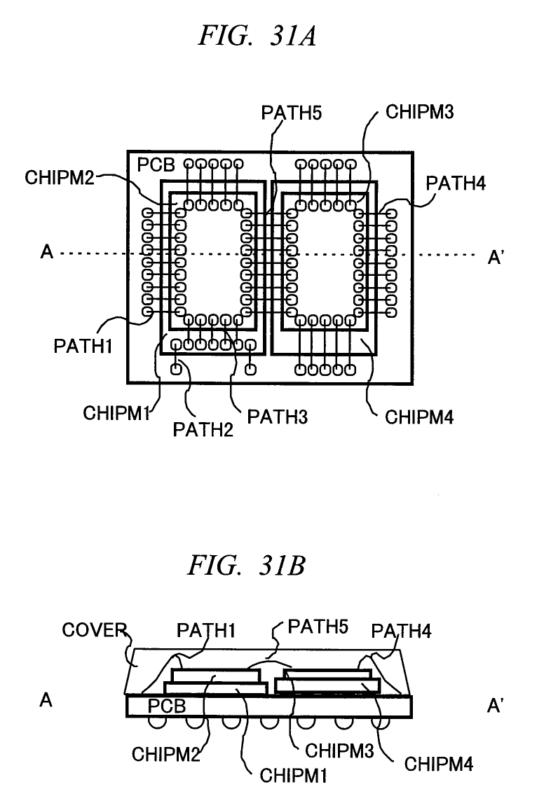

FIGS. 31A and 31B show a multi-chip module according to a ninth embodiment of the present invention. FIG. 31A is a top view of the module and FIG. 31B is a sectional view taken along the line A-A′ of the top view.

In the memory module according to the ninth embodiment, the CHIPM1, the CHIPM2, the CHIPM3 and a CHIMP4 are mounted on a printed circuit board PCB (e.g. a PCB made of a glass epoxy substrate) which is to be mounted in an apparatus using ball grid array (BGA). The CHIPM1 and the CHIPM2 are nonvolatile memories, the CHIPM3 is a random access memory.

The CHIPM4 is a data processing unit CPU_CHIP. In this mounting method, the data processing systems shown in each of FIG. 1, FIG. 25, FIG. 26 and FIG. 28 can be integrated in a single sealed package.

The CHIPM1 is connected to a bonding pad on the printed circuit board PCB by bonding wire PATH2, the CHIPM2 is connected to a bonding pad on the printed circuit board PCB by bonding wire PATH4, and the CHIPM3 is connected to a bonding pad on the printed circuit board PCB by bonding wire PATH1.

The CHIPM1 is connected to the CHIPM3 by a bonding wire PATH3 and the CHIPM2 is connected to the CHIPM3 by a bonding wire PATH5. For mounting and wiring the CHIPM4, the ball grid array (BGA) is used. In this mounting method, since the bear chips are directly mounted on the print circuit board PCB, the memory module with small mounting area can be realized. And, the chips can be positioned adjacent with each other, the length of wiring between the chips can be short.

By connecting the chips by bonding wires directly, the numbers of bonding pads and wires on the printed circuit board can be reduced, and the memory module can be manufactured by steps of smaller number. Furthermore, since bonding between the CHIPM4 and the printed circuit board PCB is unnecessary, the number of bonding wires can be reduced, and the number of steps of assembly can be reduced, and a multi-chip module with more reliability can be provided.

### Tenth Embodiment

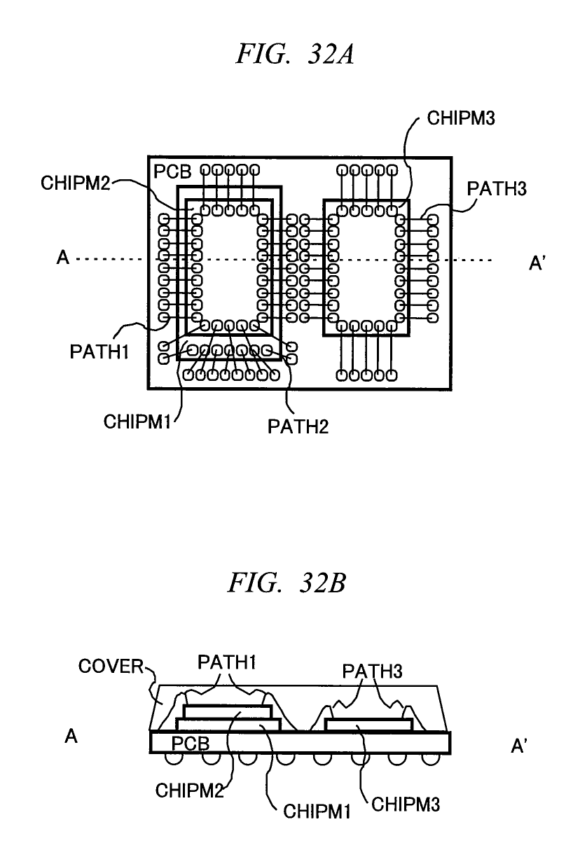

FIGS. 32A and 32B each show a memory system according to a tenth embodiment of the present invention. FIG. 32A is a top view of the embodiment. FIG. 32B is a sectional view taken along the line A-A′ of the top view.

A memory module according to this embodiment includes CHIPM1, CHIPM2 and CHIMP3 mounted on a printed circuit board PCB (e.g. a PCB made of a glass epoxy substrate) which is to be mounted in an apparatus by the ball grid array (BGA). The CHIPM1 and CHIPM2 are nonvolatile memories and the CHIPM3 is a random access memory.

By utilizing wire bonding method to all wirings between the chips and wirings between the chips and the circuit board, the memory module can be manufactured by small number of steps. In this mounting method, the memory module MEM in FIG. 1, the memory module MEM25 in FIG. 25, the memory module MEM26 in FIG. 26 and the memory module MEM28 in FIG. 28 can be integrated in a single sealed package

The CHIPM1 is connected to a bonding pad on the printed circuit board PCB by bonding wires PATH2, the CHIPM2 is connected to a bonding pad on the printed circuit board PCB by bonding wires PATH1, the CHIPM3 is connected to a bonding pad on the printed circuit board PCB by bonding wires PATH3. In this embodiment, since the bear chips are directly mounted on the print circuit board PCB, the memory module with small mounting area can be realized. Additionally, since the chips can be positioned adjacent with each other, length of wiring between the chips can be short.

By utilizing wire bonding method to all wirings between each chips and the circuit board, the memory module can be manufactured by small number of steps.

### Eleventh Embodiment

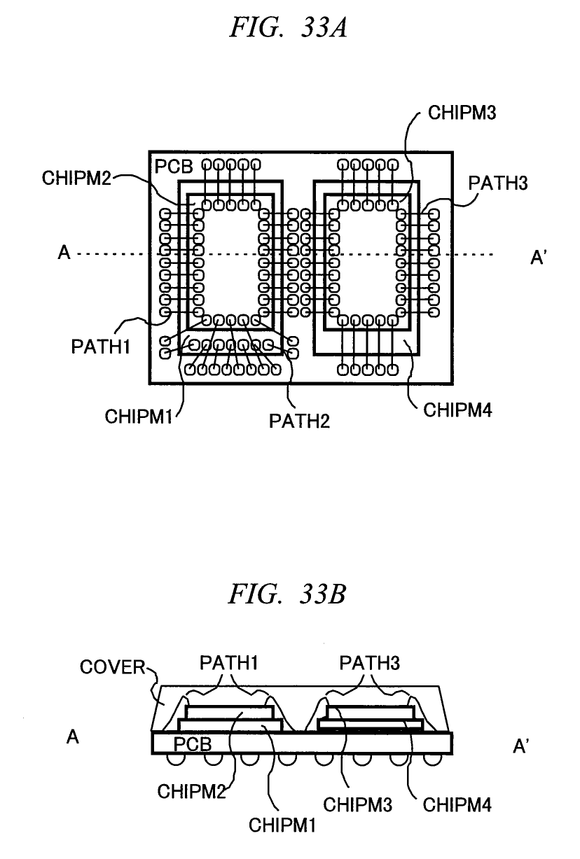

FIGS. 33A and 33B show a memory system according to an eleventh embodiment of the present invention. FIG. 32A is a top view. FIG. 32B is a sectional view taken along the line A-A′ of the top view.

The memory module according to this embodiment includes CHIPM1, CHIPM2, CHIMP3 and CHIPM4 on a printed circuit board PCB (e.g. a PCB made of a glass epoxy substrate) which is to be mounted in an apparatus by the ball grid array (BGA). The CHIPM1 and CHIPM2 are nonvolatile memories and the CHIPM3 is a random access memory. The CHIPM4 is a data processing unit CPU_CHIP. In this mounting method, the data processing systems shown in FIG. 1, FIG. 25, FIG. 26 and FIG. 28 are integrated in a single sealed package.

The CHIPM1 is connected to a bonding pad on the printed circuit board PCB by bonding wire PATH2, the CHIPM2 is connected to a bonding pad on the printed circuit board PCB by bonding wire PATH1, the CHIPM3 is connected to a bonding pad on the printed circuit board PCB by bonding wire PATH3. For mounting and wiring the CHIPM4, the ball grid array (BGA) is used.

In the embodiment, since the bear chips are directly mounted on the print circuit board PCB, the memory module with small mounting area can be realized. In addition, those chips are positioned adjacent to each other, length of wire between the chips can be short. Furthermore, since bonding between the CHIPM4 and the printed circuit board PCB is unnecessary, the number of bonding wires can be reduced, the steps of assembly can be reduced, and a multi-chip module with high reliability can be realized.

### Twelfth Embodiment

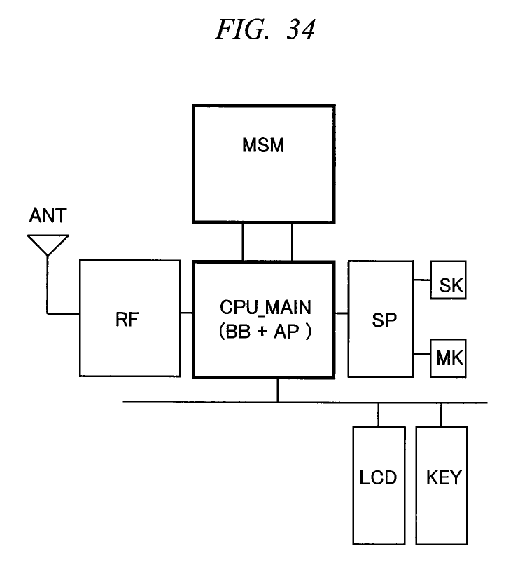

FIG. 34 shows a mobile phone according to a twelfth embodiment of the invention using a memory module according to the invention. The mobile phone is composed of an antenna ANT, a radio frequency block RF, an audio codec block SP, a speaker SK, a microphone MK, a data processing unit CPU, a liquid crystal display LCD, a keyboard KEY and a memory module MSM according to the invention. The data processing unit CPU_MAIN includes a plurality of data processing circuits. One of these, a data processing circuit CPU0 operates as a baseband processing circuit BB. One of the others, at least one data processing circuit CPU1 operates as an application processor AP.

An operation during call will be described. A voice received through the antenna ANT is amplified by the radio frequency block RF to be input to the data processing circuit CPU0. The data processing circuit CPU0 converts an analog signal of the voice into a digital signal and performs error correction and decoding to output to the audio codec block SP. The audio codec block converts the digital signal into an analog signal to output it to the speaker SK, as a result, the voice of the other party on the line can be heard from the speaker SK.

Next, a series of operations, downloading music data by accessing a web site on the Internet through the mobile phone, reproducing, listening, and finally, saving the downloaded music data will be described.

The memory module MEM stores an OS, application programs (e.g. E-mail program, Web browser, music play program, a moving picture play program, a game program, etc.), music data, still image data, moving picture data, and the like.

If a browser boot instruction is executed through the keyboard, a web browser program stored in the NOR flash memory of the memory module MSM is read and executed by the data processing circuit CPU1, therefore, the Web browser appears on the liquid crystal display LCD. Then, with an access to a desired website, downloading of a favorite music data is instructed through the keyboard KEY. The music data is received through the antenna ANT, amplified by the radio frequency block RF and then input to the data processing circuit CPU0. The data processing circuit CPU0 converts an analog signal of the music data into a digital signal and performs error correction and decoding thereof. The music data converted into the digital signal is temporarily stored in the dynamic random access memory DRAM of the memory module MSM and finally transferred to the NAND flash memory of the memory module MEM and stored therein.

Next, if an instruction to boot the music play program is executed through the keyboard KEY, the data processing circuit CPU1 reads and executes the music play program stored in the NOR flash memory of the memory module MSM, therefore, the music play program appears on the liquid crystal display LCD.

Next, if an instruction to listen to the music data downloaded in the NAND flash memory of the memory module MEM is executed through the keyboard KEY, the data processing circuit CPU1 executes the music play program and processes the music data stored in the NAND flash memory, finally, music can be heard from the speaker SK. The NOR flash memory of the memory module MSM according to the present invention stores a web browser and a plurality of programs such as a music play program and an E-mail program, and the data processing unit CPU_MAIN has the plurality of data processing circuits CPU0 to CPU3, therefore, the plurality of programs can be executed simultaneously.

During the standby state waiting for a call or E-mail, the data processing unit CPU_MAIN allows a clock to the memory module MSM to operate at a minimum frequency, so that power consumption can be extremely reduced.

As described above, by utilizing the memory module according to the invention, a large amount of data such as E-mails, a music play program, application program, music data, still and moving picture data, and the like, and the plurality of programs can be executed simultaneously.

### Thirteenth Embodiment

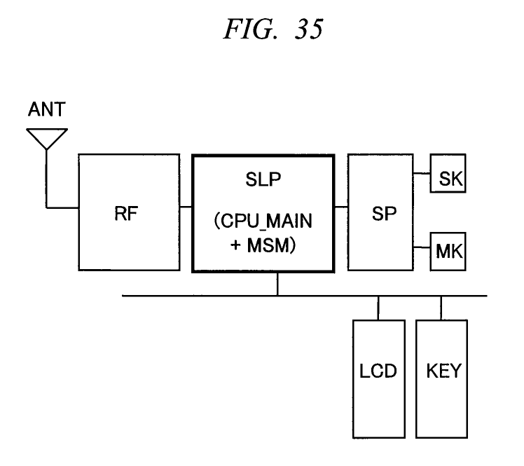

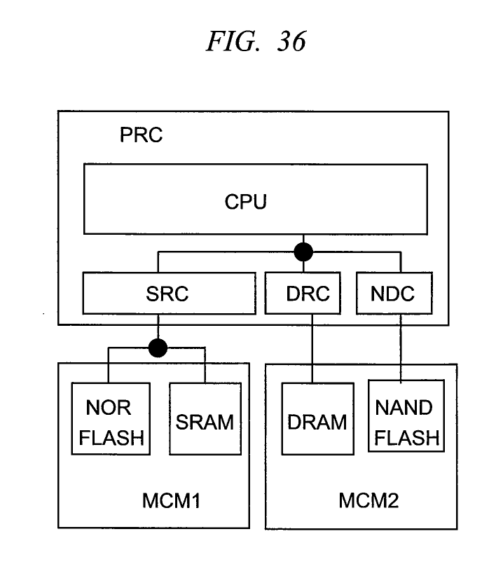

FIG. 35 shows a mobile phone according to the thirteenth embodiment utilizing a memory system according to the present invention. The mobile phone is composed of the antenna ANT, the radio frequency block RF, the audio codec block SP, the speaker SK, the microphone MK, the liquid crystal display LCD, the keyboard KEY and a data processing system SLP according to the invention in which the memory module MSM and the data processing unit CPU_MAIN are integrated into a single sealed package.

By using the data processing system SLP according to the present invention, component count can be reduced. Therefore, the cost can be reduced, a reliability of the mobile phone can be improved, and, since the mounting area for the components composing the mobile phone can be made small, the mobile phone can be miniaturized.

### SUMMARY OF THE ADVANTAGES DESCRIBED IN THE EMBODIMENTS

The following are the main advantages obtained by the present invention described above in the specification.

Firstly, by confirming the series connection immediately after turning power on, the certain connections between the memories can be confirmed. Additionally, since the boot device and the endmost memory chip are specified and ID numbering for each memory chip is automatically performed, it is easy to connect memory chips only as necessary to expand memory storage capacity.

Secondly, by assigning an ID number to a request, the request is transferred from the data processing unit CPU_CHIP to each of the memory chips M0, M1 and M2 certainly. And, by assigning an ID number to a response to the data processing unit CPU_CHIP, it can be confirmed that the data has been transferred from the memory chips correctly. And, because of series connection between the data processing unit CPU_CHIP and the memory chips M0, M1 and M2, the data processing unit CPU_CHIP can execute desired operation, while the number of connections signals can be reduced.

Thirdly, since the request interface circuit ReqIF and the response interface circuit ResIF can operate independently, data read and write can simultaneously be executed, therefore, the data transfer capability can be improved.

Fourthly, regardless of the input order of a request, fast read data can be read immediately without waiting for late read data. Accordingly, fast processing can be realized. In addition, by assigning an ID to the request, the request is transferred to its destination certainly. Furthermore, by assigning an ID to a response, the data processing unit CPU_CHIP can identify the memory chip as a transfer source, even if the input order of the request differs from the order of read data.

Fifthly, since the order of responses from the memory chips to the data processing unit CPU_CHIP is changed dynamically according to the read frequency, data transfer capabilities can be improved. Furthermore, the read frequency is programmable so as to be adjusted to individual system flexibly.

Sixthly, since an error can be transmitted to the data processing unit CPU from the memory chips, the data processing unit CPU can detect the error and can respond to it immediately. Therefore, a data processing system with high reliability can be constructed.

Seventhly, the clock frequency of each of the memory chips M0, M1 and M2 can be changed according to its need, therefore, power consumption can be reduced.

Eighthly, in the reading operation from the memory chip M2, error detection and correction are performed, and writing operation, replacement processing is performed for a bad address in which write has been done incorrectly. Therefore, reliability can be maintained.

Ninthly, by mounting the plurality of semiconductor chips into a single sealed package, a system memory module with a small mounting area can be provided.

What is claimed is:

1. A memory module composed of a plurality of memories including a first memory device and a second memory device connected in series,
wherein the each memory devices composing the plurality of memory modules receive a request including identification information that indicates which of the plurality of memory devices is a destination of the request, and in responding operation to the request, output a response including the identification information of the memory device.

2. The memory module according to claim 1,
wherein the second memory device is connected in subsequent part of the first memory device,
wherein the first memory device transmits the identification information included in the request to the second memory device and receives the identification information included in a response output from the second memory device.

3. The memory module according to claim 1,
wherein each of the plurality of memory devices individually has an input/output circuit of a signal regarding the request and an input/output circuit of a signal regarding the response to the request.

4. The memory module according to claim 1,
wherein each of the plurality of memory devices individually has a clock for a signal regarding the request and a clock for a signal transmitting the response to the request.

5. The memory module according to claim 1,
wherein the response is output according to a response priority.

6. The memory module according to claim 5,
wherein the response priority is dynamically changed.

7. The memory module according to claim 6,
wherein the response priority is changed according to a response frequency.

8. The memory module according to claim 7,
wherein the response frequency is programmable.

9. The memory module according to claim 8,
wherein the response frequency is programmable in a manner corresponding to each memory device.

10. The memory module according to claim 1,
wherein a signal regarding the request includes an address information, a command information and a memory device identification information, while a signal regarding the response includes a signal data information and the identification information, and the information thereof are multiplexed to be transmitted and received.

11. The memory module according to claim 2,
wherein the request includes one of a command for changing a clock frequency of memory device, a command for stopping the clock and a command for restarting the clock.

12. The memory module according to claim 1,
wherein the memory device composing the memory module outputs error information.

13. The memory module according to claim 12,
wherein the error information is an error of the identification information, an error of read operation, or an error of write operation.

14. A memory module composed of a plurality of memory devices connected in series,
wherein the memory device composing the memory module includes a status register, and
wherein the status register stores one of a quantity of unprocessed responses to requests, a read error, a write error or an ID error.

15. The memory module according to claim 14,
wherein the content of the status register is read out.

16. A memory module in which a plurality of memory devices can be connected in series,
wherein each of the plurality of memory devices is assigned identification information initially after turning power on.

17. The memory module according to claim 16,
wherein a completion of assignment of the identification information to the memory device is notified.

18. The memory module according to claim 16,
wherein connections between the memory devices are confirmed initially after turning power on.

19. The memory module according to claim 16,
wherein a boot program is read out from a designated memory device of the plurality of memory devices initially after turning power on.

20. The memory module according to claim 19,
wherein designation of the memory device from which the boot program is read out is programmable.

21. A memory module in which a plurality of memory devices connected in series,
wherein a memory device with a shortest read time is positioned at a top of the series connection so as to connect the memory devices in order of shorter read times.

22. A memory module comprising in which a plurality of memory devices connected in series,
wherein a memory device storing an operating system is positioned at a top of the series connection and communicates with a data processing unit directly.

23. A memory module comprising in which a plurality of memory devices connected in series,
wherein a memory device storing a program for audio communication and data communication is positioned at a top of the series connection and communicates with a data processing unit directly.
